(19) United States
(12) Patent Application Publication
(10) Pub. No.: US 2018/0206139 A1
(43) Pub. Date: Jul. 19, 2018

(54) METHOD AND SYSTEM FOR DIRECTIONAL-BAND RELAY ENHANCEMENTS

(71) Applicant: INTERDIGITAL PATENT HOLDINGS, INC., Wilmington, DE (US)

(72) Inventors: Xiaofei Wang, Cedar Grove, NJ (US); Guodong Zhang, Syosset, NY (US); Robert L. Olesen, Huntington, NY (US); Arnab Roy, Phoenixville, PA (US); Qian Zhang, Basking Ridge, NJ (US); Douglas R. Castor, Norristown, PA (US); Ravikumar V. Pragada, Warrington, PA (US)

(73) Assignee: INTERDIGITAL PATENT HOLDINGS, INC., Wilmington, DE (US)

(21) Appl. No.: 15/742,678

(22) PCT Filed: Jul. 8, 2016
(86) PCT No.: PCT/US2016/041601

§ 371 Date: Jan. 8, 2018

Related U.S. Application Data
(60) Provisional application No. 62/190,073, filed on Jul. 8, 2015.
(60) Provisional application No. 62/191,076, filed on Jul. 10, 2015.

(51) Int. Cl. H04W 24/10; H04B 7/155

(52) U.S. Cl. CPC H04W 24/10; H04W 84/12; H04B 7/15507

(57) ABSTRACT

Systems and methods are provided for transmitting a relay search request frame from a source relay edge directional multigigabit (DMG) station STA (REDS) to the AP and receiving a relay search response frame including a list of at least a first and second relay DMG STA (RDS) in a wireless network. Systems and methods are further provided for transmitting over a first data stream through a direct link between the source REDS and the destination REDS, transmitting over a second data stream through the first RDS between the source REDS and the destination REDS, and transmitting over a third data stream through the second RDS between the source REDS and the destination REDS. Directional-band relay in wireless communications may be used in range extension where two wireless nodes may set up a relayed link without first forming a direct link between them.

### BACKGROUND

A wireless local area network (WLAN) in Infrastructure Basic Service Set (BSS) mode has an Access Point (AP) for the BSS and one or more stations (STAs) associated with the AP. The AP typically has access, or an interface, to a Distribution System (DS), which may connect the BSS to other wired/wireless network(s) that may carry traffic outside of the DS. Traffic to STAs that originates from outside the BSS arrives through the AP and is delivered to the STAs. Traffic originating from STAs to destinations outside the BSS is transmitted to the AP to be delivered to the respective destinations. Traffic between STAs within the BSS may also be transmitted through the AP where the source STA transmits traffic to the AP and the AP delivers the traffic to the destination STA. Such traffic between STAs within a BSS is really peer-to-peer traffic. Such peer-to-peer traffic may also be transmitted directly between the source and destination STAs with a direct link setup (DLS) using an IEEE 802.11e DLS or an IEEE 802.11z tunneled DLS (TDLS). A WLAN using an Independent BSS (IBSS) mode has no AP, and STAs communicate directly with each other. This mode of communication may be referred to as an “ad-hoc” mode of communication.

IEEE 802.11s is an IEEE 802.11 amendment for mesh networking defining how wireless devices can interconnect to create a WLAN mesh network, which may be used for static topologies and ad-hoc networks. An IEEE 802.11s mesh network device is labeled as Mesh Station (MSTA). MSTAs form mesh links with one another, over which mesh paths may be established using a routing protocol. IEEE 802.11s extends the IEEE 802.11 MAC standard by defining an architecture and protocol that support both broadcast/multicast and unicast delivery using radio-aware metrics over self-configuring multi-hop topologies.

In IEEE 802.11ad-2012, Very High Throughput using the 60 Gigahertz (GHz) band has been introduced. Wide bandwidth spectrum at 60 GHz is available, thus enabling very high throughput operation. IEEE 802.11ad supports up to 2 GHz operating bandwidths and the data rate can reach up to 6 Gigabits per second (Gbps). Since the propagation loss at 60 GHz is more significant than at the 2.4 GHz and 5 GHz bands, beamforming has been adopted in IEEE 802.11ad as a means to extend the coverage range. Another feature of the IEEE 802.11ad amendment is the addition of a scheduled channel access mode in addition to contention-based access. This allows an AP and STA to gain predictable access to the channel. Further, in addition to the IBSS, the IEEE 802.11ad introduced the concept of a Personal Basic Service Set (PBSS) as an ad-hoc network. Similar to the IBSS, the PBSS is a type of IEEE 802.11 local area network (LAN) in which STAs communicate directly with each other. In contrast to the IBSS, in the PBSS one STA assumes the role of the PBSS control point (PCP).

### SUMMARY

Methods and systems are disclosed herein to enhance the use of directional-band relay in wireless communications. In an example of range extension, two wireless nodes, which may belong to a Personal Basic Service Set (PBSS)/Basic Service Set (BSS), may set up a relayed link without first forming a direct link between the two wireless nodes. In an example of coverage extension, a node may join a PBSS/BSS when it is beyond beacon range of a PBSS control point (PCP)/Access Point (AP). For example, an Enhanced Relay Directional Multi-gigabit (DMG) Station (eRDS) may transmit beacons for new node discovery. Also, methods and procedures are disclosed herein for channel access for a relay link including the eRDS. Further, methods and systems are disclosed herein to build on range and coverage extensions to enable multiple active relays per source-destination pair, including: multiple relay setup, channel access procedures, relay handover procedures and procedures for multi-user-MIMO (MU-MIMO) operations.

In an example wireless communication system, a PCP/AP, may transmit an announce service period (SP) to perform beam processing to a Source-Relay End-point DMG Station (S-REDS), a first Relay DMG Station (RDS), a second RDS and a Destination-Relay End-point DMG Station (D-REDS). The S-REDS may transmit a first multi-relay channel measurement request to the first RDS and a second multi-relay channel measurement request to the second RDS. Also, the first RDS may transmit a first multi-relay channel measurement report to the S-REDS and the second RDS may transmit a second multi-relay channel measurement report to the S-REDS. In addition, the first RDS may transmit a third multi-relay channel measurement request to the D-REDS and the second RDS may transmit a fourth multi-relay channel measurement request to the D-REDS. Further, the D-REDS may transmit a third multi-relay channel measurement report to the first RDS and a fourth multi-relay channel measurement report to the second RDS. The S-REDS may then transmit a fifth multi-relay channel measurement request to the first RDS and a sixth multi-relay channel measurement request to the second RDS.

In addition, the first RDS may transmit a fifth multi-relay channel measurement report, which may contain a first channel measurement information for channel information between the first RDS and the D-REDS, to the S-REDS. The first channel measurement information may include channel information based on the third multi-relay channel measurement report. The first channel measurement information may also include channel information measured from the first RDS to the D-REDS and channel information measured from the D-REDS to the first RDS. Also, the second RDS may transmit a sixth multi-relay channel measurement report, which may contain a second channel measurement information for channel information between the second RDS and the D-REDS, to the S-REDS. The second channel measurement information may include channel information based on the fourth multi-relay channel measurement report. The second channel measurement information may also include channel information measured from the second RDS to the D-REDS and channel information measured from the D-REDS to the second RDS.

Systems and methods are provided for transmitting a relay search request frame from an S-REDS to the AP and receiving a relay search response frame including a list of at least a first and second RDS in a wireless network. Systems and methods are further provided for transmitting over a first data stream through a direct link between the S-REDS and the D-REDS, transmitting over a second data stream through the first RDS between the S-REDS and the D-REDS, and transmitting over a third data stream through the second RDS between the S-REDS and the D-REDS.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a system diagram of an example of an unmodified IEEE 802.11ad relay topology; and

FIG. 3 is a diagram of a deployment example for coverage extension;

FIG. 4 is a diagram of an example signaling procedure for Relay directional multi-gigabit (DMG) Station (RDS) selection for range extension;

FIG. 5 is a diagram of an example modified Multi-Relay Channel Measurement Report Frame Action field format;

FIG. 6 is a diagram of another example signaling procedure for RDS selection for range extension;

FIG. 7 is a diagram of an example Multi-Relay Measurement Report Frame Action field format;

FIG. 8 is a diagram of an example range extension scenario;

FIG. 9 is a diagram of an example signaling procedure for a link setup for range extension;

FIG. 10 is a diagram of an example Relay Link Setup Request frame Action field format;

FIG. 11 is a diagram of an example signaling procedure for a potential relay set reduction;

FIG. 12 is a diagram of an example signaling procedure for range extension and periodic data transfer;

FIG. 13 is a diagram of an example signaling procedure for range extension and polled data transfer;

FIG. 14 is a diagram of an example modified grant frame format;

FIG. 15 is a diagram of an example of service period transmissions between S-REDS and D-REDS;

FIG. 16 is a diagram of another example of service period transmissions;

FIG. 17 is a diagram of another example of service period transmissions;

FIG. 18 is a diagram of another example of service period transmissions;

FIG. 19 is a diagram of another example of service period transmissions;

FIG. 20 is a diagram of another example of service period transmissions;

FIG. 21 is a diagram of another example of service period transmissions;

FIG. 22 is a diagram of an example of a frame control field, including information for an enhanced RDS (eRDS) beacon configuration;

FIG. 23 is a diagram of an example beacon interval control field;

FIG. 24 is a diagram of an example signaling procedure for BSS extension with eRDS;

FIG. 25 is a diagram of an example signaling procedure for beamforming and association procedure with a new station (STA);

FIG. 26 is a diagram of an example of the contents of a relay channel information message;

FIG. 27 is a diagram of an example signaling procedure for channel access for coverage extension;

FIG. 28 is a diagram of an example of channel access with eRDS using dynamic allocation;

FIG. 29 is a diagram of an example of an eRDS poll frame format;

FIG. 30 is a diagram of an example of an eRDS SPR frame format;

FIG. 31 is a diagram of an example of a relay control element format;

FIG. 32 is a diagram of an example of an eRDS grant frame format;

FIG. 33 is a diagram of an example of range extension, including Destination-Relay End-point DMG Station (D-REDS) broadcast beacons;

FIG. 34 is a diagram of an example of a multi-relay topology;

FIG. 35 is a diagram of an example signaling procedure for D-REDS association with multi-relay;

FIG. 36 is a diagram of an example Secondary Relay Configuration Request message format;

FIG. 37 is a diagram of an example Secondary Relay Configuration Response message format;

FIG. 38 is a diagram of an example of a Relay Capability field format;

FIG. 39 is a diagram of an example Relay Association Request message format;

FIG. 40 is a diagram of an example Relay Association Response message format;

FIG. 41 is a diagram of an example of a Relay Configuration field format;

FIG. 42 is a diagram of an example Relay Association Confirm message format;

FIG. 43 is a diagram of an example of a Concurrent Relay Request field format;

FIG. 44 is a diagram of an example of a DMG TSPEC element format;

FIG. 45 is a diagram of an example of a DMG Allocation Info field format;

FIG. 46 is a diagram of an example of a Concurrent Relay Response field format;

FIG. 47 is a diagram of an example of a dynamic scheduling procedure for multiple relays;

FIG. 48 is a diagram of an example of a Multi-Relay Poll frame format;

FIG. 49 is a diagram of an example of contents of a Multi-Relay Control field format;

FIG. 50 is a diagram of an example of a Multi-Relay SPR frame format;

FIG. 51 is a diagram of an example of a Multi-Relay Grant message frame format;

FIG. 52 is a diagram of an example of an Enhanced Dynamic Allocation Info field;

FIG. 53 is a diagram of an example of contents of a Primary eRDS Handover Request frame format;

FIG. 54 is a diagram of an example of a Handover List element format;

FIG. 55 is a diagram of an example of contents of a Primary eRDS Handover Response frame format;

FIG. 56 is a diagram of an example of contents of a Multi-Relay field format;

FIG. 57 is a diagram of an example signaling procedure for periodic channel evaluation with multi-relay;

FIG. 58 is a diagram of an example signaling procedure for a Multi User-Multiple Input Multiple Output (MU-MIMO) channel access mechanism with multiple relays;

FIG. 59 is an example network diagram which shows multiple data stream relay STAs between a S-REDS and a D-REDS; and

FIG. 60 is a modified relay capabilities information field which indicates support for MDS Relay capabilities;

FIG. 61 is a diagram of an example relay discovery procedure;

FIG. 62 is a diagram of an example MDS relay selection procedure;

FIG. 63 is a modified relay transfer parameter field of the relay transfer parameter set element to support MDS relay operations;

FIG. 64 is a diagram of an example relay link setup procedure;

FIG. 65 is a diagram of an example design of the modified relay capabilities information field;

FIG. 66 is a diagram of an example range extension relay discovery procedure;

FIG. 67 is a diagram of another example range extension relay discovery procedure;

FIG. 68 is a diagram of an example range extension selection procedure;

FIG. 69 is a diagram of another example range extension selection procedure; and

FIG. 70 is a modified relay transfer parameter field of the relay transfer parameter set element.

### DETAILED DESCRIPTION

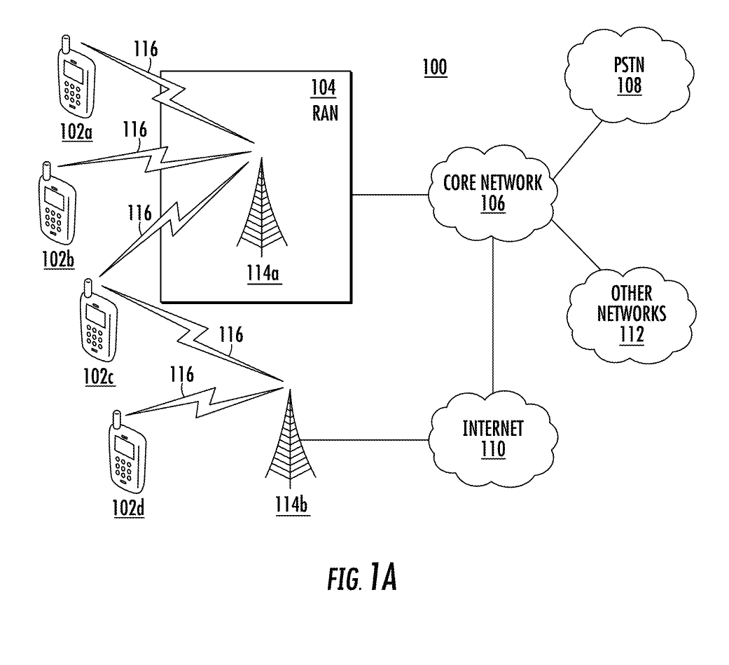

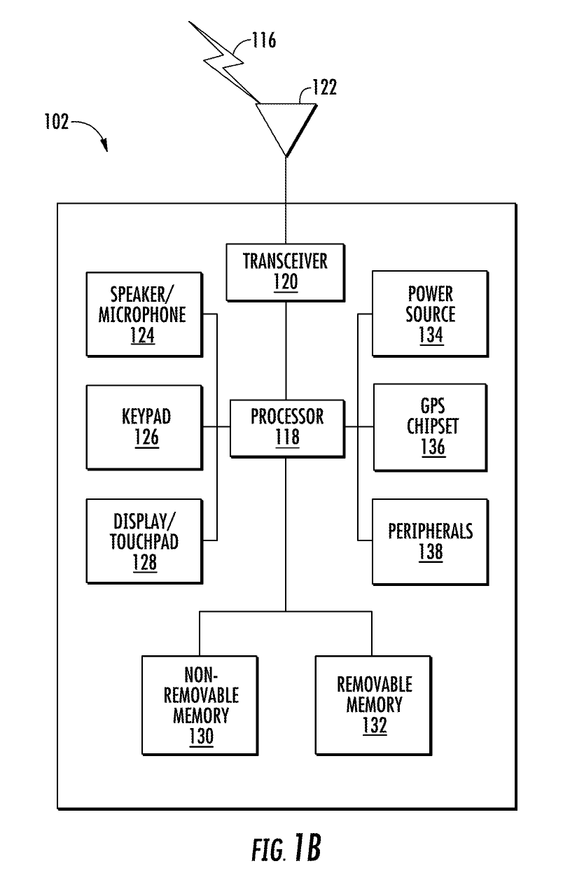

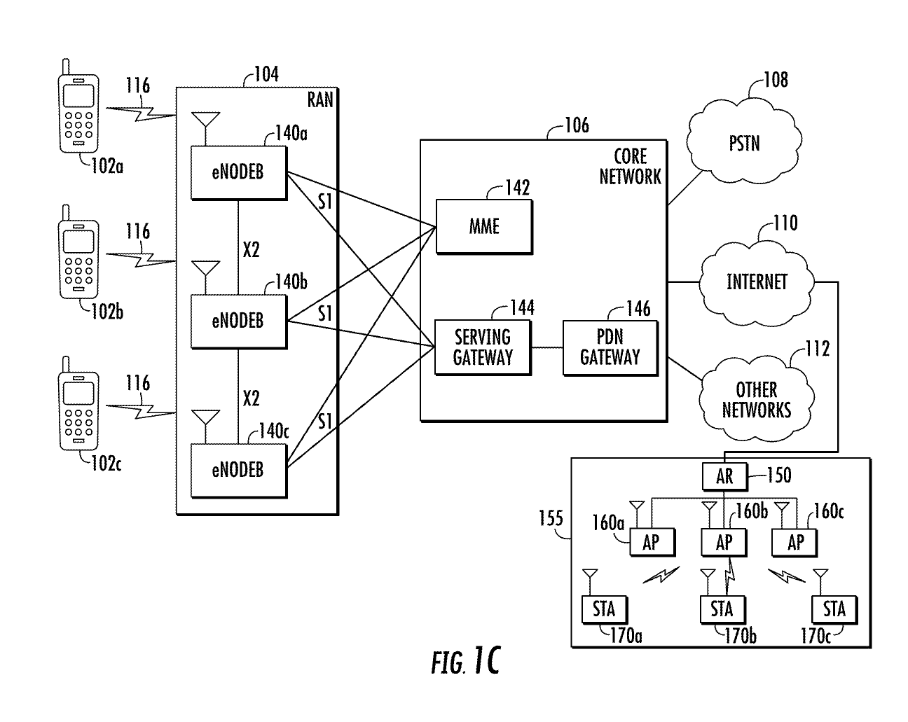

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a WLAN 155 may be in communication with the Internet 110. The AR 150 may facilitate communications between APs 160a, 160b, and 160c. The APs 160a, 160b, and 160c may be in communication with stations (STAs) 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

An overview of a WLAN is disclosed herein. A WLAN in infrastructure basic service set (BSS) mode has an access point (AP) for the BSS and one or more stations (STAs) associated with the AP. The AP typically has access or interface to a distribution system (DS) or another type of wired/wireless network that carries traffic in and out of the BSS. Traffic to STAs that originates from outside the BSS arrives through the AP and is delivered to the STAs. Traffic originating from STAs to destinations outside the BSS is transmitted to the AP to be delivered to the respective destinations. Traffic between STAs within the BSS may also be transmitted to through the AP where the source STA transmits traffic to the AP and the AP delivers the traffic to the destination STA. The traffic between STAs within a BSS should be considered peer-to-peer traffic. This peer-to-peer traffic may be transmitted directly between the source and destination STAs with a direct link setup (DLS) using an IEEE 802.11e DLS or an IEEE 802.11z tunneled DLS (TDLS). A WLAN in Independent BSS mode has no AP and STAs communicate directly with each other.

An overview and introduction to a sub 1 GHz Wi-Fi system, including IEEE 802.11ah, is disclosed herein. New spectrum is being allocated in various countries around the world for wireless communication systems such as WLANs. Such spectrum is often quite limited in the size and also in the bandwidth of the channels they comprise. In addition, the spectrum may be fragmented in that the available channels may not be adjacent and may not be combined for larger bandwidth transmissions. Such is the case, for example, in spectrum allocated below 1 GHz in various countries. WLAN systems, for example built on the IEEE 802.11 Standard, may be designed to operate in the below 1 GHz spectrum. Given the limitations of the spectrum below 1 GHz, the WLAN systems may only be able to support for smaller bandwidths and lower data rates compared to high throughput (HT)/very high throughput (VHT) WLAN systems based on the IEEE 802.11n/IEEE 802.11ac Standards for example.

The IEEE 802.11ah Task Group (TG) has been established to develop solutions to support WiFi in the sub 1 GHz band. The IEEE 802.11ah TG is targeting to achieve several requirements. These requirements may include the OFDM PHY operating below 1 GHz in license-exempt bands excluding TV whitespace (TVWS), enhancements to media access control (MAC) to support physical layer (PHY), coexistence with other systems, for example, 802.15.4 and P802.15.4g, and the optimization of rate vs. range performance (range up to 1 km (outdoor) and data rates>100 Kbit/s). Three use cases have been adopted by the IEEE 802.11ah TG. These include use case 1, sensors and meters, use case 2, backhaul sensor and meter data, and use case 3, extended range Wi-Fi for cellular offloading.

Since the spectrum allocation in some countries is quite limited, for example, in China the 470-566 and 614-787 MHz bands only allow 1 MHz bandwidth. Therefore, there will be a need to support 1 MHz only option in addition to a support for a 2 MHz with 1 MHz mode also. The IEEE 802.11ah PHY is required to support 1, 2, 4, 8, and 16 MHz bandwidths.

The IEEE 802.11ah PHY operates below 1 GHz and is based on the IEEE 802.11ac PHY. To accommodate the narrow bandwidths required by IEEE 802.11ah, the IEEE 802.11ac PHY is down-clocked by a factor of 10. While support for 2, 4, 8, and 16 MHz can be achieved by the 1/10 down-clocking described above, support for the 1 MHz bandwidth requires a new PHY definition with an FFT size of 32.

In IEEE 802.11ah, a key use case defined is meters and sensors, in which up to 6000 STAs must be supported within one single BSS. The devices such as smart meters and sensors have very different requirements pertaining to the supported uplink and downlink traffic. For example, sensors and meters could be configured to periodically upload their data to a server which will most likely to be uplink traffic only. Sensors and meters can also be queried or configured by the server; when the server queries or configures a sensor and meter, it will expect that the queried data should arrive within a setup interval; similarly the server/application will expect a confirmation for any configuration performed within a certain interval. These types of traffic patterns may be very different than the traditional traffic patterns assumed for WLAN systems.

In the IEEE 802.11ah signal (SIG) field of the physical layer convergence procedure (PLCP) preamble of a packet, 2 bits are used to indicate the type of acknowledgment expected as a response or an early acknowledgement (ACK) indication, to the packet. These two bits are defined for an ACK using a “00” value, a block acknowledgement (BA) using a “01” value, and No ACK using a “10” value. The “11” value is currently reserved.

The following relay examples are discussed with reference to IEEE 802.11ah, however it is understood that these examples may be applied to any wireless technology. These examples include a relay for IEEE 802.11ah, relays to extend AP coverage and save power, a proposed use of a non-AP relay which consists of a relay STA (R-STA) and relay AP (R-AP), using four-address frames, two-hop relaying, a proposed bidirectional relay function, reduced power consumption for STA with battery constraints, and limited MCS range, sharing one TXOP for relay and reducing the number of contentions for channel access, address buffer overflow at relay with a flow control mechanism at the relay, and the use of a probe request message for relay discovery which may include information on an AP-STA link budget, if available, to reduce number of responses.

In order to serve STAs with poor wireless link conditions more efficiently with respect to a power budget, relay functionality was introduced in the IEEE 802.11ah specification framework document (SFD). A bidirectional two-hop relay function has been proposed using one relay node. A relay node is a device that may consist of two logical entities: a relay STA and a relay AP. The relay STA associates with a parent node or AP. The relay AP allows STAs to associate and obtain connectivity to the parent node/AP via the relay STA. So a relay node allows range extension and supports packet/frame forwarding between source and destination nodes.

Relay operation may be applied in IEEE 802.11ad. Example relay operations in IEEE 802.11ad may function in half duplex (HD) mode or full duplex (FD) mode. The relay directional multigigabit (DMG) STA (RDS) may operate in link switch or cooperation mode. When operating in link switch mode, the RDS may provide an alternative connection from the source relay edge DMG STA (S-REDS) and the destination REDS (D-REDS) while the source and the destination REDSs should have a direct link to each other. When operating in cooperation mode, the RDS may transmit concurrently with the S-REDS in order to provide a stronger received signal at the D-REDS.

IEEE 802.11ad may allow only one RDS to operate in a relay operation between a source and a destination REDS. In addition, the source and the destination REDS are assumed to have a direct link and therefore to be within range of each other.

FIG. 2 is a system diagram of an example of an unmodified IEEE 802.11ad relay topology 200. Procedures for using relays to transfer data from source to destination nodes may be applied in IEEE 802.11ad. Both Amplify and Forward/Full-duplex and Decode and Forward/Half-Duplex modes may be supported. In addition, two types of relaying operation may be supported including Link Switching and Link Cooperating. Referring to FIG. 2, the use of a single relay node 210 between the source and the destination relay nodes, called Source-Relay End-point directional multi-gigabit (DMG) Station (S-REDS) 220 and Destination-Relay End-point DMG Station (D-REDS) 230, may require that a direct link 240 between the S-REDS 220 and D-REDS 230 is first established. In this example, only when the direct link between the end nodes is disrupted, the relay link 250 through the Relay DMG Station (RDS), shown as the relay node 210, may be utilized. Different frame exchange rules for Full-Duplex/Amplify and Forward and Half-Duplex/Decode and Forward utilizing Data Sensing time, and First and Second Periods may be supported.

Relay extensions may be used in sub-1 GHz Wi-Fi systems. For example, the proposed IEEE 802.11ah standard has introduced the concept of relaying for omni-directional transmissions. The proposed procedure may allow the AP and the STA to exchange frames with one another through a relay. A relay may be an entity that logically consists of a Relay AP and a Relay STA.

Relay STAs may enable STAs to use higher modulation and coding schemes (MCSs) and reduce the time STAs have to stay in Active Mode. This may improve battery life of the STAs. Relay STAs may also provide connectivity for STAs located outside the coverage area of the AP. There may be an overhead cost on overall network efficiency and increased complexity with the use of Relay STAs. To limit this overhead, the relaying function may be limited to two hops only. However, the outlying STA may associate with the Relay AP in the Relay STA and not the root AP, which may increase the time required to transition the STA from one Relay STA to another or to the root AP. Additionally, in some circumstances, only STA-AP data transfer may be allowed via a Relay. Direct STA to STA links using a Relay STA are not currently possible.

Directional millimeter wave links may be susceptible to blocking. The IEEE 802.11ad specification may include support for directional relays as secondary links.

A multi-hop method and procedure may be used, such as for an outdoor small cell. A multi-hop method and procedure may also be used for an indoor relay, such as data center networking, and the link.

The channel access schemes in IEEE 802.11ad may allow for direct communication between DMG stations. Relaying has been introduced in IEEE 802.11ad to improve reliability of communication in a DMG Basic Service Set (BSS) in scenarios where a direct link exists between the S-REDS and D-REDS. The unmodified relaying procedure may require that the direct-link must be first established between S-REDS and D-REDS, before a relay node is introduced between them. This limits the utility of the relaying procedure, requiring the source and destination REDS to be within communication range of each other. Methods and procedures are disclosed herein to support range-extension relaying schemes, so that a requirement of direct-link between the S-REDS and D-REDS may be made redundant. The communication between the S-REDS and D-REDS through RDS may be controlled by either S-REDS or Personal Basic Service Set (PBSS) control point (PCP)/AP.

The unmodified procedure requires that all STAs be associated and be part of a PBSS/BSS before they can participate in the relay procedure. The unmodified relaying procedure in IEEE 802.11ad is not capable of extending the coverage-range of the PBSS/BSS.

FIG. 3 is a diagram of a deployment example for coverage extension 300. Referring to FIG. 3, the BSS coverage 310 of the S-REDS 320 is outside the communication range 330 of the D-REDS 340. In this example, an RDS 350 may be used to create an extended BSS coverage 360 of the S-REDS 320, even though the S-REDS 320 might be outside the physical discovery and communication range of the D-REDS 340.

Methods and procedures are also disclosed herein to enable new node discovery, beam-forming training, association, and channel access. Relaying has been introduced in IEEE 802.11ad to improve reliability of communication in a DMG BSS in scenarios where the direct link between the S-REDS and D-REDS is enabled. The existing relaying procedure requires that only one relay DMG STA to be part of S-REDS and D-REDS. It does not allow for multiple relay DMG STAs to be part of the S-REDS and D-REDS. Methods and procedures are disclosed herein to enable the communications between the S-REDS and D-REDS via multiple relays. Areal spectral efficiency may be improved by enabling multiple simultaneously active relays per source-destination pair.

In one example, two nodes, belonging to a BSS/PBSS may setup a relayed link without first forming a direct link between them. In examples using range extension, the S-REDS may make the RDS selection decision. Examples disclosed herein may describe improvements for the RDS selection procedure of IEEE 802.11ad. The unmodified RDS selection procedure requires that the S-REDS should perform beamforming (BF) with the D-REDS and once BF is completed, the S-REDS may transmit a Multi-Relay Channel Measurement Request frame to the D-REDS. In response, the D-REDS may transmit a Multi-Relay Measurement Report frame back to the S-REDS including the channel measurement information between the D-REDS and all RDSs known to the D-REDS.

In examples disclosed herein, the direct link from the S-REDS to D-REDS may or may not be required to report the results of the RDS selection. Therefore, if the S-REDS is outside the range of the D-REDS or the direct link has an insufficient MCS level, the RDS selection may still be performed without the direct link. The S-REDS may perform the RDS selection decision once it collects all the channel measurement information between the S-REDS and all the known RDSs and/or between the D-REDS and all the known RDSs.

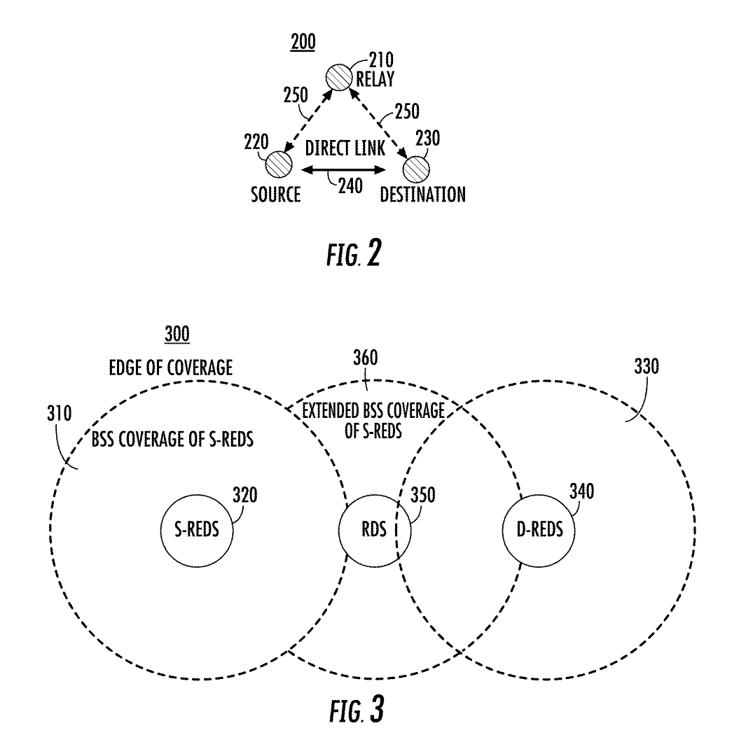

FIG. 4 is a diagram of an example signaling procedure for Relay DMG Station (RDS) selection for range extension 400 involving a S-REDS 401, a PCP/AP 402, a first RDS 403, a second RDS 404, and a D-REDS 405. In this example, the PCP/AP 402 may announce a service period (SP) 410 to the S-REDS 401, D-REDS 405, and also each known RDS 403, 404 in a quasi-omni broadcasting manner to perform beamform (BF) training processing 415.

If a link between the S-REDS 401 and D-REDS 405 is not available, one or more of the RDSs 403, 404 may be used to transmit the Multi-Relay Channel Measurement Request to the D-REDS, and to return the Multi-Relay Channel Measurement Report to the S-REDs. For example, after the RDS 403, 404 completes BF processing 415 with both the S-REDS 401 and D-REDS 405, the S-REDS 401 may transmit a Multi-Relay Channel Measurement Request 420A, 420B to each RDS 403, 404, which may respond with the transmission of a Multi-Relay Channel Measurement Report frame 425A, 425B back to the S-REDS 401. Following the reception of the Multi-Relay Channel Measurement Request 420A, 420B, each RDS 403, 404 may transmit a Multi-Relay Channel Measurement Request 430A, 430B to the D-REDS 405, which may also respond with the transmission of a Multi-Relay Channel Measurement Report 435A, 435B back to each RDS 403, 404. By performing this procedure, each RDS 403, 404 may collect the channel information measured both at the RDS 403, 404 and the D-REDS 405. Following this procedure, the S-REDS 401 may transmit another Multi-Relay Channel Measurement Request 440A, 440B to each RDS 403, 404, which may respond with the transmission of a Multi-Relay Channel Measurement Report 445A, 445B back to the S-REDS 401. After performing an optional BF processing, the PCP/AP may either announce a SP to the S-REDS and each RDS again to obtain the second channel report between the S-REDS and RDS or include the schedule for the second Multi-Relay Channel Measurement Request/Response between the S-REDS and RDS in the first announcement. The second channel report from RDS to the S-REDS may contain the channel information between RDS and the D-REDS.

The BF processing between the S-REDS and D-REDS may or may not be used, for example, because the direct link may be redundant.

Correspondingly, the Multi-Relay Channel Measurement Report may be modified to report the channel information measured at both RDS and the D-REDS. FIG. 5 is a diagram of an example modified Multi-Relay Channel Measurement Report Frame Action field format 500. The Multi-Relay Channel Measurement Report Frame Action field format 500 may include a Category field 510, a DMG action field 520, a dialog token 530, a Channel Measurement Information field 540, and a Remote Channel Measurement Information field 550. The format of the Remote Channel Measurement Information field 550 may be the same as the Channel Measurement Information field 540; however, the Channel Measurement Information field 540 may include the channel information measured from the one or more RDSs to the D-REDS and the Remote Channel Measurement Information field 550 may include the channel information measured from the D-REDS to the one or more RDSs.

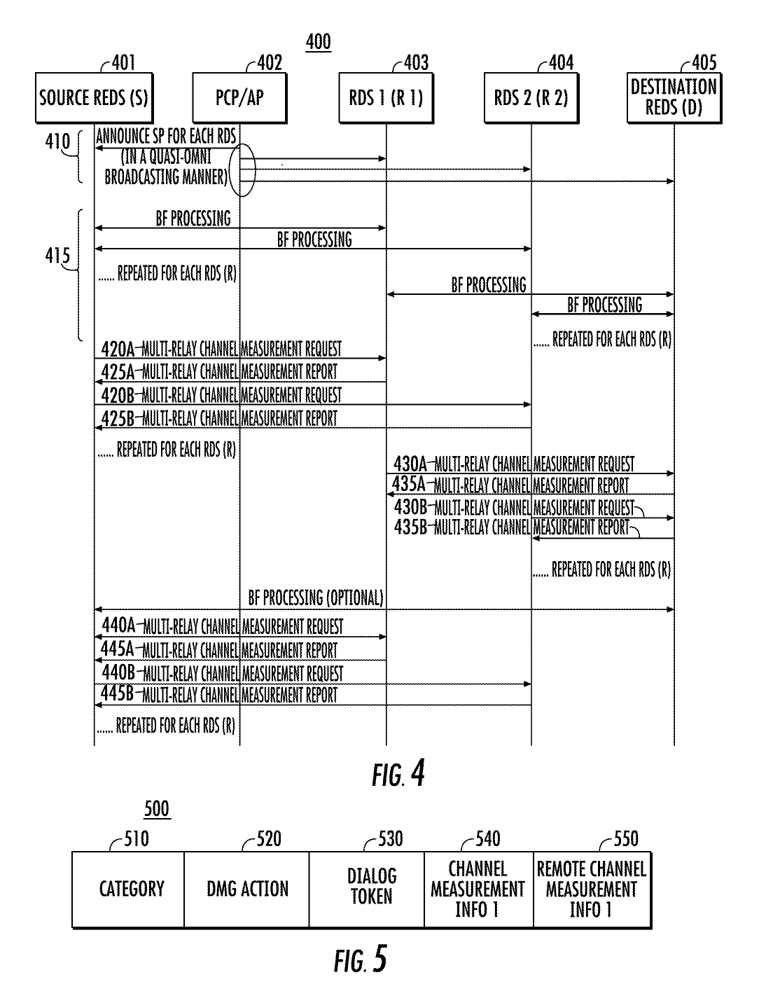

FIG. 6 is a diagram of another example signaling procedure for RDS selection for range extension 600 involving a S-REDS 601, a PCP/AP 602, a first RDS 603, a second RDS 604, and a D-REDS 605. In this example, the RDS selection procedure may be performed when the S-REDS 601 is outside the range of the D-REDS 605. For example, if a link between the S-REDS 601 and D-REDS 605 is not available, the one or more RDS 603, 604 may be used to transmit the Multi-Relay Channel Measurement Request to the D-REDS, and to return the Multi-Relay Channel Measurement Report to the S-REDs. After each RDS 603, 604 completes BF processing 610 with both the S-REDS 601 and D-REDS 605, each RDS 603, 604 may transmit a Multi-Relay Channel Measurement Request 620A, 620B to the D-REDS 605, which may respond with the transmission of a Multi-Relay Measurement Report 625A, 625B back to each RDS 603, 604. Then RDS may collect the channel information measured at both RDS 603, 604 and D-REDS 605. The S-REDS 601 may transmit a Multi-Relay Channel Measurement Request 630A, 630B to each RDS 603, 604, which may respond with the transmission of a Multi-Relay Channel Measurement Report 635A, 635B back to the S-REDS 601. At this time, the Multi-Relay Channel Measurement Report 635A, 635B may contain not only the channel information measured from the S-REDS 601 to RDS 603, 604, but also the channel information between RDS 603, 604 and the D-REDS 605. In an example, the BF processing 640 between the S-REDS 601 and D-REDS 605 may or may not be used.

FIG. 7 is a diagram of an example Multi-Relay Measurement Report 700 that may be modified to report the channel information measured at both RDS and the D-REDS and also measured from the S-REDS to RDS. The Multi-Relay Channel Measurement Report Frame Action field format 700 may include a Category field 710, a DMG action field 720, a dialog token 730, a Channel Measurement Information 1 field 740, a Channel Measurement Information 2 field 750, and a Remote Channel Measurement Information field 760. The Channel Measurement Information 1 field 740 may include the channel information measured from the S-REDS to the RDS, the Channel Measurement Information 2 field 750 may include the channel information measured from the RDS to the D-REDS and the Remote Channel Measurement Information 1 field 760 may include the channel information measured from the D-REDS to the RDS.

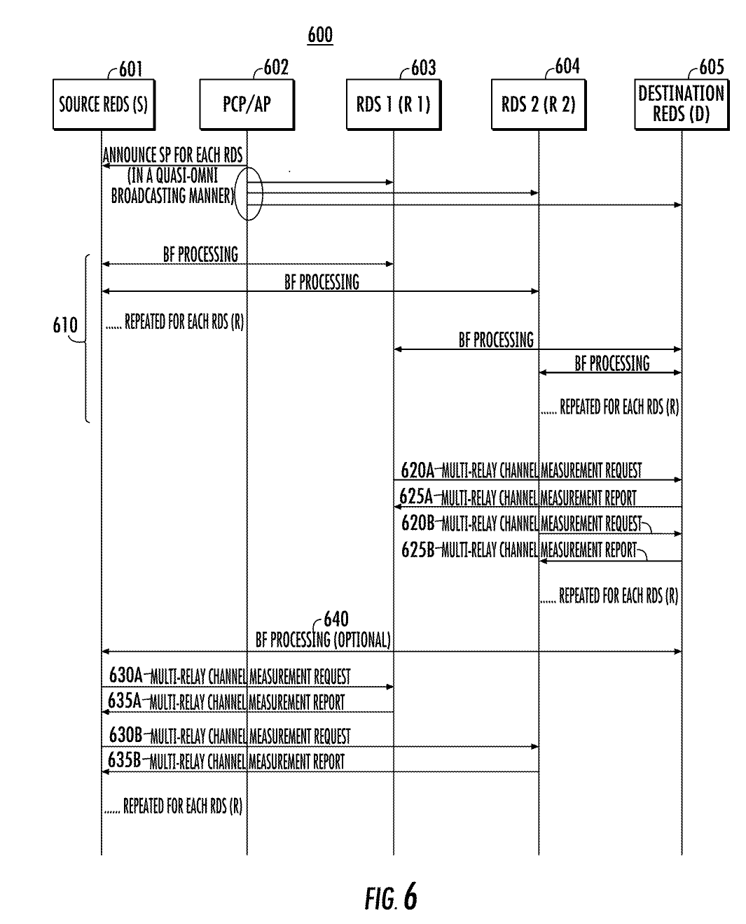

FIG. 8 is a diagram of an example range extension scenario 800. In an example of range extension, an S-REDS and a D-REDS, shown as STA 1 810 and STA 3 820 respectively, may be outside direct communication range but may communicate with an AP/PCP 830 for control. For example, two STAs may belong to the same BSS/PBSS but may be outside direct communication range. Therefore, each STA may communicate with the AP/PCP 830 and/or another STA 840 but cannot directly communicate with each other.

The following describes an example procedure followed by the first STA, called S-REDS henceforth, to discover and establish a link with the second STA, called D-REDS here, through a Relay STA, also called an RDS. This procedure may be enabled by the AP/PCP, which may be in direct communication with all three nodes: S-REDS, D-REDS and RDS.

FIG. 9 is a diagram of an example signaling procedure for a link setup for range extension 900. FIG. 9 shows an example link setup procedure between an S-REDS 901 and a D-REDS 902 through an RDS 903, with assistance from an AP/PCP 904. Initially, the S-REDS 901 may determine the identity of a capable D-REDS 902 by transmitting an Information Request message 905 to the AP/PCP 904 with the Subject Address field set to the Broadcast address. In response, the AP/PCP 604 may transmit an Information Response message 907 with the identities and capabilities of all BSS/PBSS members. The S-REDS 901 may transmit a Relay Link Setup Request 909 to the AP/PCP 904. The Relay Link Setup Request 909 may include an indicator that indicates the D-REDS 902 as the destination STA. The AP/PCP 904 may transmit an Extended Schedule 911 to the S-REDS 901. The Extended Schedule 911 may include a BF training field set to 1 and a destination AID field that indicates the D-REDS 902. The AP/PCP 904 may also transmit an Extended Schedule 913 to the D-REDS 902. The Extended Schedule 913 may include a BF training field set to 1 and a destination AID field that indicates the S-REDS 901.

Beamforming training 915 may be performed between the S-REDS 901 and the D-REDS 902 during an allotted time. The S-REDS 901 may transmit a BF-Training Report 917 to the AP/PCP 904 that indicates a receive signal strength. The D-REDS 902 may transmit a BF-Training Report 919 to the AP/PCP 904 that indicates a receive signal strength. The AP/PCP 904 may determine 921 that a direct link between the S-REDS 901 and the D-REDS 902 is not possible. The AP/PCP 904 may perform an optional Potential Relay Set reduction procedure 923.

BF-Training 925 may be performed between the S-REDS 901 and the potential relays. The AP/PCP 904 may transmit an Extended Schedule 927 to the S-REDS 901. The Extended Schedule 927 may include a BF training field set to 1 and a destination AID that indicates the RDS 903. The AP/PCP 904 may transmit an Extended Schedule 929 to the RDS 903. The Extended Schedule 929 may include a BF training field set to 1 and a destination AID that indicates the S-REDS 901. The Extended Schedule may be transmitted to all the STAs in the BSS/PBSS except the S-REDS 901 and the D-REDS 902. BF training 931 may be performed between the S-REDS 901 and the RDS 903 during an allotted time. The S-REDS 901 may transmit a BF-Training Report 933 to the AP/PCP 904. The BF-Training Report 933 may include a receive signal strength. The RDS 903 may transmit a BF-Training Report 935 to the AP/PCP 904. The BF-Training Report 935 may include a receive signal strength. In this example, only one STA is shown performing BF training with the S-REDS 901 for simplicity. It is noted that BF Training results may be reported by all STAs performing BF training with the S-REDS 901.

BF-Training 937 may be performed between the D-REDS 902 and the potential relays. The AP/PCP 904 may transmit an Extended Schedule 939 to the D-REDS 902. The Extended Schedule 939 may include a BF training field set to 1 and a destination AID that indicates the RDS 903. The AP/PCP 904 may transmit an Extended Schedule 941 to the RDS 903. The Extended Schedule 941 may include a BF training field set to 1 and a destination AID that indicates the S-REDS 901. The Extended Schedule may be transmitted to all the STAs in the BSS/PBSS except the S-REDS 901 and the D-REDS 902. BF training 943 may be performed between the D-REDS 902 and the RDS 903 during an allotted time. The D-REDS 902 may transmit a BF-Training Report 945 to the AP/PCP 904. The BF-Training Report 945 may include a receive signal strength. The RDS 903 may transmit a BF-Training Report 947 to the AP/PCP 904. The BF-Training Report 947 may include a receive signal strength. In this example, only one STA is shown performing BF training with the S-REDS 901 for simplicity. It is noted that BF Training results may be reported by all STAs performing BF training with the S-REDS 901.

The AP/PCP 904 may determine 949 that the RDS 903 will act as a relay for communications between the S-REDS 901 and the D-REDS 902. The AP/PCP may transmit a Relay Link Setup Response 951 to the S-REDS 901. The Relay Link Setup Response 951 may include a relay field that indicates that the RDS 903 will function as a relay. The AP/PCP 904 may transmit a Relay Link Setup Response 953 to the RDS 903. The Relay Setup Response 953 may include an indicator that indicates that the source is the S-REDS 901 and an indicator that indicates that the destination is the D-REDS 902. The AP/PCP 904 may transmit a Relay Link Setup Response 955 to the D-REDS 902. The Relay Setup Response 955 may include an indicator that indicates that the source is the S-REDS 901 and an indicator that indicates that the RDS 903 is a relay.

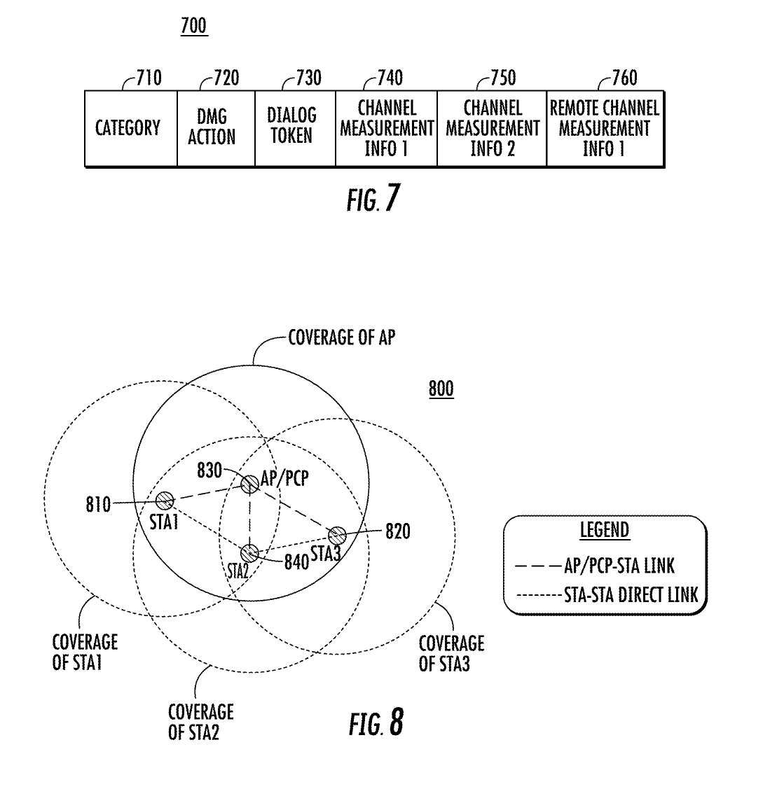

FIG. 10 is a diagram of an example Relay Link Setup Request frame Action field format 1000. The Relay Link Setup Request frame Action field format 1000 may include a Category field 1010, a DMG Action field 1020, a Dialog Token field 1030, a Destination AID field 1040, a Source AID 1050, and one or more RDS Order-Relay AIDS field(s) 1060.

In one example, from the received information, STA 1 (S-REDS) may determine that STA 3 is a valid D-REDS. The S-REDS may then transmit a Relay Link Setup Request message to the AP/PCP and include STA 3's address as the Target. Then, at first, a direct link establishment may be attempted between S-REDS and D-REDS by the AP/PCP. This may involve performing BF-Training between the S-REDS and D-REDS and transmitting the results to the AP/PCP. If a direct link is found infeasible, based on a channel quality report received as part of BF-TRAINING Report message at the AP/PCP, then a relay link setup may be attempted by the AP/PCP between the S-REDS and D-REDS.

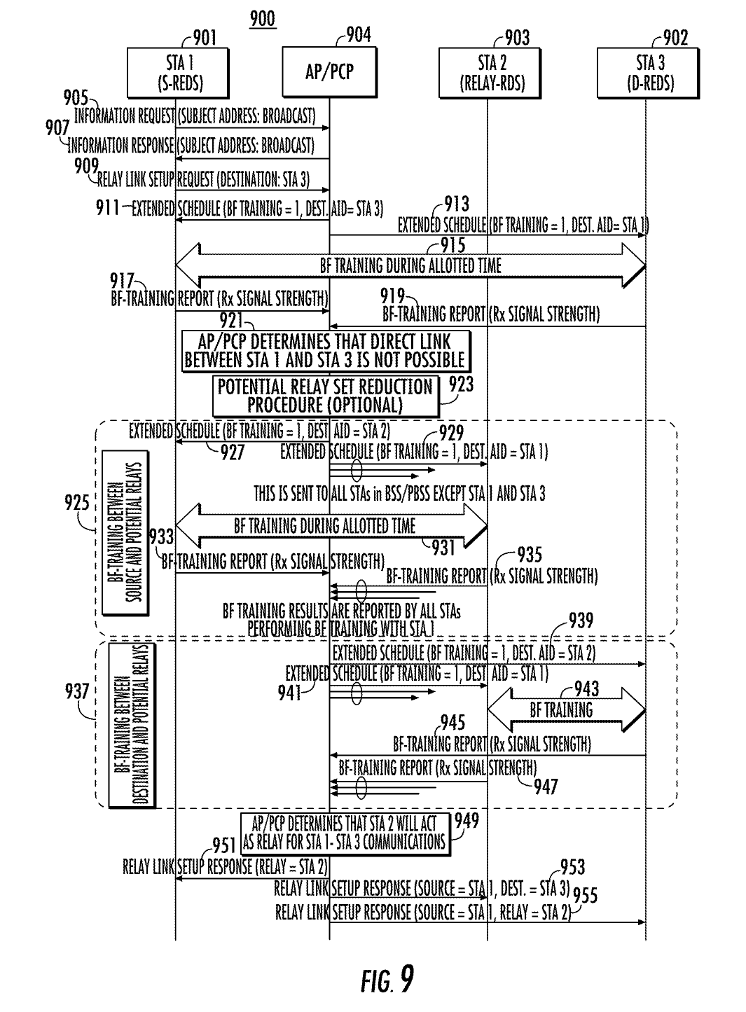

FIG. 11 is a diagram of an example signaling procedure for a potential relay set reduction 1100. In this example, an S-REDS 1101, an AP/PCP 1102, an RDS 1103, and a D-REDS 1104 may perform relay link setup, the AP/PCP 1102 may perform the potential relay set reduction procedure. This procedure may reduce the number of potential relays, thereby reducing the relay setup time. This procedure may have two phases. A first phase 1105 may include an assessment of channel quality between S-REDS and all potential relays, and a second phase 1106 may include an assessment of channel quality between D-REDS and all potential relays. At the start of each phase, the AP/PCP 1102 may transmit an Extended Schedule 1107 containing a channel allocation for Sector Level Sweep (SLS) for a BF-Training procedure. The Extended Schedule 1107 may be transmitted to the S-REDS 1101 at the start of the first phase 1105 and the Extended Schedule 1108 may be transmitted to D-REDS 1104 at the start of the second phase 1106. Thereafter, in each phase the Extended Schedules 1109, 1111 may be transmitted to all potential Relays within the BSS/PBSS.

At an allotted time in the first phase 1105, the S-REDS 1101 may perform an SLS procedure 1113. The SLS procedure 1113 may involve transmitting a control message via each sector in sequence. The control message may be a Sector Sweep (SSW) frame and may be repeated M*N times, where M and N are the number of transmitter and maximum receiver sectors at the S-REDS 1101 and potential relays, respectively. In the second phase 1106 the same process may be repeated between D-REDS 1104 and all potential Relays. At the end of each phase the AP/PCP 1102 may receive the BF-Training Report message 1115, 1117 containing the channel reports between the S-REDS 1101 or D-REDS 1104 and the potential Relays. Once these channel reports are received, the AP/PCP 1102 may identify the nodes that will not be able to perform adequately as RDSs. The remaining nodes may form the Potential Relay Set and may be utilized in the subsequent procedure. The set of potential Relays may be reduced based on the received BF-Training Reports 1119.

In another example, the potential Relay nodes may transmit SSW frames directionally at pre-determined time slots and the S-REDS 1101 and D-REDS 1104 may receive directionally, according to a pre-determined schedule. The potential Relay nodes may transmit the SSW frames sequentially based on the schedule provided by the AP/PCP 1102. The scan results may then be transmitted by the S-REDS 1101 and D-REDS 1104 to the PCP/AP 1102 for potential Relay Set determination.

Once the Potential Relay Set is determined, the AP/PCP 1102 may set up separate SPs for performing BF-Training between the S-REDS 1101 and all potential Relay STAs or RDSs in the BSS/PBSS. Additionally, SPs may be allocated for performing BF-Training between the D-REDS 1104 and potential Relay STAs or RDSs in the BSS/PBSS. After assessing all the channel quality reports for each individual link, the AP/PCP 1102 may determine a STA that will act as a Relay STA or an RDS between the S-REDS 1101 and the D-REDS 1104. In this example, STA 2 may be deemed to act as the Relay STA or RDS 1103.

The AP/PCP 1102 may communicate its RDS choice via the Relay Link Setup Response message to the S-REDS 1101. Additionally, the AP/PCP 1102 may transmit one or more unsolicited Relay Link Setup Response messages to the D-REDS 1104 and the RDS 1103 with the identities of the S-REDS 1101, RDS 1103 and D-REDS 1104, as appropriate.

FIG. 12 is a diagram of an example signaling procedure for range extension and periodic data transfer 1200. This example signaling procedure may involve an S-REDS 1201, an AP/PCP 1202, and RDS 1203, and a D-REDS 1204. Once a link is setup 1205 between the S-REDS 1201 and the D-REDS 1204 through the RDS 1203, periodic end-to-end data communication may be set up by either the S-REDS 1201 or the D-REDS 1204 transmitting a Relay ADDTS Request message 1219 to the AP/PCP 1202. The Relay ADDTS Request message 1210 may include the relevant parameters for the requested channel access. The AP/PCP 1202 may determine the schedule for STA 1-STA 2 (i.e., S-REDS-RDS) and STA 2-STA 3 (i.e., RDS-D-REDS) communications, depending on their respective channel qualities. The schedule may be communicated to the three nodes in the Relay ADDTS Response messages 1215, 1220, 1225. Additionally, the new SP schedule may be included in the Extended Schedule element included in the following DMG Beacon transmissions 1230 to setup the first SP 1235 and the second SP 1240. This procedure may be used for periodic data transfer between the nodes. The schedule may be changed by transmitting another Relay ADDTS Request message, and the change may become effective in the next Beacon Interval when a new Extended Schedule may be transmitted in the DMG Beacon or Announce frames.

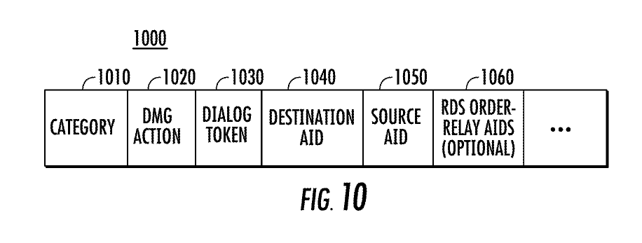

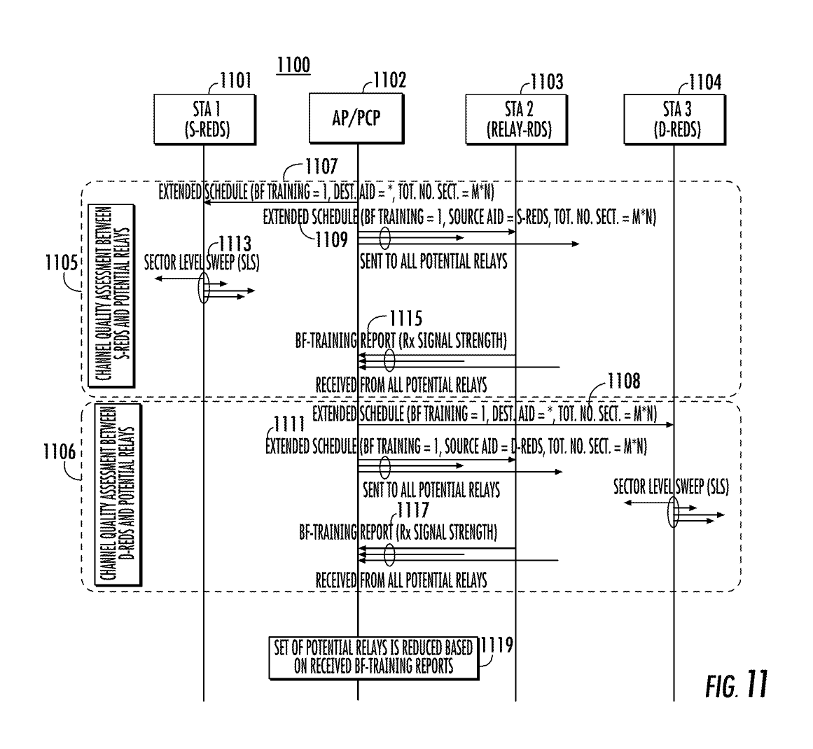

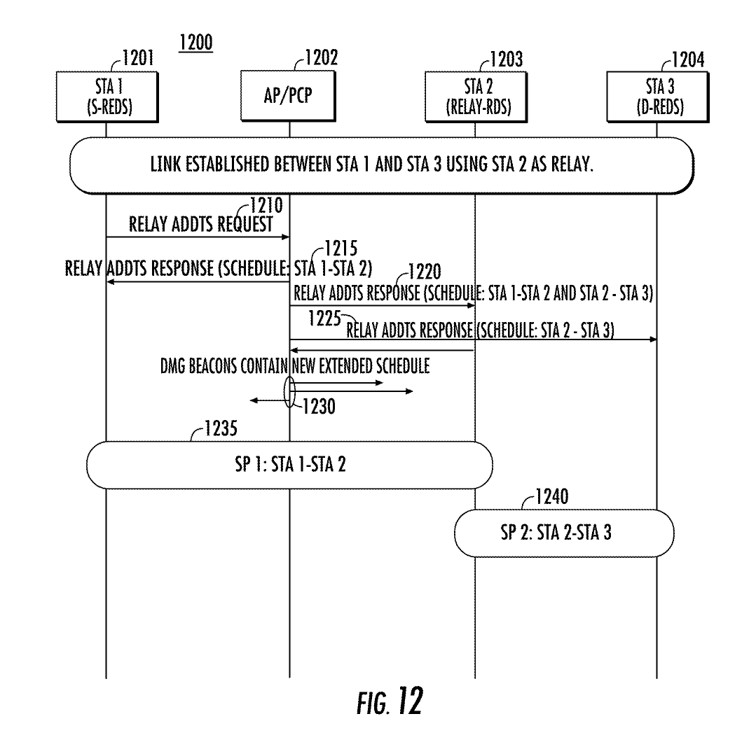

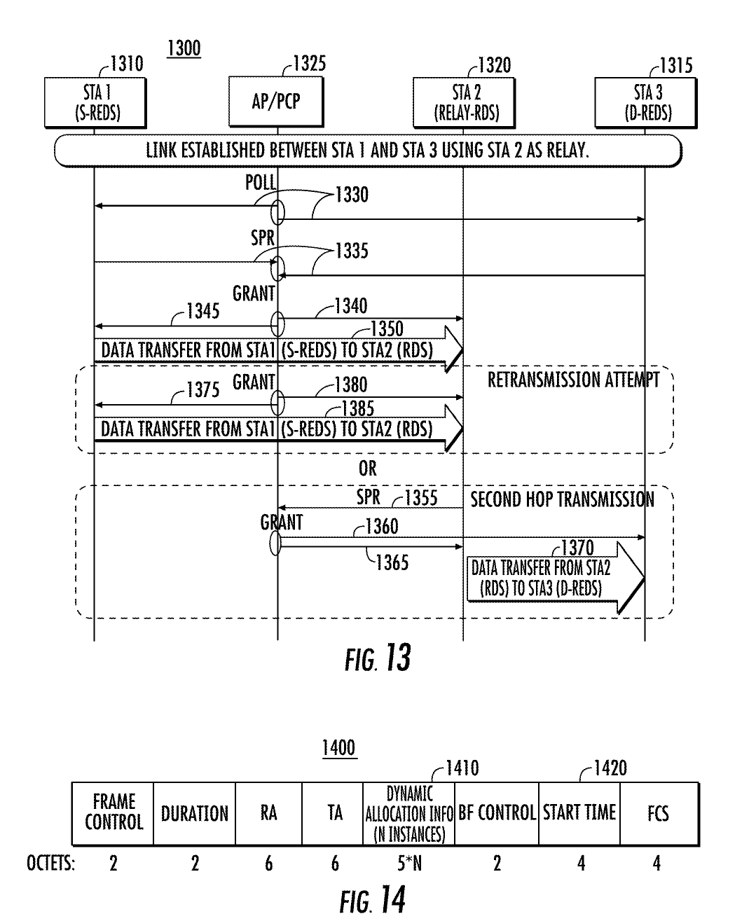

FIG. 13 is a diagram of an example signaling procedure for range extension and polled data transfer 1300. In this example, a link may be established 1305 between an S-REDS 1310 and a D-REDS 1315 via an RDS 1320. FIG. 13 shows the procedure for data transfer where the nodes may be first polled by a AP/PCP 1325 transmitting a Poll message 1330. This may follow the device discovery, association and RDS selection steps described previously. Each STA, upon receiving the Poll message 1330 from the AP/PCP 1325, may transmit a Service Period Request (SPR) 1335 containing its channel time requirement. The SPR message 1335 may optionally include multiple Dynamic Allocation Info fields, for different data queues. This information may enable the AP/PCP 1325 to prioritize channel access according to queue occupancy across multiple STAs.

To allocate channel time for data transfer via the RDS 1320, the AP/PCP 1325 may transmit two or more Grant frames 1340, 1345, the first Grant frame 1340 to the RDS 1320 and the second Grant frame 1345 to S-REDS 1310. The S-REDS 1310 may start data transmission 1350 to the RDS 1320 after receiving the Grant frame 1345 from the AP/PCP 1325. If the S-REDS 1310 had requested channel time for data transmission from multiple queues in the SPR frame 1335, then the S-REDS 1310 may transmit from the queues for which channel time is allocated in the Grant frame 1345 received from the AP/PCP 1325. The S-REDS 1310 may start data transmission 1350 after a Short Inter-Frame Spacing (SIFS) duration of receiving the Grant frame 1345.

When the data packets are correctly received by the RDS 1320 it may transmit an SPR frame 1355 to the AP/PCP 1325 to request for resources for packet transmission on the second hop between the RDS 1320 and D-REDS 1315. The AP/PCP 1325 may then transmit two Grants, the first Grant frame 1360 to the D-REDS 1315 and the second Grant frame 1365 to the RDS 1320. The RDS 1320 may start data transmission 1370 to D-REDS 1315 after receiving the Grant frame 1365 from the AP/PCP 1325. If the RDS 1320 had requested channel time for data transmission from multiple queues in the SPR frame 1355, then the RDS 1320 may transmit from the queues for which channel time is allocated in the Grant frame 1365 received from the AP/PCP 1325. The RDS 1320 may start data transmission 1370 after a Short Inter-Frame Spacing (SIFS) duration of receiving the Grant frame.

If the AP/PCP 1325 does not receive the SPR frame 1355 from the RDS 1320 at the expected time, then it again may transmit a first Grant frame 1375 to the S-REDS 1310 and a second Grant frame 1380 the RDS 1320 for re-transmission 1385 on the first hop, provided the maximum retransmission limit is not reached for the particular hop.

FIG. 14 is a diagram of an example modified Grant frame format 1400. The modified Grant frame format 1400 may include a Dynamic Allocation Information field 1410 that indicates N instances that may correspond to multiple queues. The modified Grant frame format 1400 may include a Start Time field 1420. If the modified grant frame format 1400 is used, the S-REDS may start data transmission at the Start Time indicated in the Grant frame. The Start Time field 1420 may indicate the lower order 4 octets of the Timing Synchronization Function (TSF) timer corresponding to the channel time allocation.

In one example, frame exchange rules for half-duplex/decode and forward (HD/DF) mode may be used. For example, no direct link may exist due to the REDS being out of range of each other, therefore the S-REDS may use a relay link to initiate frame transmission to the D-REDS at the start of the first SP in the 1st period. S-REDS to RDS transmission and RDS to D-REDS transmission may repeat if all packets are successfully transmitted. Per-link acknowledgment (ACK) and end-to-end ACK may both be needed to indicate per link transmission and end-to-end transmission success.

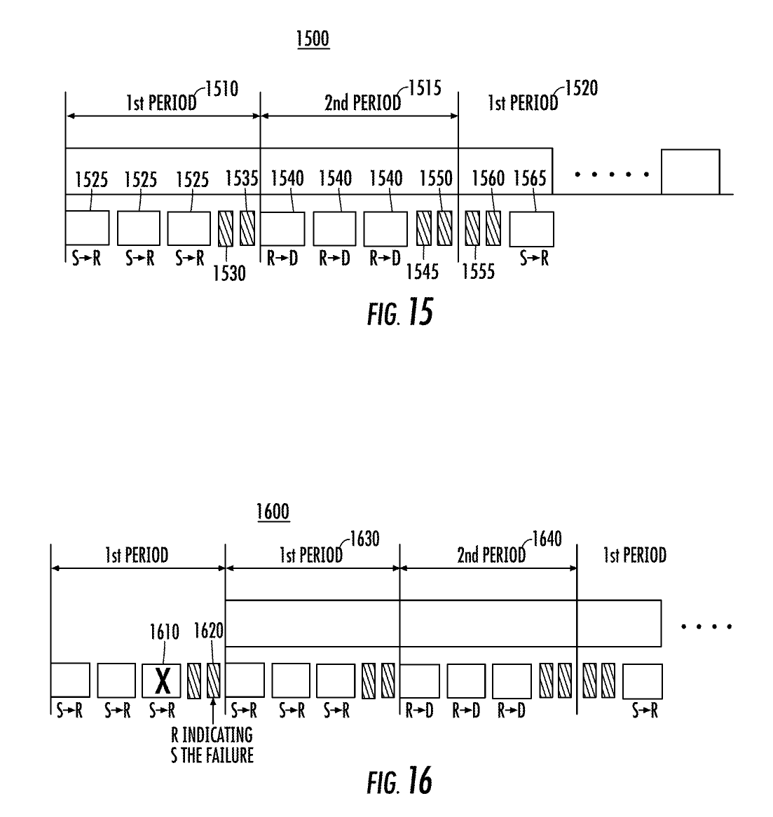

FIG. 15 is a diagram of an example of service period transmissions 1500 between S-REDS and D-REDS. Without link failure, the 1st period transmission 1510 and 2nd period transmission 1515 between S-REDS and D-REDS may repeat 1520 as illustrated in FIG. 15. In the 1st transmission period 1510, the S-REDS may transmit one or more data frames 1525 to the RDS followed by a Block Acknowledgement (ACK) Request (BAR) frame 1530 to the RDS. In response, the RDS may transmit a Block ACK (BA) frame 1535 to the S-REDS. In the 2nd period 1515, the RDS may transmit one or more data frames 1540 to the D-REDS followed by a BAR frame 1545 to the D-REDS. In response, the D-REDS may transmit a BA frame 1550 to the RDS. When the 1st period repeats 1520, the S-REDS may transmit a Relay ACK Request 1555 to the RDS. Upon receipt of a Relay ACK Response 1560 from the RDS, the S-REDS may begin data transmission 1565 to the RDS. Considering the failure situation due to blockage or channel degradation, there may be several cases that may trigger retransmission, examples of which may be described as follows.

FIG. 16 is a diagram of another example of service period transmissions 1600. In this example, a data transmission 1610 between the S-REDS and the RDS may fail. The BA frame to relay link 1620 may indicate the failure to S-REDS. Hence, both S-REDS and RDS may notice this failure, which may trigger the retransmission during another 1st period 1630 between S-REDS and RDS. If this time the transmission between S-REDS and RDS is successfully completed, the 2nd period 1640 may follow to start the transmission between RDS and D-REDS.

FIG. 17 is a diagram of another example of service period transmissions 1700. In this example, data may be successfully transmitted between S-REDS and RDS. However, a BA frame to relay link 1710 may fail to be received by S-REDS. In this case, the RDS is not aware of the failure, therefore it may continue forwarding the data packets 1720 to D-REDS in the 2nd period 1730. Depending on the success of the 2nd period 1730 transmissions, multiple cases may occur as shown in the following examples.

For example, if the 2nd period 1730 transmission succeeds, and a relay ACK response 1740 is received by the S-REDS, then the failed BA frame 1710 in the 1st period 1750 may or may not affect this end-to-end transmission. The S-REDS may start to initialize another transmission to RDS.

FIG. 18 is a diagram of another example of service period transmissions 1800. In this example, the S-REDS may notice the failure 1805 between the S-REDS and the RDS without receiving an ACK response from the RDS. If during the 2nd period 1810, a BA frame 1820 is not successfully received by RDS, a relay ACK response 1830 may indicate the failure to S-REDS without receiving an ACK from the D-REDS. Depending on the failure on both S-REDS to RDS and RDS to D-REDS, the S-REDS may start to initialize the retransmission 1840 for both S-REDS to RDS and RDS to D-REDS.

FIG. 19 is a diagram of yet another example of service period transmissions 1900. In this example, the S-REDS may notice the failure 1910 between the S-REDS and the RDS without receiving an ACK response from the RDS. If during the 2nd period 1920, data transmission 1930 from RDS to D-REDS fails, a BA frame to relay link 1935 may indicate the failure to the RDS, and a relay ACK response 1940 may indicate the failure to S-REDS. Depending on the failure on both S-REDS to RDS and RDS to D-REDS, S-REDS may start to initialize the retransmission 1950 for both S-REDS to RDS and RDS to D-REDS.

FIG. 20 is a diagram of another example of service period transmissions 2000. In this example, if the 1st period 2010 between S-REDS and RDS is successfully transmitted, and a data transmission 2020 from RDS to D-REDS fails, a relay ACK response 2030 may indicate the failure to S-REDS. The RDS may start the retransmission 2040 between RDS and D-REDS in another 2nd period 2050.

FIG. 21 is a diagram of another example of service period transmissions 2100. In this example, the 1st period 2110 between S-REDS and RDS is successfully transmitted, and data transmission from the RDS to D-REDS succeeds but a BA frame 2120 from the D-REDS to RDS may or may not have been received. A Relay ACK response 2130 may indicate the failure to S-REDS. The RDS may start the retransmission 2140 between RDS and D-REDS in another 2nd period 2150.

In an example of coverage extension, extended PBSS/BSS discovery may be used via enhanced RDS (eRDS) that transmits a beacon. Methods and procedures are disclosed herein for a node to join a PBSS/BSS when it is beyond beacon range of an AP/PCP. In one example, an eRDS may transmit beacons for new node discovery. Further, methods and procedures may be applied for channel access for a relay link including eRDS.

Methods and procedures may be used to extend the coverage of the PBSS/BSS of the S-REDS. The D-REDS is initially outside the coverage area, and the S-REDS may only be able to discover the RDS through the RDS discovery procedure in IEEE 802.11ad-2012, for example. But for the D-REDS to discover the RDS, the RDS may need to broadcast a beacon. For this example, a modified type of RDS referred to as the eRDS may be used.

The RDS in the coverage of the S-REDS may be associated through standard association and authentication procedures. The S-REDS may obtain a list of RDSs per an RDS discovery procedure in, for example, IEEE 802.11ad-2012. After discovery of the RDSs, the S-RED may select the RDS to support range extension if the RDS has reported that it is eRDS capable. The measurement reports resulting from this selection procedure may be used to determine suitability of the RDS to serve as an eRDS.

FIG. 22 is a diagram of an example of a frame control field 2200, including information for an eRDS beacon configuration 2210. A modified capability may be used for the RDS, an eRDS, whereby the RDS provides coverage extension for the S-REDS. A modified action frame message referred to as ‘eRDS Setup’ may be added to support setup of the eRDS.

Table 1 below shows an example of MLME-eRDS_Setup Primitive Parameters.

TABLE 1
MLME-eRDS_Setup Primitive Parameters

| Name | Type | Valid Range | Description |
|---|---|---|---|
| eRDS MAC Address | MAC | Any valid | Specifies the MAC |
| | Address | individual | address of the |
| | | MAC address | selected eRDS |
| DestinationCapability | As defined | As defined in | Indicates the Relay |
| Information | in frame | frame format | capabilities info field |
| | format | | within the Relay |
| | | | capabilities element |
| | | | of the target |
| | | | destination relay |
| | | | endpoint DMG STA |
| | | | (REDS). |
| RelayCapabilityInformation | As defined | As defined in | Indicates the Relay |
| | in frame | frame format | capabilities info filed |
| | format | | within the Relay |
| | | | capabilities element |
| | | | of the selected RDS |
| RelayTransferParameterSet | As defined | As defined in | Specifies the |
| | in frame | frame format | parameters for the |
| | format | | relay operation. |

The eRDS setup message may be initiated at the MLME with primitive parameters as described in Table 1 and may include information for the eRDS beacon configuration, a new BSSID for the eRDS as well as the S-REDS BSSID for association to the eRDS. The eRDS may be set with Discovery mode enabled and may transmit a beacon such that other REDS can discover the extended BSS. The eRDS beacon may be transmitted using the DMG Beacon Frame Control field type, but with a modified subtype value to indicate this is an eRDS, as shown in FIG. 22. Essentially the eRDS may now have a beacon that advertises it is a relay that has a suitable link to the S-REDS. Typically, eRDS and S-REDS beacon may be configured with a ‘Next Beacon’ IE greater than one, such that their beacons can be transmitted in non-overlapping beacon intervals.

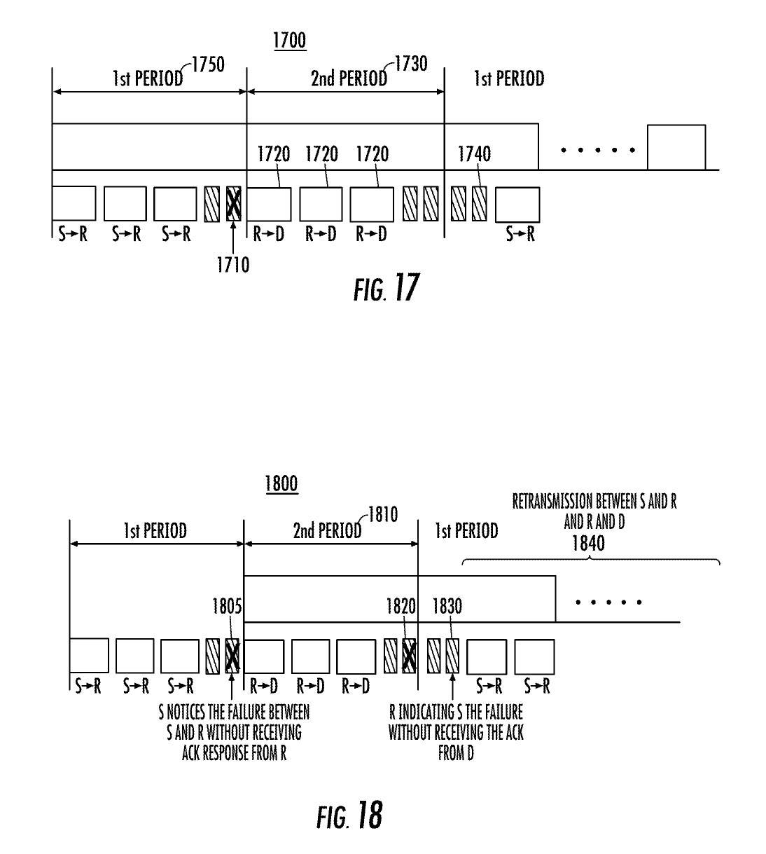

FIG. 23 is a diagram of an example beacon interval control field 2300. The beacon interval control field 2300 may include a CC Present field 2305, a Discovery Mode field 2310, a Next Beacon field 2315, an announcement transmission interval (ATI) Present field 2320, an A-BFT Length field 2325, an FSS field 2330, an IsResponderTXSS field 2335, a Next A-BFT field 2340, a Fragmented TXSS field 2345, a TXSS Span field 2350, an N BIs A-BFT field 2355, an A-BFT Count field 2360, an N A-BFT in Ant field 2365, a PCP Association Ready field 2370, and a Reserved field 2375.

The CC Present field 2305 may indicate a presence of a Clustering Control field in the DMG beacon. The Discovery Mode field 2310 may be set to 1 if the STA is generating the DMG beacon. The Next Beacon field 2315 may indicate the number of beacon intervals following the current beacon interval during which the DMG beacon is not present. The ATI Present field 2320 may be set to 1 to indicate that the ATI is present in the current beacon interval. The A-BFT Length field 2325 may specify the size of the A-BFT following the BTI, and may be defined in units of a sector sweep slot. The FSS field 2330 may specify the number of SSW frames allowed per sector sweep slot. The IsResponderTXSS field 2335 may be set to 1 to indicate that the A-BFT following the BTI is used for responder transmit sector sweep (TXSS). When the IsResponderTXSS field 2335 is set to 0, the FSS field may specify the length of a complete receive sector sweep by the STA transmitting the DMG beacon frame. The Next A-BFT field 2340 may indicate the number of beacon intervals during which the A-BFT is not present. The Fragmented TXSS field 2345 may be set to 1 to indicate the TXSS is a fragmented sector sweep, and may be set to 0 to indicate that the TXSS is a complete sector sweep. The TXSS Span field 2350 may indicate the number of beacon intervals it takes for the STA transmitting the DMG beacon frame to complete the TXSS phase. The N BIs A-BFT field 2355 may indicate the interval, in number of beacon intervals, at which the STA transmitting the DMG beacon frame allocates an A-BFT.

The A-BFT Count field 2360 may indicate the number of A-BFTs since the STA sending the DMG Beacon frame last switched receive (RX) DMG antennas for an A-BFT. A value of 0 may indicate that the DMG antenna used in the forthcoming A-BFT differs from the DMG antenna used in the last A-BFT. This field may be reserved if the value of the Number of RX DMG Antennas field within the STA's DMG Capabilities element is 1.

The N A-BFT in Ant field 2365 may indicate how many A-BFTs the STA sending the DMG Beacon frame receives from each DMG antenna in the DMG antenna receive rotation. This field may be reserved if the value of the Number of RX DMG Antennas field within the STA's DMG Capabilities element is 1.

The PCP Association Ready field 2370 may be set to 1 to indicate that the PCP is ready to receive Association Request frames from non-PCP STAs and may be set to 0 otherwise. This field may be reserved when transmitted by a non-PCP STA.

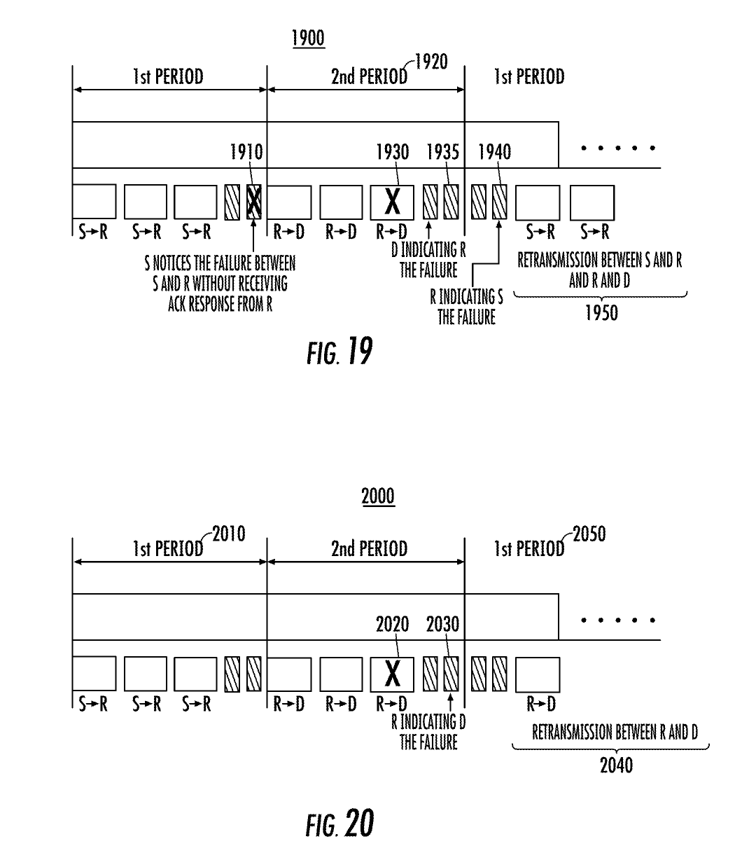

FIG. 24 is a diagram of an example signaling procedure 2400 for BSS extension with an eRDS 2405. In this example, a PCP/AP may function as an S-REDS 2410, and the D-REDS 2415 may be out of range of the S-REDS 2410. The S-REDS 2410 may transmit one or more DMG Beacons 2420 while the D-REDS 2415 scans for beacons 2425. In this example, the D-REDS 2415 may be out of range, therefore the DMG beacons may not be found. The S-REDS 2410 may perform Sector Sweep Beamforming and an association procedure 2430. The eRDS may transmit an Association Response 2435 that includes an indicator that indicates an eRDS Relay Capability.

To establish a link between the S-REDS 2410 and the eRDS 2405, the S-REDS 2410 may transmit an eRDS Setup message 2440. The eRDS Setup message 2440 may include a BSSID=‘eRDS’, configuration information, and an indication that Discovery Mode is enabled. In response, the eRDS 2405 may transmit an eRDS Setup Confirm message 2445 to the S-REDS 2410 to establish the link between the S-REDS 2410 and the eRDS 2405.

The eRDS 2405 may switch to eRDS mode, enable Discovery Mode, and transmit one or more DMG Beacons 2450. A Sector Sweep Beamforming and eRDS Association Procedure 2455 between the eRDS 2405 and the D-REDS 2415 may be performed followed by a Relay Link Setup procedure 2460.

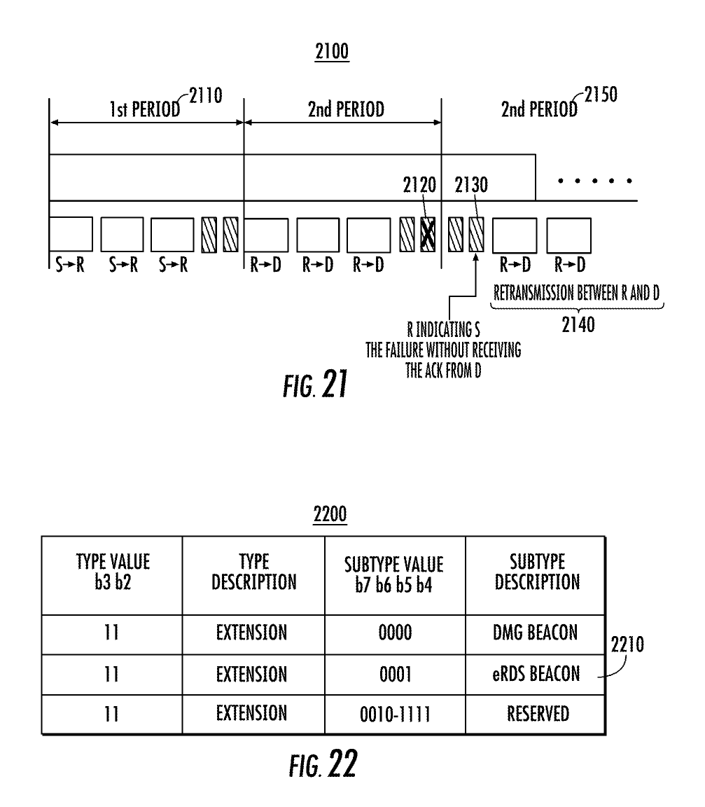

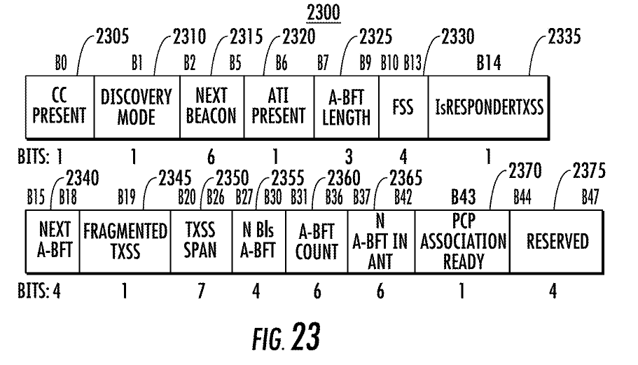

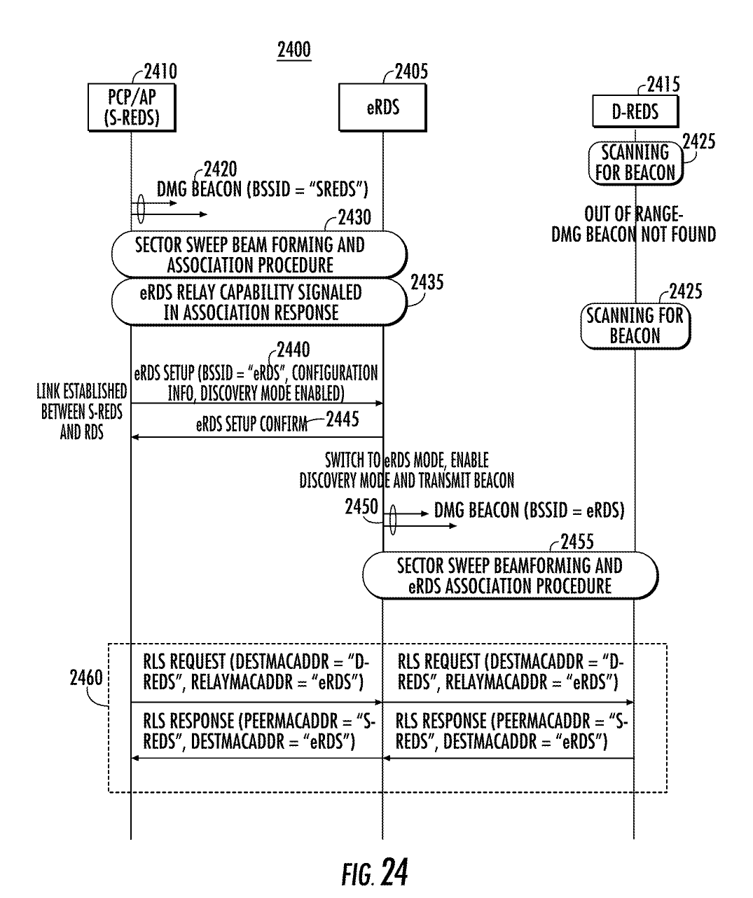

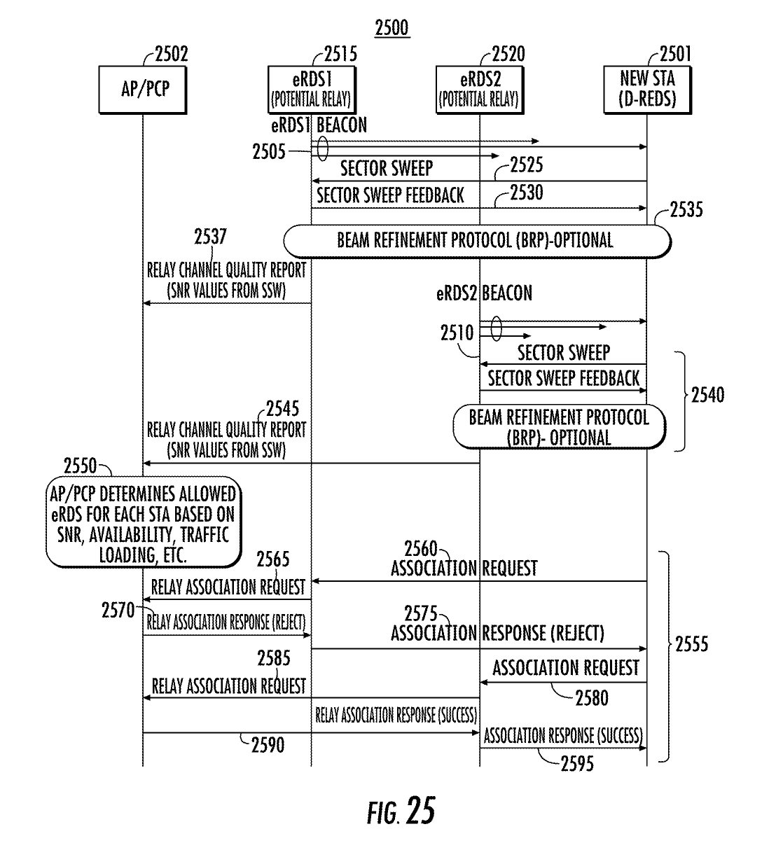

FIG. 25 is a diagram of an example signaling procedure for beamforming and association procedure with a new STA 2500. In this example, the D-REDS 2501 may discover the eRDS and the existence of the associated S-REDS BSSID. Upon issuing the MLME-SCAN.request, beamforming and measurements may be done for the eRDS to D-REDS link, and the eRDS may also return the BSSID and SSID of the S-REDS. The D-REDS 2501 may initiate an association with the AP/PCP 2502 such that the AP/PCP 2502 and D-REDS 2501 may agree on the selected eRDS.

Messages received by the eRDS intended for the S-REDS (as distinguished by the address field showing the BSSID of the S-REDS, but MAC address of the eRDS) may be forwarded to the S-REDS. One exception to this may be the Synchronization messages. Using this exchange, the S-REDS and D-REDS 2501 may complete Relay Link Setup, and other DMG Relay operations. At this point the procedure may follow the steps in, for example, IEEE 802.11ad-2012, starting with the Multi-Relay Measurement Request and continuing through the Relay Link Setup (RLS) procedure. The Multi-Relay Measurement procedure described herein may be used. The procedure in FIG. 24 may be used in the entire extended BSS discovery procedure.

Allocation, beam-forming, and association between the coverage extension relay DMG STA and the D-REDS 2501 may be performed. FIG. 25 shows an example beamforming and association procedure for a new STA, shown as D-REDS 2501, for coverage extension. As described in the section above, the eRDSs may periodically transmit eRDS Beacons, enabling a new STA to discover them. In the example shown in FIG. 25, the D-REDS 2501 may hear eRDS Beacons 2505, 2510 from two eRDSs: eRDS1 2515 and eRDS2 2520. The D-REDS 2501 first may respond to eRDS1 2515 with an SSW frame transmission 2525. eRDS1 2515 may transmit a Sector Sweep Feedback (SSW-Fbck) 2530 in response, and this may end the first phase of BF-Training procedure, also referred to as SLS. In this example, the D-REDS 2501 and eRDS1 2515 may perform a second BF-Training procedure referred to as Beam Refinement Protocol (BRP) 2535. After completing BF-Training with eRDS1 2515, eRDS1 2515 may transmit a Relay Channel Quality Report 2537 to the AP/PCP 2502. The Relay Channel Quality Report 2537 may include SNR values from the Sector Sweep procedure.

The D-REDS 2501 may repeat the BF-Training procedure 2540 with the next discovered eRDS, eRDS2 2520 in this case. At the end of the BF-Training procedure 2540, the eRDS2 2520 may transmit a Relay Channel Quality Report 2545 to the AP/PCP 2502. The Relay Channel Quality Report 2545 may include SNR values from the Sector Sweep procedure. The Relay Channel Quality Reports 2537, 2545 may be different from the Multi-Relay Channel Measurement Report, which is only valid after RDS discovery.

In response to receiving the Relay Channel Quality Reports 2537, 2545, the AP/PCP 2502 may determine 2550 the allowed eRDS for each STA based on, for example, SNR, availability, traffic loading, etc., and perform an association procedure 2555.

After completing BF-Training with all discovered eRDSs the D-REDS 2501 that is out of range of the AP/PCP 2502 may form an association with an eRDS and AP/STA such that, the D-REDS 2501 may order them based on a received signal power or other criteria. The D-REDS 2501 may transmit an Association Request 2560 message to the eRDS that is the highest priority in its ordered list, in this example eRDS1 2515. The chosen eRDS may then transmit a Relay Association Request 2565 message to the AP/PCP 2502. This may be similar to an IEEE 802.11 Association Request message, with an additional field for the D-REDS 2501 address. The AP/PCP 2502 may communicate the association decision in the Relay Association Response 2570 message transmitted to eRDS1 2515. The AP/PCP 2502 may determine the validity of an eRDS based on a combined knowledge of channel qualities, availability of each eRDS (as other sessions may already be using this RDS), and/or traffic loading on each eRDS. In the example shown in FIG. 25, the AP/PCP 2502 may reject the Relay Association Request 2565 received from eRDS1 2515. This decision may be conveyed to the D-REDS 2501 through the Association Response message 2575 by eRDS1 2515. The D-REDS 2501 may then transmit an Association Request message 2580 to eRDS2 2520, which may then transmit a Relay Association Request message 2585 to the AP/PCP 2502. AP/PCP 2502 may allow the D-REDS 2501 to associate with eRDS2 2520 in this example, and this may be conveyed to eRDS2 2520 and the D-REDS 2501 through the Relay Association Response message 2590 and Association Response message 2595, respectively.

FIG. 26 is a diagram of an example of the contents of a relay channel information message 2600. As shown in FIG. 26, the contents of this message may include the new STA MAC address 2610, the Received Channel Power Indicator (RCPI) 2620, and optionally the Signal-to-Noise Ratio (SNR) 2630 if BRP is performed. These fields for each parameter may follow the format included in, for example, IEEE 802.11ad-2012 specifications. Additionally, the Relay Channel Quality Report may be transmitted by the eRDS whenever there is a change greater than a predetermined threshold in the channel quality between the eRDS and new STA.

Channel access may be provided for a new STA using SPs. Channel access may be provided to a new STA via a coverage extension relay DMG STA.

FIG. 27 is a diagram of an example signaling procedure for channel access for coverage extension 2700. This example procedure may involve an AP/PCP that functions as an S-REDS 2705, an eRDS 2710 that functions as a relay, and a STA that functions as a D-REDS 2715. For uplink data transmission 2713, the procedure may begin with the D-REDS 2715 transmitting a DMG ADDTS Request message 2720 to the eRDS 2710. The eRDS 2710 may then transmit a Relay ADDTS Request message 2725 to the AP/PCP 2705. This transmission may include the information received from the D-REDS 2715 in the DMG ADDTS Request message 2720 and some additional information. The Relay ADDTS Request message 2725 may be similar to the DMG ADDTS Request message found in IEEE 802.11ad-2012, with some additions as listed in Table 2 below. Table 2 contains examples of additional elements in a Relay ADDTS Request message 2725 relative to a DMG ADDTS Request. A Relay TSPEC element may contain the traffic specification requirements for the eRDS.

TABLE 2

| Order | Information |
|---|---|
| 5 | D-REDS address |
| 6 | Relay TSPEC |

Upon receiving the Relay ADDTS Request message 2725 from the eRDS 2710, the AP/PCP 2705 may respond with a Relay ADDTS Response message 2730 containing the status of the ADDTS request. This message may be similar to the DMG ADDTS Response message found in IEEE 802.11ad-2012, with an additional element as listed in Table 3 below. Table 3 contains examples of an additional element in a Relay ADDTS Response message 2730 relative to a DMG ADDTS Response.

TABLE 3

| Order | Information |
|---|---|
| 7 | D-REDS address |

Finally, the success of the ADDTS operation may be communicated to the D-REDS 2715 by the eRDS 2710 using a DMG ADDTS Response message 2735. Further, the actual channel allocation may be communicated by the AP/PCP 2705 to the eRDS 2710 and D-REDS 2715 using the Extended Schedule element contained in DMG Beacon or Announce frames 2740. A similar procedure for downlink data transmission 2745 may be performed as shown in FIG. 26.

FIG. 28 is a diagram of an example of channel access with an eRDS using dynamic allocation 2800. In this example, dynamic allocation may be used for channel access for the new STA, i.e., the D-REDS. FIG. 28 shows an S-REDS to eRDS transmission 2810 and an eRDS to D-REDS transmission 2820 during multiple SPs 2830.

When the dynamic allocation transmission mechanism is used with eRDS, it may be necessary for the eRDS to forward the Poll, Service Period Request (SPR) and Grant frames since the D-REDs is out-of-range of the AP/PCP. For example, during a polling period 2840, the S-REDS may transmit a Poll 2845. The eRDS may forward the Poll 2845A to the D-REDS. The D-REDS may respond with an SPR 2850A to the eRDS. The eRDS may respond to the S-REDS in an SPR frame 2850 that contains information from the D-REDS. During the grant period 2860, the S-REDS may transmit a Grant frame 2865 to the eRDS, and the eRDS may forward the Grant frame 2865A to the D-REDS. In IEEE 802.11ad-2012 DMG relay operation, these frames may be assumed to be received by D-REDs via a direct link that is in-range of the AP/PCP, which may no longer be the case with eRDS. FIG. 28 illustrates the forwarding of Polls, SPRs and Grants to achieve coverage extension using dynamic allocation. The SPR and Grants on the link between the S-REDS and eRDS may encapsulate SPR and Grant information for the link between the eRDS and D-REDS.

FIG. 29 is a diagram of an example of an eRDS poll frame format 2900. The example eRDS poll frame format 2900 may include an eRDS Address field 2910. The RA and TA fields in the Poll, SPR, and Grant frames may refer to the S-REDS and the D-REDS. The eRDS Address field 2910 may be added to complete the address set for the three nodes, i.e., the S-REDS, eRDS, and D-REDS. If there are two or more eRDSs associated with an S-REDS/D-REDS pair, then the eRDS Address field 2910 may identify which eRDS is transmitting the Poll and Grant frames to the D-REDS and the SPR frame to the S-REDS.

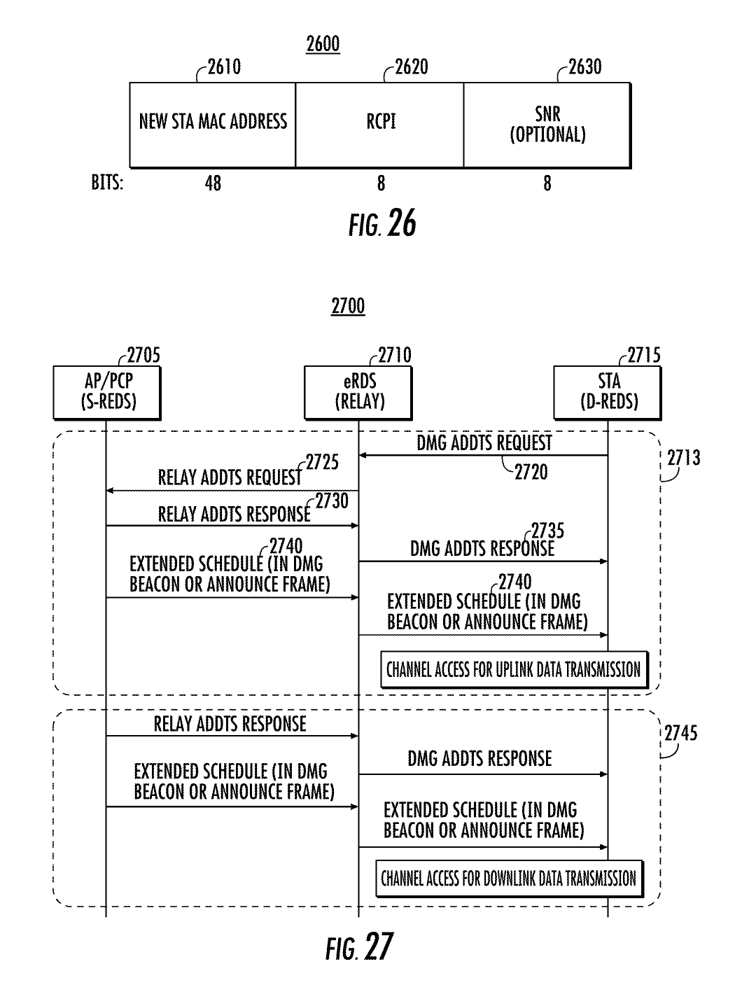

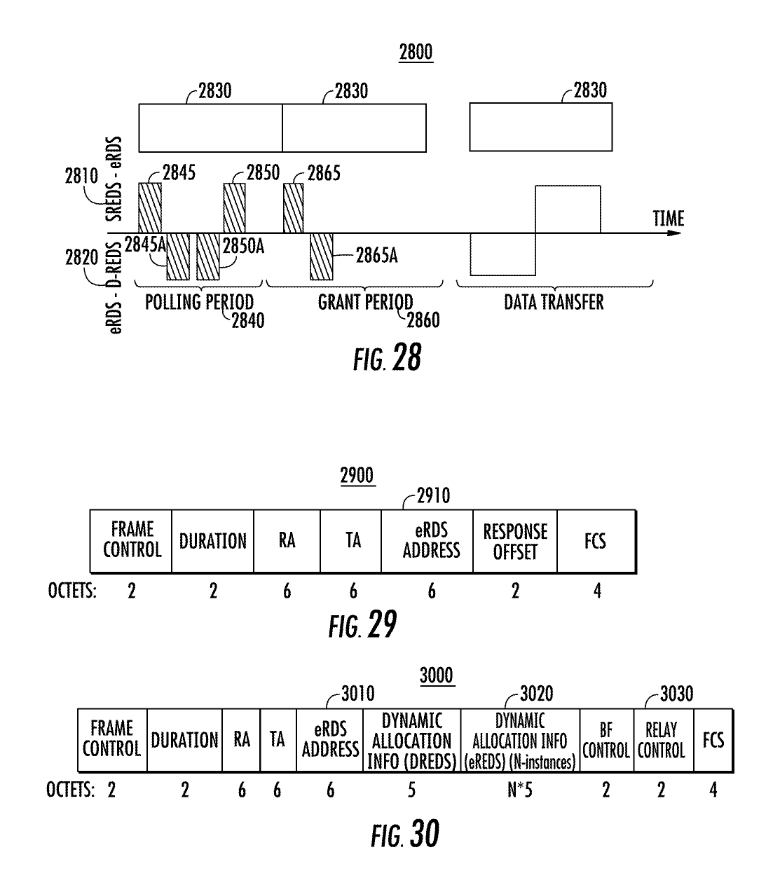

FIG. 30 is a diagram of an example of an eRDS SPR frame format 3000. The eRDS SPR frame format 3000 may include an eRDS Address field 3010, one or more Dynamic Allocation Information field 3020, and a Relay Control element 3030. The first Dynamic Allocation field 3020 may contain the requested allocation information from the D-REDS. The following N Dynamic Allocation Fields, where N is number of traffic streams, may contain allocation requests originating at the eRDS or from other D-REDS. For an eRDS SPR frame transmitted from the D-REDs to the eRDS, N may be zero and the field may or may not be present.

FIG. 31 is a diagram of an example of a Relay Control element format 3100. The relay control element format 3100 may include a Relay Enable field 3110. A zero in the Relay Enable field 3110 may indicate a direct link between the S-REDS and D-REDS. The values 1, 2 or 3 may correspond to a specific relay being requested for the particular transmission, if multiple relays are permitted.

FIG. 32 is a diagram of an example of an eRDS Grant frame format 3200. The eRDS grant frame format 3200 may include an eRDS Address field 3210, a Dynamic Allocation Information field 3220, and a Relay Control field 3230. The eRDS Grant frame format 3200 may be the same as the eRDS SPR frame format 3000. The eRDS Grant frame format 3200 may indicate the resources allocations for the S-REDS to eRDS link and for the eRDS to D-REDS link(s). As in the case of the SPR, N may be equal to zero on the link between an eRDS and D-REDS.

Modifications to the frame formats and usage of the Duration field may be needed in order to enable operation of eRDS with dynamic allocation. The modifications to the Poll, SPR and Grant frames may include an eRDS address field to identify the intended eRDS that is to be allocated, as illustrated in FIG. 29, FIG. 30 and FIG. 32, respectively. In addition, the Dynamic Allocation fields may be modifications and a Relay control field may be added.

In non-eRDS situations, the Duration field may be set to include the duration, in microseconds of the remaining Poll frame transmissions, plus all appropriate interframe spacings (IFSs), plus the duration for the SPR frame transmission. With the new eRDS scenario, it may be necessary to increase the Duration Field settings to include the time required for forwarding of the Poll, SPR, and Grant by the eRDS. For instance, when the AP/PCP transmitting to an eRDS transmits a Poll, the Duration Field may be increased by the time required for forwarding the Poll and its associated SIFS period to the D-REDS, as well as the time required for returning the SPR from the D-REDS to the eRDS, and its associated SIFS period. Additionally, when the eRDS forwards Poll, S P R and Grant, the duration period field of the forwarded frame may be decremented by the duration of the first transmission from either the PCP/AP or D-REDS.

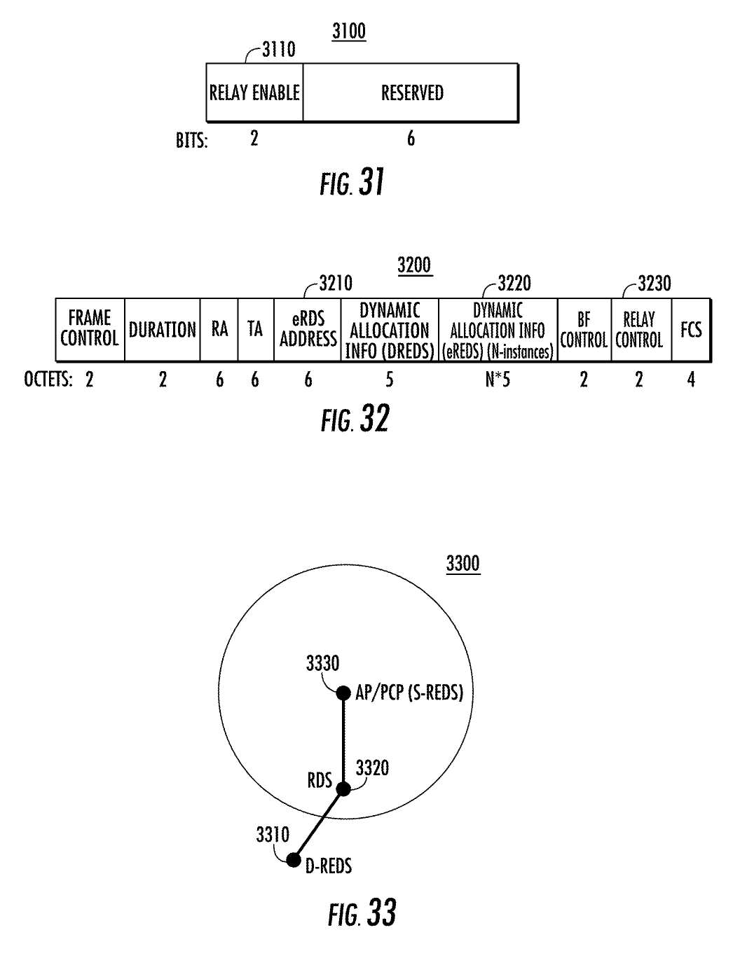

FIG. 33 is a diagram of an example of range extension, including D-REDS broadcast beacons 3300. In this example, coverage extension may be provided, including a D-REDS 3310 broadcasting a beacon and discovering an RDS 3320. In this example, the S-REDS 3330 may only be able to discover the RDS 3320 through, for example, the RDS discovery procedure in IEEE 802.11ad-2012 but not able to discover the D-REDS 3310. To enable D-REDS 3310 to discover the RDS's, the D-REDS 3310 may broadcast beacons and the RDS(s) 3320 may need to scan for beacons during the scheduled SP per beacon interval.

The RDS(s) 3320 in the range of the S-REDS 3330 may be associated through a beamforming training, association, and authentication procedures. The S-REDS 3330 may obtain a list of RDSs per the RDS discovery procedure in IEEE 802.11ad-2012, for example. When a new node, for example the D-REDS 3310 powers up, it may first scan directionally with each of its beams for the presence of a DMG beacon from the AP/PCP. The D-REDS 3310 may finish the scanning for all its receiving beams and no beacons may be received. The D-REDS 3310 may then be out of the range of the AP/PCP, and it may start to broadcast beacons in order to discover the RDSs. The DMG beacon frames may be transmitted in multiple time slots, each using a different antenna beam, so that the D-REDS may be able to discover the presence of an RDS in the PBSS.

Each RDS in the PBSS may scan directionally to search for the presence of a beacon from a particular direction during a scheduled SP in one beacon interval. In the next beacon interval, the receiver beam of the RDS 3320 may switch to a different direction to continue scanning for beacons during the scheduled SP duration. The procedures may repeat for each of its receiver antenna beams. Since the D-REDS 3310 is not yet connected to the PBSS, it may not have achieved frame synchronization, and its beaconing period may not be aligned with the RDS scanning duration. Therefore, the AP/PCP may schedule the scanning SP for the RDS 3320 in a random fashion using the extended schedule per beacon interval. Then the start time of the scanning SP duration may be different for each beacon interval, but the start time may be the same for all the RDSs in the PBSS, in order to guarantee that the RDS 3320 may be able to hear a beacon if it is within the range of the D-REDS 3310.

Once the RDS 3320 receives a beacon from the D-REDS 3310, it may respond to the D-REDS 3310 with a SSW frame. The D-REDS 3310 may choose the best RDS and respond with a SSW feedback frame. Once the RDS 3320 receives the SSW feedback frame from the D-REDS 3310, it may forward this to the AP/PCP. This may end the first phase of BF-Training procedure, also called SLS. Once this is completed, the D-REDS 3310 may stop the procedures of broadcasting beacons. Optionally the D-REDS 3310 and RDS 3320 may perform a second BF-Training procedure also referred to as Beam Refinement Protocol (BRP). The BF-Training procedures may also be scheduled by the AP/PCP. After completing BF-Training with RDS 3320, the results may be forwarded to the AP/PCP, shown here as S-REDS 3330. The S-REDS 3330 may transmit the association request to the RDS 3320, so the association between the RDS 3320 and the D-REDS 3310 may be performed and the D-REDS 3310 may successfully discover and associate with the RDS 3320.

Methods and systems are disclosed herein to build on range and coverage extensions to enable multiple active relays per source-destination pair, including: multiple relay setup, channel access procedures, relay handover procedures and procedures for multi-user-MIMO (MU-MIMO) operations. Methods and procedures disclosed herein may enable communications between the S-REDS and D-REDS via multi-relay DMG STAs.

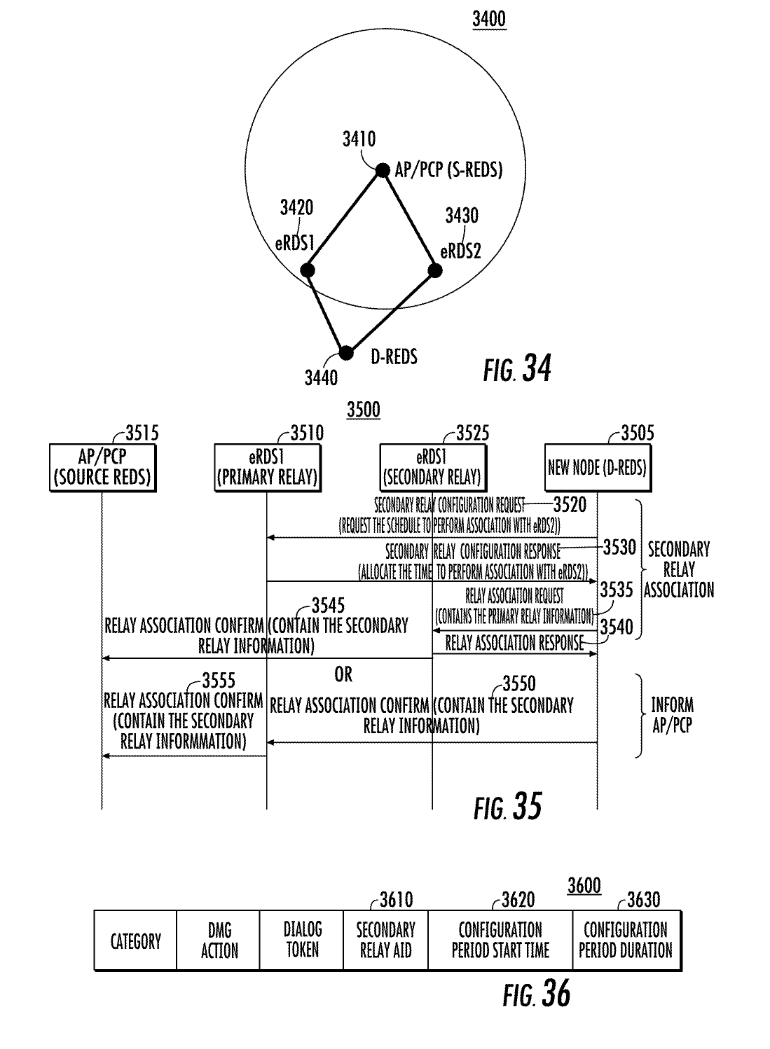

FIG. 34 is a diagram of an example of a multi-relay topology 3400. In this example scenario, a multi-relay may include an AP/PCP (S-REDS) 3410, a first eRDS 3420, a second eRDS 3430, and a new STA node which that may be a potential D-REDS 3440. However, the procedure may apply to more than two eRDSs also. The D-REDS 3440 may be outside the direct communication range of the AP/PCP (S-REDS) 3410. Procedures for the D-REDS 3440 to communicate with the AP/PCP (S-REDS) 3410 using an eRDS are described elsewhere herein. Procedures for communication between the S-REDS 3410 and D-REDS 3440 via multiple eRDSs are presented herein, including the following.

Methods and systems are disclosed herein which include procedures to achieve new STA node (potential D-REDS) association with multiple eRDSs. Described elsewhere herein are procedures for eRDS1 and eRDS2 association with the AP/PCP (S-REDS), including coverage extension. The D-REDS may be out of the coverage range of the AP/PCP. Therefore, it may only hear the beacons from the eRDSs within its communication range, namely eRDS1 and eRDS2 in an example.

DMG beacon transmission by eRDSs, possibly with modified fields to indicate their availability to act as relays is disclosed elsewhere herein. There may be possible alternatives for the new STA (D-REDS) response. Firstly, the new STA node may wait until finishing scanning in all the directions and respond to one eRDS based on some criterion such as maximum received beacon power. This eRDS may henceforth be referred to as the primary relay or primary RDS. The new STA node may then respond to another eRDS with beacon response in a subsequent beacon interval. In another example, the new STA node may listen to the beacons and respond to the first AP/PCP from which it received the beacon, which then becomes the primary relay. The new node may then continue scanning the remaining directions and respond to any other received beacons. In both of the above examples, the new STA node may perform BF-Training procedure with each of the discovered eRDSs to identify fine beams to use when communicating with them.

FIG. 35 is a diagram of an example signaling procedure for D-REDS association with multi-relay 3500. In this example, the new STA node, referred to here as D-REDS 3505, may perform an association procedure with a primary eRDS, such as eRDS1 3510. The D-REDS 3505 may transmit an Association Request message (not shown) to the primary RDS and then the primary RDS may respond with an Association Response message (not shown) back to the new node. The association information may also be forwarded (not shown) from eRDS1 to the AP/PCP 3515 to inform about this association via a Relay Association Indication message.

In another example, the D-REDS 3505 may transmit a Secondary Relay Configuration Request message 3520 to its primary relay, eRDS1 3510 to request the schedule for performing the BF-Training (if not performed earlier) and association with the secondary relay, eRDS2 3525. The eRDS1 3510 may respond with a Secondary Relay Configuration Response message 3530 to allocate channel time for association between the D-REDS 3505 and eRDS2 3525. After that, the D-REDS 3505 may transmit a Multi-Relay Association Request message 3535 to eRDS2 3525, and eRDS2 3525 may respond with a Multi-Relay Association Response message 3540 back to the D-REDS 3505. The Multi-Relay Association Request message 3535 may contain the MAC address or Association ID (AID) of the primary relay eRDS1 3510.

In a further example, once the association with the secondary relay is completed, the information may be forwarded to the AP/PCP 3515. There may be two ways to achieve this. In a first example, the AP/PCP 3515 may be notified from eRDS2 3525 directly. The eRDS2 3525 may transmit a Relay Association Confirm message 3545 to the AP/PCP 3515 to inform the completion of the association with the new node. In a second example, the AP/PCP 3515 may be notified by the primary relay. In this example, the new node may first transmit a Relay Association Confirm message 3550 to eRDS1 3510 to inform the completion of the association with eRDS2 3525. The eRDS1 3510 may forward this information to the AP/PCP 3515 via the Relay Association Confirm message 3555.

FIG. 36 is a diagram of an example Secondary Relay Configuration Request message format 3600. The Secondary Relay Configuration Request message format 3600 may include a Secondary Relay AID field 3610, a Configuration Period Start Time field 3620, and a Configuration Period Duration field 3630. The Configuration Period Start Time field 3620 may indicate the start time of the channel time requested by the D-REDS to perform association with a secondary relay identified by the Secondary Relay AID field 3610. The Configuration Period Duration field 3630 may indicate the duration of the channel time requested by the D-REDS to perform association with a secondary relay identified by the Secondary Relay AID field 3610. The D-REDS may obtain these parameters from beacons received from the secondary relay.

FIG. 37 is a diagram of an example Secondary Relay Configuration Response message format 3700. The Secondary Relay Configuration Response message format 3700 may include a Secondary Relay AID field 3710, a Result Code field 3720, an optional Configuration Period Start Time field 3730, and an optional Configuration Period Duration field 3740. The Result Code field 3720 in Secondary Relay Configuration Response message 3700 may indicate the values SUCCESS, REJECTED or REJECTED WITH ALTERNATE PARAMETERS. The Configuration Period Start Time field 3730 and the Configuration Period Duration field 3740 contain the alternate values supplied by the eRDS when the Result Code field 3720 contains REJECTED WITH ALTERNATE PARAMETERS.

FIG. 38 is a diagram of an example of a relay capability field format 3800. The relay capability field format 3800 may include a Concurrent Relay Capable field 3810, a Bi-Directional Relay Capable field 3820, and a Multi-Relay Poll Supported field 3830. These parameters may refer to the primary relay (eRDS1) capabilities, and may be transmitted by the D-REDS to the secondary relay (eRDS2). The Concurrent Relay Capable field 3810 may be set to indicate that the primary eRDS supports multiple relay mode. The Bi-Directional Relay Capable field 3820 may be set when the primary eRDS is capable of supporting bi-directional traffic between the S-REDS and the D-REDS. The Multi-Relay Poll Supported field 3830 may be set when the primary relay supports multi-relay poll functionality.

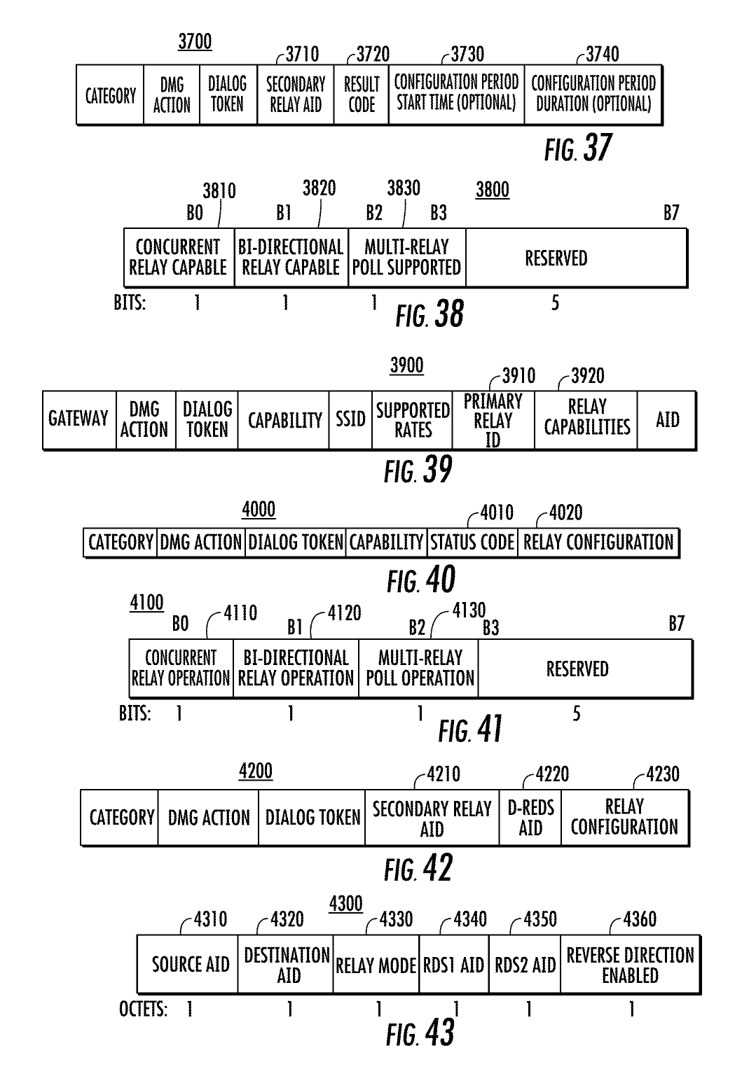

FIG. 39 is a diagram of an example Relay Association Request message format 3900. The Relay Association Request message format 3900 may include a Primary Relay ID field 3910 and a Relay Capability field 3920. The Relay Capability field 3920 includes the fields shown in the relay capability field format 3800 in FIG. 38.

FIG. 40 is a diagram of an example Relay Association Response message format 4000. The Relay Association Response message format 4000 may include a Status Code field 4010 and a Relay Configuration field 4020. The Category field may be set to the category for DMG. The DMG Action field value may correspond to the code for Relay Association Response message. The Dialog Token value may be copied from the corresponding Relay Association Request message. The Capability field may indicate the capabilities of the node sending the message. The Status Code 4010 may indicate the result of the previous operation. If successful, the Status Code 4010 may be set to 0. Several non-zero values may be used to signal specific error conditions.

FIG. 41 is a diagram of an example of a Relay Configuration field format 4100. The Relay Configuration field format 4100 may include a Concurrent Relay Operation field 4110, a Bi-Directional Relay Operation field 4120, and a Multi-Relay Poll Operation field 4130. The Concurrent Relay Operation field 4110 may be set when the secondary relay enables concurrent relay operation. The Bi-Directional Relay Operation field 4120 may be set when the secondary relay enables bi-directional traffic relaying between the S-REDS and the D-REDS. The Multi-Relay Poll Operation field 4130 may be set when the secondary eRDS enables a multi-relay polling procedure.

FIG. 42 is a diagram of an example Relay Association Confirm message format 4200. The Relay Association Confirm message format 4200 may include a Secondary Relay AID field 4210, a D-REDS AID field 4220, and a Relay Configuration field 4230. The Secondary Relay AID 4210 may identify the secondary relay chosen by the D-REDS. The D-REDS AID 4220 may identify the D-REDS to the S-REDS when this is relayed either by the primary relay or the secondary relay.

When multiple relays are enabled for a pair of S-REDS and D-REDS, concurrent transmissions may increase transmission efficiency. For example, if two relays RDS1 and RDS2 are identified for communications between an S-REDS and a D-REDS, following the association procedure described elsewhere herein, simultaneous transmissions between S-REDS and RDS1, and between RDS2 and D-REDS may be scheduled simultaneously, provided these transmissions do not cause mutual interference. Likewise, the links between RDS1 and D-REDS, and between S-REDS and RDS2 may be scheduled simultaneously, provided mutual interference is not a concern. Note that the present procedure may also apply to enhanced relays (eRDSs).

FIG. 43 is a diagram of an example of a concurrent relay request field format 4300. To enable concurrent relay transmissions, a modified Service Period type may be introduced, referred to as a Concurrent Relay Service Period (CRSP). To initiate CRSP formation either the S-REDs or D-REDS may transmit an ADDTS Request frame to the AP/PCP with a new Concurrent Relay Request field. The concurrent relay request field format 4300 may include a Source AID field 4310, a Destination AID field 4320, a Relay Mode field 4330, an RDS1 AID field 4340, an RDS2 AID field 4350, and a Reverse Direction Enabled field 4360.

The Source AID field 4310 and the Destination AID field 4320 may identify the source and destination nodes for the data transmission being requested, respectively. If a concurrent transmission between the S-REDS and D-REDS is requested, then Source AID field 4310 and Destination AID field 4320 may contain the AIDs for the S-REDS and D-REDS, respectively. For concurrent session setup in the opposite direction, the values may be switched. The Relay Mode field 4330 may contain the value for concurrent transmissions. RDS1 AID field 4340 and RDS2 AID field 4350 may identify the two RDSs or eRDSs that may be used in the requested concurrent transmission session. The Reverse Direction Enabled field 4360 may be set to 0, if a unidirectional traffic session is being requested, otherwise it may be set to 1.

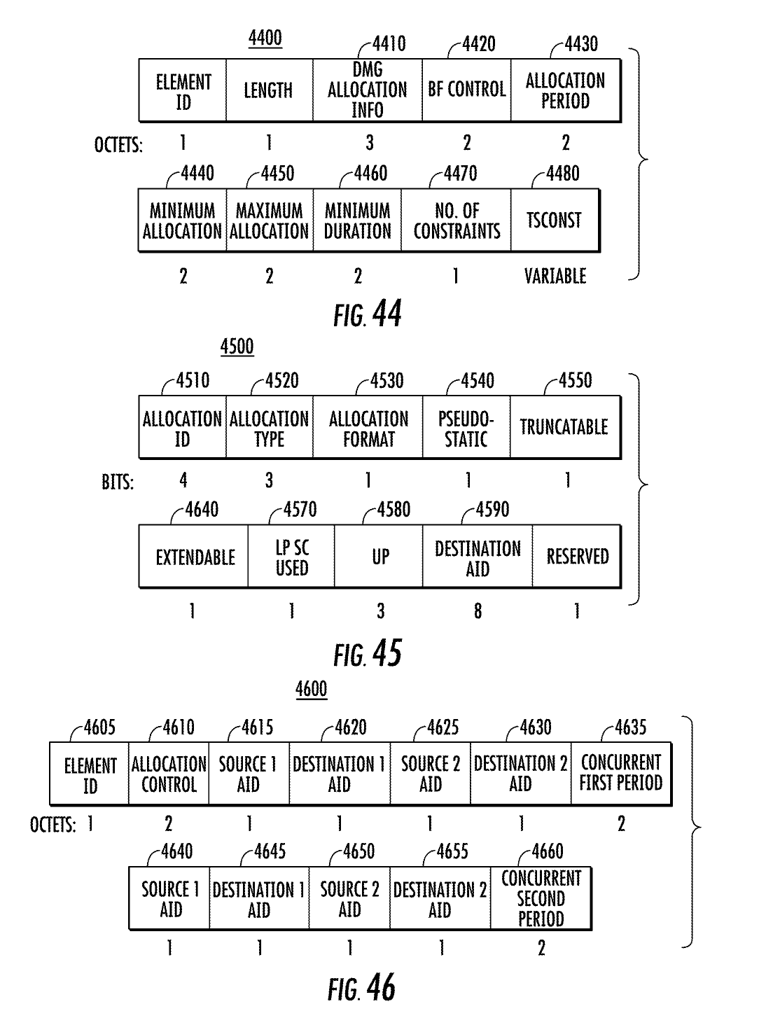

FIG. 44 is a diagram of an example of a DMG TSPEC element format 4400. The DMG TSPEC element format 4400 may include a DMG Allocation Information field 4410, a BF Control field 4420, an Allocation Period field 4430, a Minimum Allocation field 4440, a Maximum Allocation field 4450, a Minimum Duration field 4460, a Number of Constraints field 4470, and a variable TSCONST field 4480.

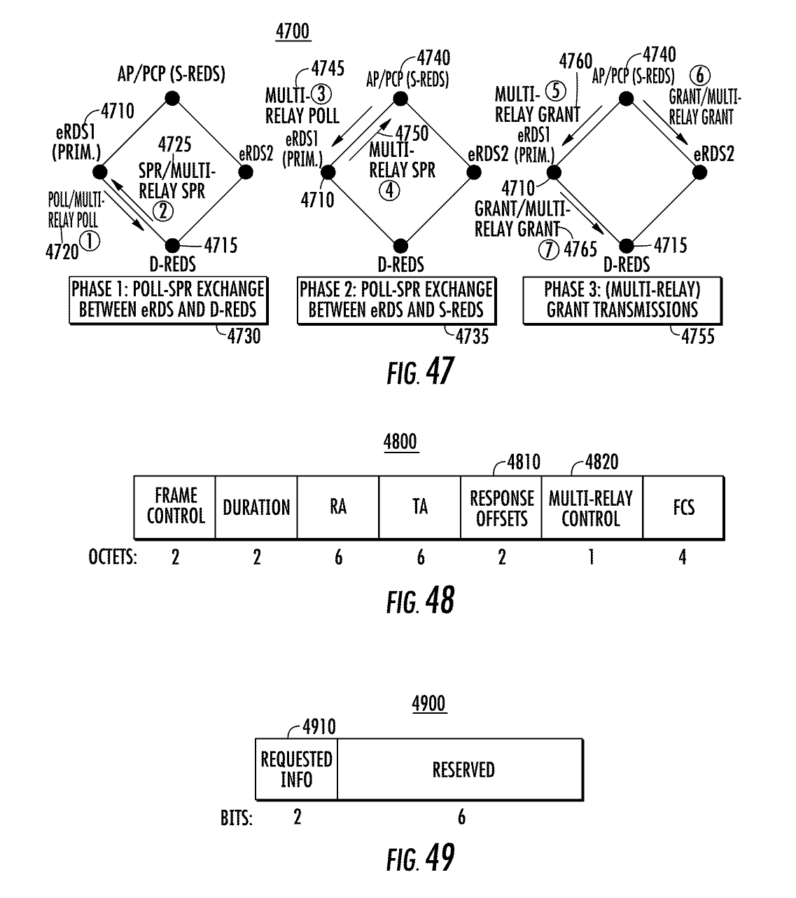

The Element ID field may be equal to the value for the DMG TSPEC. The Length field for this element indicates the length of the Information field. The DMG Allocation field 4410 is shown in FIG. 45. The BF Control field 4420 may specify the Beamforming Training parameters. The Allocation Period field 443 may indicate the period over which the allocation repeats, in terms of either a multiple or fraction of the Beacon Interval (BI). When this field is set to 0, it may indicate that the allocation is not periodic. The minimum Allocation field 4440 may be set to the Minimum acceptable allocation in microseconds in each allocation period. The Maximum Allocation field 4450 may be set to the desired allocation in microseconds in each allocation period. The Minimum Duration field 4460 may specify, the minimum acceptable duration in microseconds. Possible values range from 1 to 32,767 for an SP allocation and 1 to 65,535 for a CBAP allocation. A value of 0 may indicate that no minimum is specified. The Number of Constraints field 4470 may indicate the number of TSCONST fields 4480 contained in the element. The value of this field ranges from 0 to 15. Other values may be reserved. The Traffic Scheduling Constraint (TSCONST) field 4480 may contain interference constraints, such as start of interference, its duration, periodicity and MAC address of interference source.

FIG. 45 is a diagram of an example of a DMG Allocation Information field format 4500. The DMG Allocation Information field format 4500 may include an Allocation ID field 4510, an Allocation Type field 4520, an Allocation Format field 4530, a Pseudostatic field 4540, a Truncatable field 4550, an Extendable field 4560, a Low Power (LP) Single Carrier (SC) Used field 4570, a User Priority (UP) field 4580, and a Destination AID field 4590. The LP SC Used field 4570 may be set to 1 to indicate that the low power single carrier PHY is used in this SP. Otherwise, the LP SC Used field 4570 may be set to 0. The UP field 4580 may indicate the lowest priority UP to be used for possible transport of MSDUs belonging to TCs with the same source and destination of the allocation.

Table 4 below is an example of Allocation Type field values, including modified values shown in bold. In one example, the DMG TSPEC element may be modified to include the new SP type as shown in FIG. 44, FIG. 45 and Table 4.

TABLE 4

| Bit 4 | Bit 5 | Bit 6 | Meaning |
|---|---|---|---|
| 0 | 0 | 0 | SP allocation |
| 1 | 0 | 0 | CBAP allocation |
| 0 | 1 | 0 | CRSP allocation |

| | |
|---|---|
| All other combination | Reserved |

FIG. 46 is a diagram of an example of a Concurrent Relay Response field format 4600. In an example response, the AP/PCP may transmit an ADDTS Response frame containing the Concurrent Relay Response field 4600. This field may include the status of CRSP formation and, if successful, also the configuration of the CRSP. The Concurrent Relay Response Field format 4600 may include an Element ID field 4605, an Allocation Control field 4610, a Source 1 AID field 4615, a Destination 1 AID field 4620, a Source 2 AID field 4625, a Destination 2 AID field 4630, a Concurrent First Period field 4635, a Source 1 AID field 4640, a Destination 1 AID field 4645, a Source 2 AID field 4650, a Destination 2 AID field 4655, and a Concurrent Second Period field 4660. The Source 1 AID field 4615, Destination 1 AID field 4620, Source 2 AID field 4625, and Destination 2 AID field 4630 are associated with Concurrent First Period transmissions. The Source 1 AID field 4640, Destination 1 AID field 4645, Source 2 AID field 4650, and Destination 2 AID field 4655 are associated with Concurrent Second Period transmissions.

When multiple eRDSs are configured for communications between S-REDS and D-REDS, dynamic scheduling using the eRDSs is not supported by the IEEE 802.11ad-2012 specifications. Methods and systems for a modified polling mechanism is disclosed herein for the D-REDS resource request to be conveyed to the AP/PCP, and the Grants from the AP/PCP to be transmitted to the D-REDS.

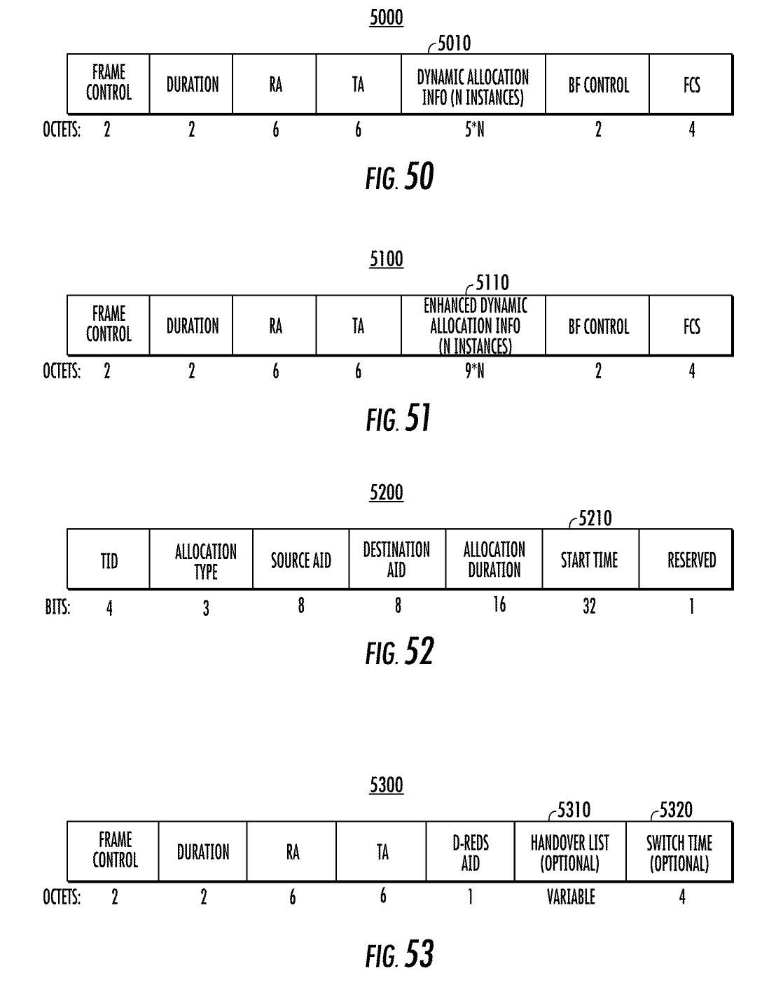

FIG. 47 is a diagram of an example of a dynamic scheduling procedure for multiple relays 4700. As one of ordinary skill in the art will appreciate, while only one Primary and a Secondary eRDS are shown in FIG. 47, this procedure may be extended to multiple Secondary eRDSs, supported by one Primary eRDS.

This procedure may utilize the Primary Relay/eRDS, described elsewhere herein, for polling the D-REDS. In this example, the Primary eRDS 4710 may have three functions related to dynamic channel allocation. The Primary eRDS 4710 may poll the D-REDS 4715 by transmitting Poll/Multi-Relay Poll messages 4720 and receiving SPR/Multi-Relay SPR messages 4725 in response in a first phase 4730. In a second phase 4735 the Primary eRDS 4710 may relay the D-REDS dynamic resource requests to the AP/PCP 4740, by responding to Multi-Relay Poll messages 4745 with Multi-Relay SPR messages 4750. In a third phase 4755, the Primary eRDS 4710 may receive Multi-Relay Grant frames 4760 from the AP/PCP 4740, and relay them to D-REDS 4715 by transmitting Grant or Multi-Relay Grant frames 4765.

Additionally, during dynamic channel allocation period the D-REDS may remain in receive mode and orient its antenna beam towards the Primary eRDS, whenever it is not transmitting or receiving during dynamically allocated channel time contained in a received Grant/Multi-Relay Grant frame. In one example, the Primary eRDS, such as eRDS1 in FIG. 47, may transmit a Multi-Relay Poll message to the D-REDS.

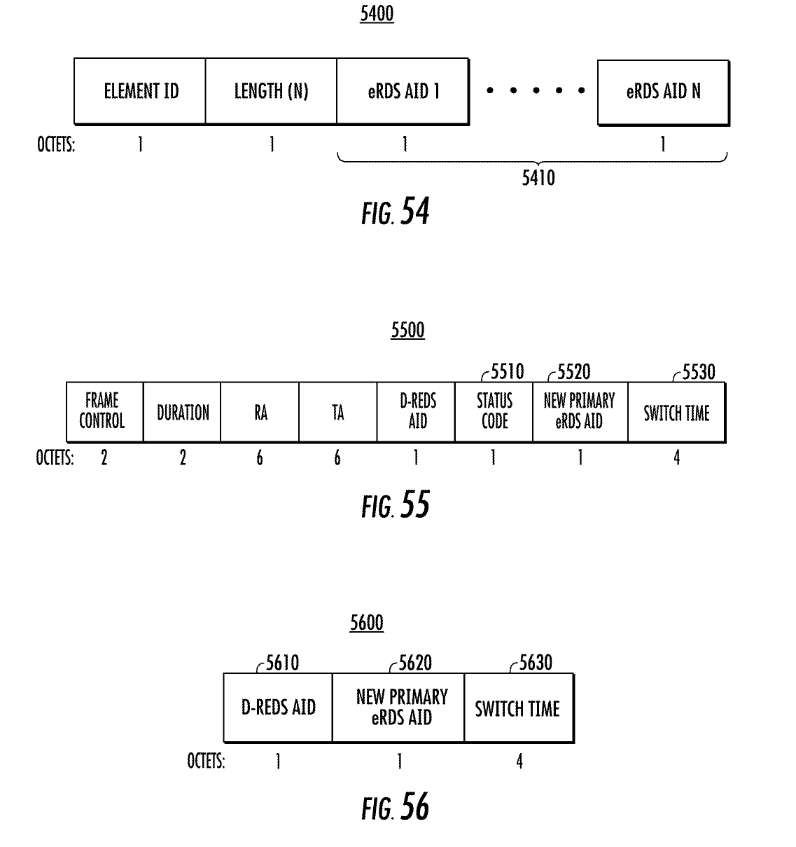

FIG. 48 is a diagram of an example of a Multi-Relay Poll frame format 4800. The contents of the Multi-Relay SPR message, which may be used in the example in FIG. 47, are shown in FIG. 48. The Multi-Relay Poll frame format 4800 may include a Response Offsets field 4810 and a Multi-Relay control field 4820. The Multi-Relay Control field 4820 may be modified in this message relative to an IEEE 802.11ad Poll frame. For example, the Multi-Relay Control field 4820 may indicate the amount of feedback information requested by the AP/PCP.

FIG. 49 is a diagram of an example of contents of a Multi-Relay Control field format 4900. The Multi-Relay Control field format 4900 may include a Requested Information element 4910. Table 5 below shows an example format of the Requested Information element contained in the Multi-Relay Control field. This may indicate the type of SPRs requested by the AP/PCP.

TABLE 5

| Bit 0 | Bit 1 | Meaning |
|---|---|---|
| 0 | 0 | All SPRs |
| 0 | 1 | SPR from eRDS only |
| 1 | 0 | SPRs from D-REDS only |
| 1 | 1 | SPRs for local (direct-link) traffic only |

In one example, if the D-REDS does not support Multi-Relay Poll (which may be signaled by D-REDS setting the Multi-Relay Poll support field=0 in Relay Capability field in Relay Association Request frame, as described elsewhere herein), the primary eRDS may use a regular Poll frame and the D-REDS may respond with a regular IEEE 802.11ad-2012 compliant SPR frame. If, however, the D-REDS supports Multi-Relay Poll frame processing, it may respond with a Multi-Relay SPR frame in response to a Multi-Relay Poll frame from the Primary eRDS.

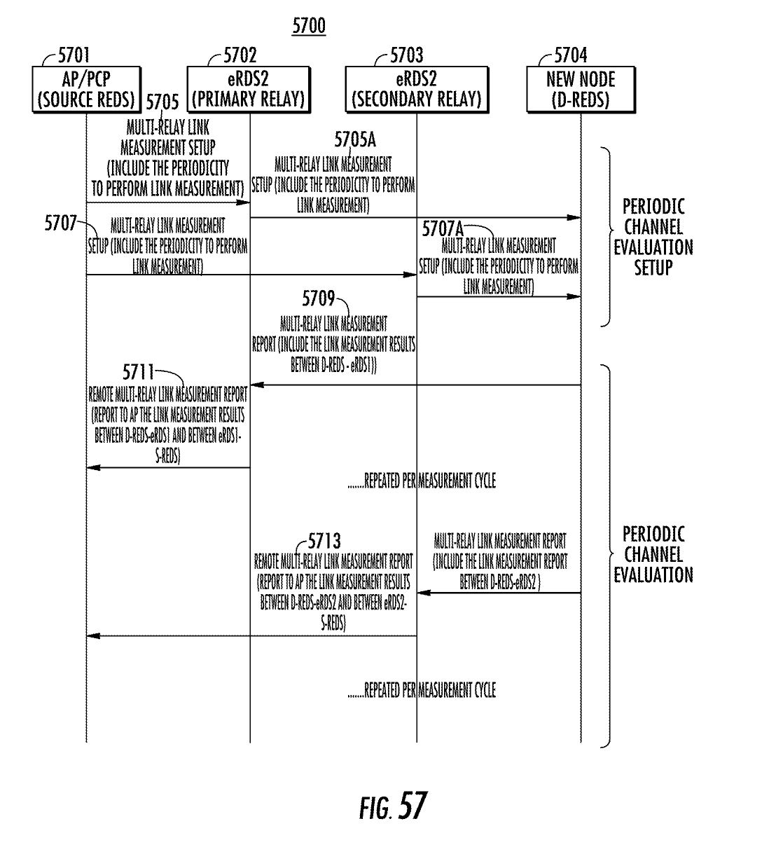

FIG. 50 is a diagram of an example of a Multi-Relay SPR frame format 5000. This example differs from the regular IEEE 802.11ad SPR message in that it may contain more than one instance of a Dynamic Allocation Information field 5010, each for a different data packet destination.

FIG. 51 is a diagram of an example of a Multi-Relay Grant message frame format 5100. In this example, in response to Multi-Relay SPRs received from eRDSs, the AP/PCP may transmit Multi-Relay Grant frames to the eRDSs. The Multi-Relay Grant message frame format 5100 may include one or more Enhanced Dynamic Allocation Information field 5110, each for a different data packet destination. The Enhanced Dynamic Allocation Information field 5110 may also include the Start Time of the allocation, corresponding to the lower 4 bytes of the local TSF counter.

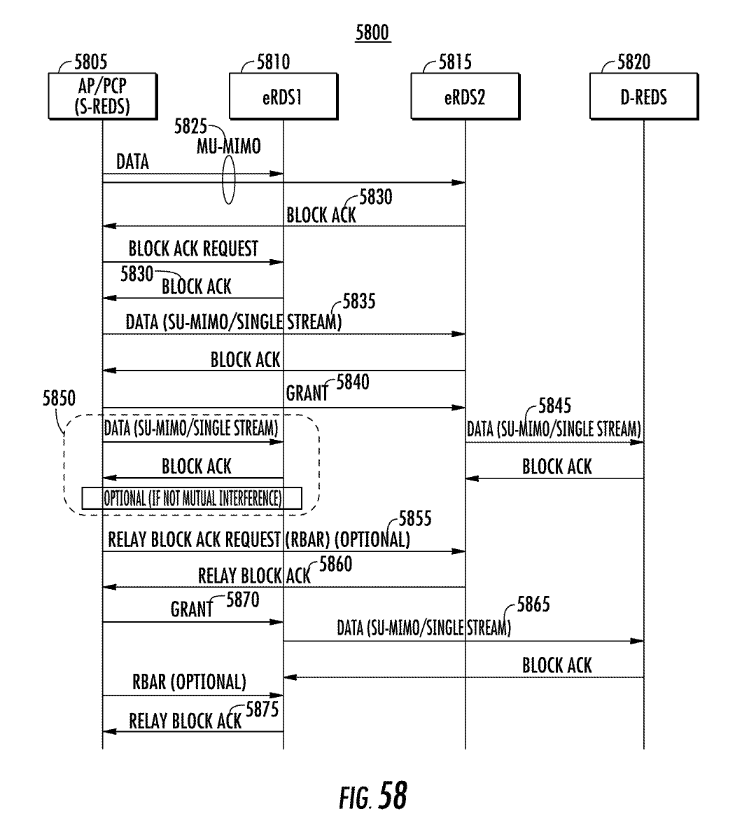

FIG. 52 is a diagram of an example of an Enhanced Dynamic Allocation Information field 5200. The Multi-Relay Grant message 5100 may contain the Enhanced Dynamic Allocation Info field. This field may contain the Start Time 5210 of the dynamic allocation in addition to the regular fields in Dynamic Allocation Info field. The Start Time 5210 may be the lower four octets of the TSF Counter of the transmitting node.

The Primary eRDS may convey the channel allocation information to the D-REDS by transmitting a regular Grant frame or a Multi-Relay Grant frame, if D-REDS supports Multi-Relay Poll processing. If a regular Grant frame is used, D-REDS may prepare to receive from the node indicated by the Source AID (if different from own AID), or transmit to node indicated by Destination AID (if different from own AID) immediately after the end of a Grant frame reception. All Secondary eRDSs associated with an S-REDS, D-REDS pair may be ready to receive a Grant or Multi-Relay Grant frame from the AP/PCP following a Poll-SPR or Multi-Relay Poll-Multi-Relay SPR frame exchange, even if it did not request any resource allocation.

In one example, a primary eRDS handover procedure may be initiated by the D-REDS, current Primary eRDS or the AP/PCP. The current Primary eRDS or D-REDS may initiate handover by transmitting a Primary eRDS Handover Request message to the AP/PCP. The AP/PCP may respond with a Primary eRDS Handover Response message with the new Primary eRDS AID and the Switch Time. The AP/PCP may also initiate the Primary eRDS handover procedure by transmitting an unsolicited Primary eRDS Handover Response message.

FIG. 53 is a diagram of an example of contents of a Primary eRDS Handover Request frame format 5300. The Primary eRDS Handover Request frame format 5300 may include an optional Handover List element 5310 and an optional Switch Time element 5320. The Frame Control field may contain control frame parameters. The Duration field may contain the duration value in microseconds for the current message. The RA and TA fields may contain the MAC addresses of the receiving and transmitting nodes of the particular message. The D-REDS AID field may contain the AID of the D-REDS requesting handover. The optional Handover List field 5310 may contain a prioritized list of eRDS AIDs that may act as secondary relays for the D-REDS sending the request. The optional Switch Time field 5320 may contain the lower 4 octets of the Timing Synchronization Function (TSF) counter, when the D-REDS is requesting a switch to the secondary relay.

FIG. 54 is a diagram of an example of a Handover List element format 5400. The Handover List element 5400 may be found in the Primary eRDS Handover Request frame 5300. The Handover List element 5400 may contain an ordered list of eRDSs 5410 prepared by the D-REDS, and may be present in some examples and not present in other examples.

FIG. 55 is a diagram of an example of contents of a Primary eRDS Handover Response frame format 5500. The Primary eRDS Handover Response frame format may include a Status Code element 5510 and a New Primary eRDS AID element 5520. The D-REDS may also provide a preferred Switch Time element 5530 as the final element. The Primary eRDS Handover Response frame 5500 may contain the result of the Primary eRDS handover request in the Status Code element 5510. The result of the Primary eRDS handover request may also be included in the new Primary eRDS AID element 5520. The Switch Time element 5530 may include the actual Switch Time.

Additionally, the AP/PCP may announce the identity of the new Primary eRDS for a D-REDS in the DMG Beacons transmitted at the start of each Beacon Interval. The DMG Beacon frames may include the Multi-Relay field containing a new Primary eRDS AID and the Switch Time.

FIG. 56 is a diagram of an example of contents of a Multi-Relay field format 5600. The Multi-Relay field format 5600 may include a D-REDS AID element 5610, a New Primary eRDS AID element 5620, and a Switch Time element 5630. The Switch Time element may contain the lower 4 octets of the TSF Counter. Table 6 is an example of a DMG Beacon frame body. An example of a modified DMG Beacon frame with the new element is shown in Table 6.

TABLE 6

| Order | Information | Notes |
|---|---|---|
| . . . | . . . | . . . |
| 15 | Multi-relay | Optional |
| . . . | . . . | . . . |

In an example, D-REDS may request a Primary eRDS handover due to a decrease in channel quality or link failure. In case of link failure with the Primary eRDS, the Primary eRDS Handover Request message may be transmitted through a Secondary eRDS. The D-REDS may detect link failure due to Nfailed_beacons such as a number of consecutive failed DMG Beacon receptions from the Primary eRDS.

The Primary eRDS may detect link failure with a D-REDS due to Nfailed_SPRs such as a number of consecutive failed SPRs in response to Polls or due to data transmission failures. Then the Primary eRDS may transmit a Primary eRDS Handover Request message to the AP/PCP.

In one example, when multiple relay links are used for communication between the S-REDS and D-REDS, the link qualities of the AP/PCP to eRDS1 link, the eRDS1 to D-REDS link, the AP/PCP to eRDS2 link, and the eRDS2 to D-REDS link may be required to report to the AP/PCP. The methods and procedures in this subsection enable the periodic channel evaluation with multi-relay.

FIG. 57 is a diagram of an example signaling procedure for periodic channel evaluation with multi-relay 5700. The signaling procedure for periodic channel evaluation with multi-relay 5700 may involve an AP/PCP functioning as an S-REDS 5701, a primary relay eRDS1 5702, a secondary relay eRDS2 5703, and a new node functioning as a D-REDS 5704. In this example, to setup the periodic channel evaluation, the S-REDS 5701 may transmit a Multi-Relay Link Measurement Setup frame 5705 to the eRDS1 5702 to define the periodicity of the link measurement. The eRDS1 5702 may forward this frame 5705A to the D-REDS 5704 to setup the periodic channel evaluation. The S-REDS 5701 may also transmit a Multi-Relay Link Measurement Setup frame 5707 to eRDS2 5703, and then the eRDS2 5703 may forward this frame 5707A to the D-REDS 5704 to setup the periodic channel evaluation for the secondary relay.

For each periodic channel evaluation cycle, the D-REDS 5704 may transmit a Multi-Relay Link Measurement Report frame 5709 to eRDS1 5702, which may include the channel measurement results between D-REDS 5704 and eRDS1 5702. Once eRDS1 5702 receives this frame 5709, it may transmit a Remote Multi-Relay Link Measurement Report frame 5711 to the S-REDS 5701, which may include the channel measurement results between the D-REDS 5704 and eRDS1 5702 and also may include the channel measurement results between the eRDS1 5702 and S-REDS 5701.

Similar procedures may be executed between the D-REDS 5704 and eRDS2 5703 and also between the eRDS2 5703 and S-REDS 5701 to report the link measurement results for the secondary relay to the AP/PCP. Alternatively, the channel measurement results between the D-REDS 5704 and eRDS2 5703 may also be reported to eRDS1 5702. The eRDS1 5702 may forward this report frame to the S-REDS 5701, together with the channel measurement results between the D-REDS 5704 and eRDS1 5702. The same channel evaluation procedures may be repeated per periodic cycle, as shown in FIG. 57.

Upon reception of Remote Multi-Relay Link Measurement Report frames 5711, 5713 from eRDS1 5702 and eRDS2 5703 respectively, the S-REDS 5701 may take several actions including changing the MCS it uses for frame transmission to the eRDSs and also from eRDSs to the D-REDS. For mobile networks, it may require changing the primary/secondary relay nodes if the primary/secondary relays are moving out of the range of the D-REDS/S-REDS.

In one example, the AP/PCP may use MU-MIMO techniques for downlink data transmissions to multiple eRDSs, as described in IEEE 802.11ac-2013 specifications. However, the standard requires equal modulation (EQM) for MIMO transmissions. Therefore, the AP/PCP may not be able to use the highest possible MCS for some of the eRDSs, as dictated by individual link qualities. A channel access mechanism is disclosed herein to enable efficient MU-MIMO transmissions when multiple relays are used.

FIG. 58 is a diagram of an example signaling procedure for a Multi User-Multiple Input Multiple Output (MU-MIMO) channel access mechanism with multiple relays 5800. This example procedure may involve an AP/PCP functioning as an S-REDS 5805, a first eRDS1 5810, a second eRDS2 5815, and a D-REDS 5820. The S-REDS 5805 may perform a MU-MIMO transmission 5825 to the two eRDSs associated with the D-REDS 5820. As stated elsewhere herein, this transmission may use the highest MCS supported by both eRDSs. The eRDSs may subsequently respond with Block ACKs 5830, indicating reception status. The S-REDS 5805 may then re-transmit un-acknowledged MPDUs 5835 to the eRDS with better channel conditions, supporting higher MCS. In one example, the AP/PCP may use the better quality link for re-transmitting data packets that were originally transmitted to the other eRDS.

The S-REDS 5805 may trigger data transmission from an eRDS to the D-REDS by transmitting a Grant frame 5840 to one of the eRDSs, eRDS2 5815 in the example shown here. eRDS2 5815 may use single stream or Single User-MIMO (SU-MIMO) transmission for packet transmission 5845 to D-REDS 5820. In this example, simultaneously, the S-REDS 5805 may transmit data packets 5850 to eRDS1 5810 provided the transmission does not interfere with eRDS2 to D-REDS transmissions.

At the end of an eRDS2 to D-REDS transmission duration, the S-REDS 5805 may transmit a Relay Block ACK Request (RBAR) frame 5855 to eRDS2 5815. eRDS2 5815 may respond with a Relay Block ACK (RBA) frame 5860. Alternately, the eRDS may transmit the RBA frame without requiring a request from the S-REDS 5805.

Thereafter, eRDS1 5810 may forward data packets 5865 received previously from the S-REDS 5805 to the D-REDS 5820 after receiving a channel grant in a Grant frame 5870 from the S-REDS 5805. Packet transmission to the D-REDS may be reported to the S-REDS 5805 using an RBA frame 5875 as before. In case of missing packets either from eRDS2 to D-REDS or from eRDS1 to D-REDS, the S-REDS may transmit another Grant frame to the eRDS for re-transmission.

In the millimeter wave (mmW) spectrum band, the frequency bands in which IEEE 802.11aj, IEEE 802.11ad and IEEE 802.11ay and other IEEE 802.11 STAs operate, due to the propagation characteristics of the mmW waveform, the communication channel between two DMG STAs is mostly line-of-sight. Consequently, communications between DMG STAs uses only one spatial stream. Demanding traffic patterns and applications may require higher throughput between DMG STAs than currently specified in IEEE 802.11ad. In one embodiment methods and systems for supporting multiple concurrent data streams between two DMG STAs is disclosed.

In IEEE 802.11ad, a source relay end DMG STA (S-REDS) may set up a relayed link through a relay DMG STA (RDS) with a destination relay end DMG STA (D-REDS). However, the relay selection procedure described in IEEE 802.11ad requires that the S-REDS and the D-REDS be able to communicate directly. Such a requirement leads to the restrictions of the usage of the relay only to the situation where the S-REDS and D-REDS are within range of each other. Enhancement of the relay selection procedure as well as relay transmission procedures using a relay is desired in order to support the communications through a RDS between the S-REDS and the D-REDS that are not within range of each other.

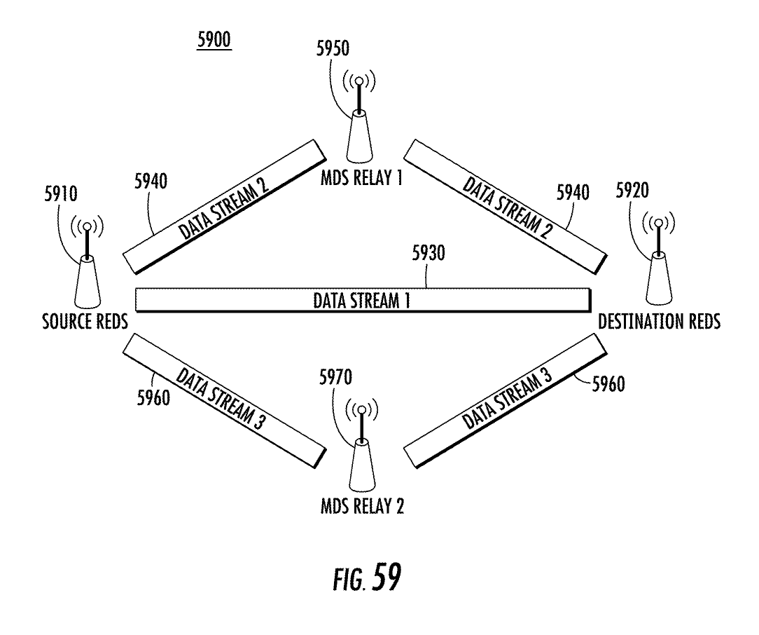

Multiple data stream support using RDS is disclosed herein. FIG. 59 is an example multiple data stream procedure 5900 using multiple data stream relay STAs between a S-REDS 5910 and a D-REDS 5920. Multiple data streams between a source STA and a destination STA may be supported if multiple relays are used between the source and destination STA.

Due to the propagation characteristics of mmW signals, it is difficult to support multiple data streams between a source and a destination STAs that may be IEEE 802.11aj, IEEE 802.11ad or IEEE 802.11ay STAs or IEEE 802.11 STAs. Multiple data stream (MDS) relay STAs or RDSs may be used to provide support for MDS between STAs, e.g., DMG or IEEE 802.11aj or IEEE 802.11ay STAs. Referring to FIG. 59, a S-REDS 5910 and a D-REDS 5920 may support three data streams between them, data stream 1 5930 through the direct link between the S-REDS 5910 and the D-REDS 5920, data stream 2 5940 through MDS relay 1 5950, and data stream 3 5960 through MDS relay 2 5970.

An embodiment for MDS relay capability indication is disclosed herein. All STAs involved in the MDS relay operations, such as the relay STAs (RDS), the source and D-REDS, may need to support the MDS mode of the relay operation. A STA may indicate that it is capable of supporting MDS mode of the relay operation as a RDS or as an REDS in one or more of a (re)association request, (re)association response, probe request, probe response, information request, and information response frames, for example, by including a modified relay capabilities element. An AP or relay capable personal basic service set (PBSS) control point (PCP) may indicate in DMG beacon frames, for example, by including a modified relay capabilities element, that it supports the MDS mode of relay operation as an RDS or as an REDS.

FIG. 60 is a diagram of an example design of the modified relay capabilities information field 6000 to indicate the support for MDS relay mode. The modified relay capabilities information field 6000 may include an MDS Relay bit 6010, an MDS Relay Supportability bit 6020, and a Number of DS field 6030.

The MDS Relay bit 6010 in the modified relay capability information field 6000 may indicate whether the transmitting STA is capable of transmitting or receiving multiple data streams through MDS relay STAs. It may be set to 1 if the transmitting STA is capable of transmitting or receiving multiple data streams through MDS relay STAs and is capable of setting up MDS relay links as an end STA such as source and destination REDS. It may be set to 0 otherwise.

The MDS relay supportability bit 6020 in the modified relay capability information field 6000 may indicate whether the transmitting STA is capable of providing MDS relaying between two STAs, such as source and destination REDS. It may be set to 1 if the transmitting STA is capable of MDS relaying and functioning as a MDS relay. It may be set to 0 otherwise. The Number of DS field 6030 may indicate the number of concurrent data streams that a source or destination REDS may be able to support through a MDS relay operation.

MDS relay discovery and selection procedures are disclosed herein. The MDS relay discovery procedure may be as disclosed herein. A STA, for example, a S-REDS, may obtain the capabilities of other STAs in the BSS following the STA's association with the BSS or with the transmission of an information request frame.

A source STA may discover a destination STA with which it desires to connect or may have a direct connection already. If the S-REDS desires to have multiple data streams to the D-REDS, and if the destination STA is capable of supporting MDS relaying operation as an end STA, then the source STA may initiate the MDS relay STAs discovery and selection procedures.

The source STA that intends to set up MDS relay operation with a destination STA shall obtain the capabilities of the destination DMG STA prior to initiating the MDS relay setup procedure with the destination STA. A source STA may only attempt to initiate an MDS relay link setup (RLS) procedure with a destination STA if the destination STA indicates that it supports MDS relay operations, in one embodiment, in its relay capabilities information field. The maximal number of DS that can be set up may not exceed the maximal DSs that the source or destination STAs may support as indicated in their relay capabilities information field.

The source STA may attempt to set up a MDS relay operation with the destination STA only if both the source STA and destination STA are REDS that both support MDS relay operations, and there exists at least one RDS in the BSS that supports MDS relay operations.

The SME of the source STA may issue a MLME-RELAYSearch.request primitive, which may be modified as disclosed herein. One function of the MLME-RELAYSearch.request primitive may include initiation of a relay search process from the SME to the MLME. The semantics of the primitive including exemplary disclosed primitive parameters as disclosed herein.

MLME-RELAYSearch.request (

DestinationMACAddress,
RelayType,
MDSRelay

)

FIG. 61 is a diagram of an example relay discovery procedure 6100. The parameter RelayType may indicate one or more types of relays being searched and may include one or more of a Range Extension, cooperation, link switch, MDSRelay, etc. and the parameter MDSRelay may be an indicator of whether the MDS relay STA is being searched for.

FIG. 61 shows a non-PCP/non-AP STA 6105 that includes an SME 6110 and an MLME 6120. The non-PCP/non-AP STA 6105 may perform a relay discovery procedure 6100 with a PCP/AP 5125 that may include an MLME 6130 and an SME 6135. In this example, an MLME-RELAYSearch.request primitive 6140 may be generated by the SME 6110 at a non-PCP/non-AP STA 6105 to request the PCP/AP 6125 for a list of appropriate RDSs in the BSS.

The effect of receipt of the MLME-RELAYSearch.request primitive is disclosed herein. This primitive may initiate a relay search procedure and provides the accompanying search criteria's. Upon receipt of the MLME-RELAYSearch.request primitive 6140, the MLME 6120 may issue an MLMERELAYSearch.confirm primitive 6145 that reflects the results. Upon receiving the MLME-RELAYSearch.request primitive, the non-PCP/non-AP STA 6105 may discover a list of RDSs in the BSS by transmitting a relay search request frame 6150 to the PCP/AP 6125 with the D-REDS AID field set to the AID of the destination STA, and if the MLME-RELAYSearch.request 6140 includes specific relay types, such as MDS relay, the non-PCP/non-AP STA 6105 may include a relay type indication or an MDS relay indication in the relay search request frame 6150 to the PCP/AP 6125. The MLME 6130 of the PCP/AP 6125 receiving a relay search request frame 6150 may generate an MLME-RELAYSearch.indication primitive 6155, which may also be modified by adding parameters such as a RelayType or an MDSRelay indicator that may be contained in the relay search request frame 6150 specifying the relay type or indicating the search for MDS relays.

Upon receiving an MLME-RELAYSearch.response primitive 6160, the PCP/AP 6125 shall transmit a relay search response frame 6165 addressed to the requesting STA, i.e. the non-PCP/non-AP STA 6105, and may include in the transmitted frame a list of RDSs in the BSS, or may include in the transmitted frame a list of RDSs in the BSS that satisfied the RelayType or can supported MDS relay operations if the criteria has been included in the associated relay search request frame. The MLME 6120 of the non-PCP/non-AP STA 6105 receiving a relay search response frame 6165 shall generate an MLME-RELAYSearch.confirm primitive 6170.

After the transmission of the relay search response frame 6170 to the non-PCP/non-AP STA 6105, the PCP/AP 6125 may transmit an unsolicited relay search response frame 6175 to the destination STA 6180 with the relay capable STA info field of the source STA and the list of RDSs that the PCP/AP 6125 included in the last relay search response frame transmitted to the non-PCP/non-AP STA 6105. The PCP/AP 6125 may also specifically indicate to the destination STA 6180 that the searched RDS are of certain categories, such as MDS Relay.

FIG. 62 is a diagram of an example MDS relay selection procedure 6200. The PCP/AP may schedule two service periods (SPs) for beamforming (BF) for each MDS relay STA contained in the transmitted relay search response frame. In the first SP, the transmitter may be the source STA and the destination may be the MDS relay STA. In the second SP, the transmitter may be the MDS relay STA and the destination may be the destination STA, such as the D-REDS.

After the MDS RDS 6210 completes BF 6220 with both the S-REDS 6230 and D-REDS 6240, the S-REDS 6230 shall transmit a multi-relay channel measurement request frame 6250 to the RDS 6210, which shall respond with the transmission of a multi-relay channel measurement report frame 6260 back to the S-REDS 6230. The MDS RDS 6210 may be referred to as an MDS Relay STA, a DMG STA, or an Enhanced DMG (EDMG) STA.

The source STA 6230 may conduct BF 6220 with the destination STA 6240, if there is a direct link between the source and the destination STA, the source STA 6230 may transmit a multi-relay channel measurement request frame to the destination STA 6240. The destination STA 6240 may respond with a multi-relay channel measurement report frame.

If the source STA 6230 and the destination STA 6240 are out of range of each other, or if it is already known that the source and destination STAs are out of range beforehand, the source STA 6230 and destination STA 6240 may exchange information through a third STA, such as the RDS 6210, PCP/AP, or a range extension relay STA, or other type of relay STAs.

For MDS relay selection, the source STA needs to transmit a multi-relay channel measurement request frame to the destination STA. If the source STA and the destination STA are out of range of each other, the source STA needs to transmit the multi-relay channel measurement request frame in one or more ways as disclosed herein.

The source STA may transmit the multi-relay channel measurement request frame to the PCP/AP, the PCP/AP then forwards the multi-relay channel measurement request frame to the destination STA. The source STA may transmit the multi-relay channel measurement request frame to a third STA, such as a previously established range extension relay, or other type of relay, the third STA then forwards the multi-relay channel measurement request frame to the destination STA. The multi-relay channel measurement request frame transmitted by the source STA may contain the transmitting STA address, such as the MAC address/AID of the source STA, and/or the BSS/PBSS to which the source STA belongs, both the receiving address and the destination address, with the receiving address being the MAC/AID address of the PCP/AP or range extension relay, and the destination address being the MAC/AID address of the destination STA. The Multi-relay channel measurement request frame transmitted by the forwarding STA, such as the PCP/AP or the range extension relay, may contain the transmitting STA address, such as the MAC address/AID of the forwarding STA, and/or the BSS/PBSS to which the source STA belongs, both the requesting address and the destination address, with the requesting address being the MAC/AID address of the source STA, and the destination address being the MAC/AID address of the destination STA.

When the destination STA receives the multi-relay channel measurement request frame, it shall respond with a multi-relay channel measurement report frame in one or more ways as disclosed herein. The destination STA transmits the multi-relay channel measurement report frame to the PCP/AP, the PCP/AP then forwards the multi-relay channel measurement report frame to the source STA. The destination STA transmits the multi-relay channel measurement report frame to a third STA, such as a previously established range extension relay, the third STA then forwards the multi-relay channel measurement report frame to the source STA.

The multi-relay channel measurement report frame transmitted by the destination STA may contain the transmitting STA address, such as the MAC address/AID of the destination STA, and/or the BSS/PBSS to which the destination STA belongs, both the receiving address and the destination address, with the receiving address being the MAC/AID address of the PCP/AP or range extension relay, and the destination address being the MAC/AID address of the source STA.

The multi-relay channel measurement report frame transmitted by the forwarding STA, such as the PCP/AP or the range extension relay, may contain the transmitting STA address, such as the MAC address/AID of the forwarding STA, and/or the BSS/PBSS to which the destination STA belongs, both the requesting address and the destination address, with the requesting address being the MAC/AID address of the destination STA, and the destination address being the MAC/AID address of the source STA.

Once the source STA receives the multi-relay channel measurement report frame from the destination STA and the multi-relay channel measurement report frame from the list of MDS relay STAs, it may select one or more MDS relay STAs as the MDS relay(s) between the source and the destination STA.

MDS relay link setup procedures are disclosed herein. An embodiment of the MDS relay link setup (RLS) procedure may be as disclosed herein. Once the source STA has selected one or more MDS relays, the SME of the source STA may issue the MLME-RLS.request primitive to initiate the MDS RLS procedure. The MLME-RLS.request may contain one or more relayMACaddresses if one or more relays are selected for the RLS procedure. The MLME-RLS.request may also contain one or more RelayOrder parameters, each associated with one MDS relay. The RelayOrder specify an order for each of the MDS relay. Data stream 0 may be transmitted over the direct link between the source and destination STA, if there is a direct link between the source and the destination STA; or through the MDS relay STA with the lowest or highest RelayOrder. Alternatively or additionally, Data stream 1 may be transmitted through the MDS relay STA with the lowest or highest RelayOrder. Data stream 2 may be transmitted through the MDS relay STA with the second lowest or highest RelayOrder.

The MLME-RLS.request may contain one or more RelayType parameter, each associated with a delay. The RelayType field may specify how a Relay STA should be used, for example, MDS Relay which may relay a data stream, or backup relay which may be used a backup relay if one of the MDS relay link fails. The MLME-RLS.request may contain the modified DestinationCapabilityInformation parameter which may include a modified relay capability field, to indicate that the destination STA is capable of being a D-REDS of a MDS relay operation. The MLME-RLS.request may contain one or more modified RelayCapabilityInformation parameter, each associated with one MDS relay, which may include a modified relay capability field, to indicate that the relay STA is capable of being a MDS relay.

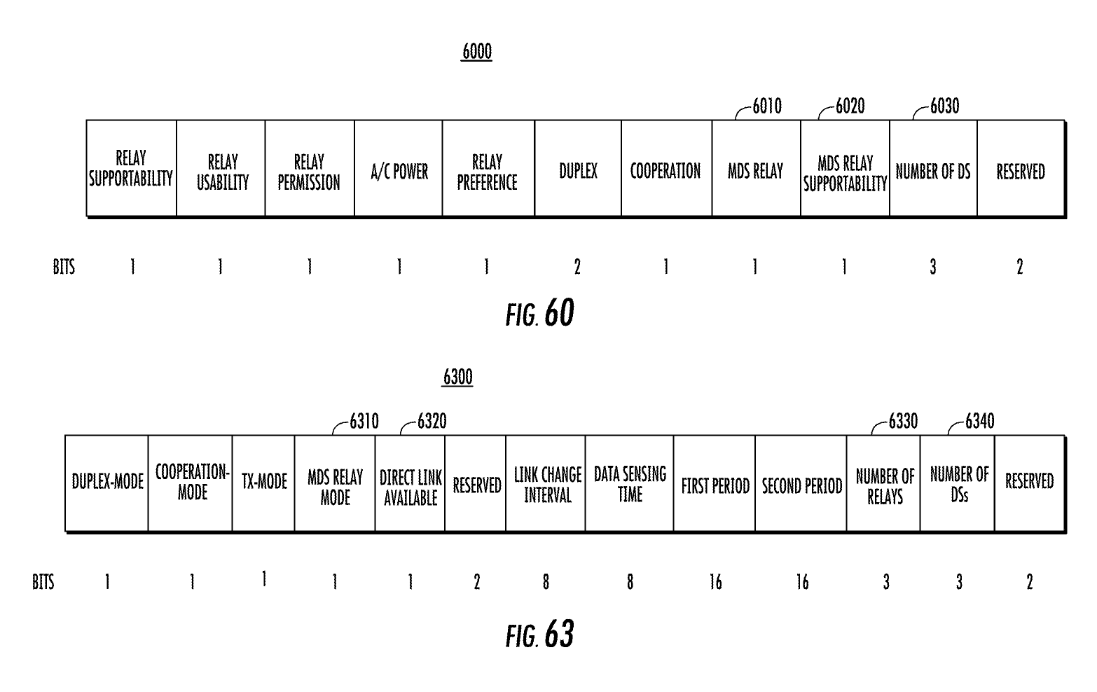

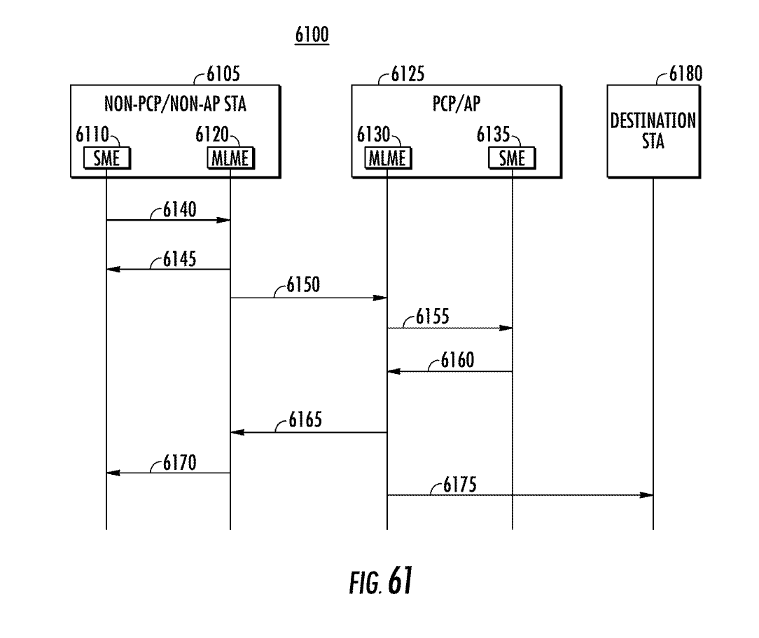

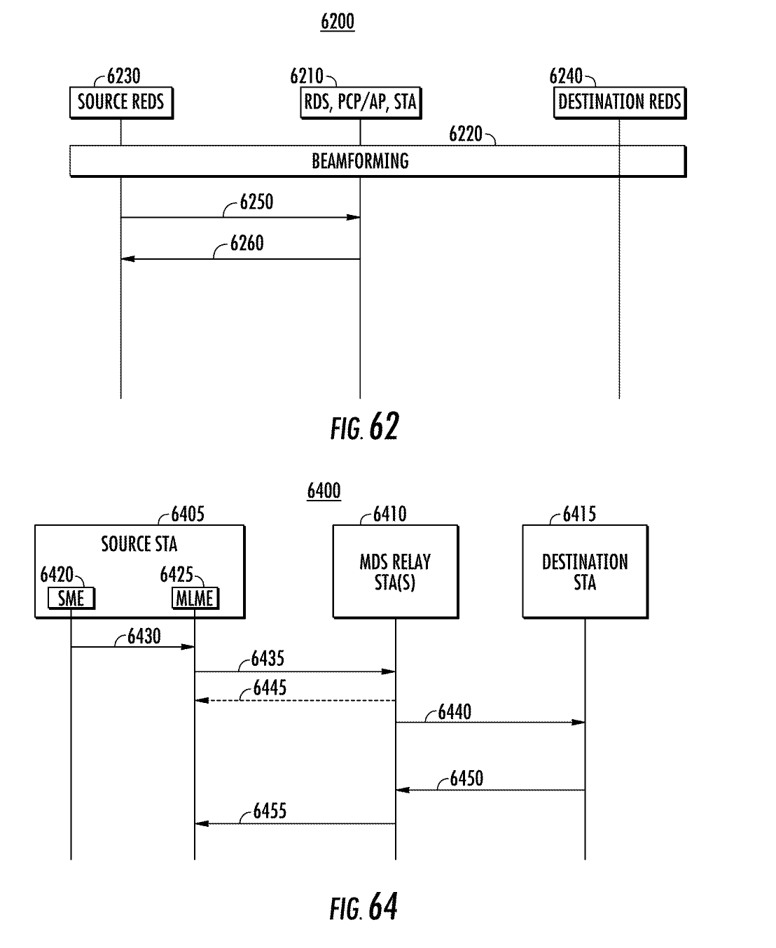

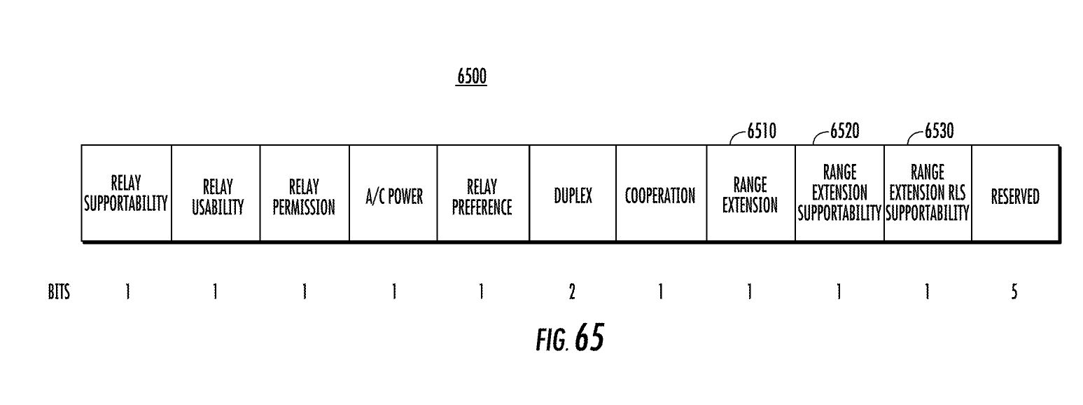

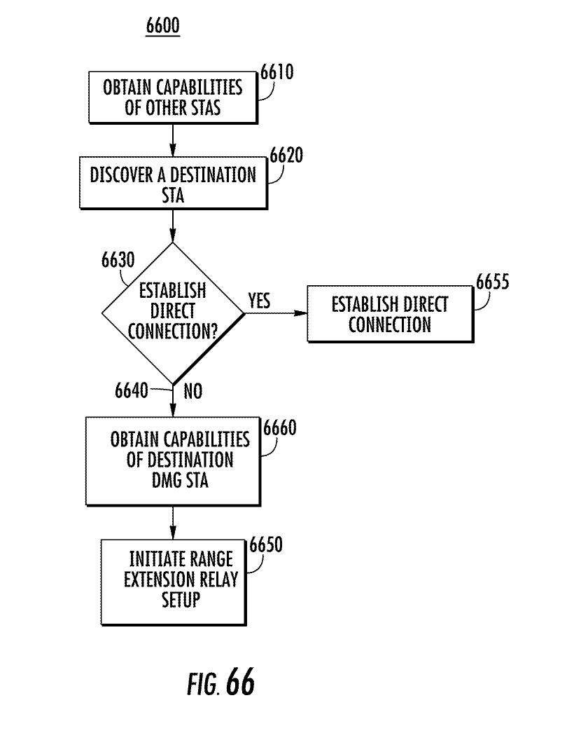

Additionally or alternatively, each relay may be identified using a collection of parameters such as a RelayID, RelayType, RelayOrder, RelayCapabilityInformation, and/or a Data Stream number. The MLME-RLS.request may contain the modified RelayTransferParameterSet parameter to indicate that the relay link setup is to establish MDS relay links. An example design of the relay transfer parameter field contained in the RelayTransferParameterSet is shown in FIG. 63. FIG. 63 includes one example design of a modified relay transfer parameter field 6300 of the relay transfer parameter set element to support MDS relay operations. The modified relay transfer parameter field 6300 may contain an MDS Relay Mode indicator 6310 to indicate that the relay operation being set up is a MDS relay operation, a Direct Link Available indicator 6320 to indicate that there is a direct link between the source and the destination STA, the Number of Relays indicator 6330 to indicate the total number of relays that are being set up, and the Number of DSs indicator 6340 to indicate the total number of data streams that are being set up in the MDS relay operation that is being set up.

FIG. 64 is a diagram of an example relay link setup procedure 6400 between a source STA 6405, one or more MDS relay STA(s) 6410, and a destination STA 6415. The source STA 6405 may include an SME 6420 and an MLME 6425. Upon receiving the MLME-RLS.request 6430, the source STA 6405 then may transmit an RLS request frame 6435 to the selected MDS relay STAs 6410. The RLS request frame 6435 may contain the AIDs for the source, destination and the MDS relay STAs, the RelayOrder that is assigned to the MDS relay, the Data Stream number, the RelayType assigned to the MDS relay and the relay capability information contained in the MLME-RLS.request, and the relay transfer parameter set included in the MLME-RLS.request.

Upon receiving the RLS request frame 6435 from the source STA 6405, and if the MDS relay STA 6410 is willing to participate in the MDS RLS, the MDS relay STA may forward 6440 the information contained in the RLS request frame 6435 to the destination STA 6415. Otherwise, the MDS relay STA 6410 may respond with an RLS response frame 6445 with the status code “failed” or “relay declined”. The destination STA 6415, if it is willing to participate in the MDS RLS, after receiving the RLS Request frame 6440 from the MDS relay STA 6410, shall store the data stream number and/or RelayOrder and RelayType associated with the MDS Relay, and respond with a RLS Response frame 6450 with a “success” status code and transmit it to the MDS Relay, which may include one or more of the Relay ID, the Data Stream number, the RelayOrder and RelayType.

After receiving the RLS response frame 6450 with status code “success” from the destination STA 6415, the MDS Relay STA 6410 may transmit an RLS response frame 6455 to the source STA 6405 with the status code “success”, which may include one or more of the Relay ID, the Data Stream number, the RelayOrder and RelayType, if it is willing to participate in MDS RLS. The MDS RLS may only be successful if the source STA has received RLS response frame with the status code “success” from each MDS relay selected. If a RLS response frame has not been received from a particular MDS relay, then the source STA may re-transmit a RLS request frame to the MDS relay with the same parameters. A new MDS RLS procedure may be initiated if the MDS RLS procedure has not been successful for a certain period of time or has failed for a certain number of times, which may exclude the MDS relay STAs that declined or did not provide RLS response frames with the Status Code “Success”.

An exemplary MDS relay link transmission procedure is disclosed herein. After successful MDS RLS procedures, SPs may be allocated to MDS Relay operations. At the beginning of the SP allocated to MDS Relay operations, the S-REDS may initiate an RF antenna module in transmit mode directed at each of the MDS RDSs. If there is a direct link between the source and the destination REDS, the S-REDS may initiate an RF antenna module in transmit mode directed at the D-REDS. Each of the MDS RDSs may initiate an RF antenna module in receive mode directed at the S-REDS, and may initiate an RF antenna module in transmit mode directed at the D-REDS. The D-REDS may initiate an RF antenna module in receive mode directed at each of the MDS RDSs, and directed to the S-REDS if there is a direct link between the source and the D-REDS.

In a first period, the S-REDS may transmit multiple concurrent data streams to the D-REDS and the MDS REDS. The S-REDS may transmit a data stream through a direct link or through each of the MDS RDSs. The MDS RDSs and the D-REDS may acknowledge the reception of the transmitted packets using ACKs or BAs. In a second period, the MDS RDSs may transmit received packets from the S-REDS to the D-REDS. The D-REDS may acknowledge the reception of the transmitted packets using ACKs or BAs on each relay link. Additionally or alternatively, the D-REDS may use the direct link to the S-REDS or a primary MDS relay link, for example, through the MDS Relay with the lowest RelayOrder, to acknowledge all packets received over all relay links using ACKs or BAs.

The relay capabilities information or the relay transfer parameters are example designs, any set or subset of the fields or subfields thereof may be implemented as any other information element, element, capability information, action frame, management frames, control frames, data frames, NDP frames, extension frames, or any part of MAC or PLCP headers.

In another embodiment, a range extension relay link using DMG RDS through tunneling by an AP/PCP is disclosed herein. One or more DMG RDS may be used to provide range extension for WiFi STAs such as IEEE 802.11ad or IEEE 802.11aj and IEEE 802.11ay STAs. Embodiments described herein are proposed to address disclosed enhancements of the relay selection procedure as well as relay transmission procedures. The term STAs are used herein to refer to IEEE 802.11, IEEE 802.11ad, IEEE 802.11aj or IEEE 802.11ay STAs, but may be disclosed embodiments may be used in other technologies without a loss of generalization due to use of the term STA.

A range extension relay capability indication may be further provided in an embodiment. Relay STAs or RDS may be used to provide range extension between STAs, e.g., DMG or IEEE 802.11aj or IEEE 802.11ay STAs, which may not be within range of each other through tunneling through AP/PCP. All STAs involved in the range extension relay operations, such as RDS, the source and destination REDS, may need to support the extension range mode of the relay operation.

A STA may indicate that it is capable of supporting extension range mode of the relay operation as a RDS or as an REDS in one or more of a (re)association request, (re)association response, probe request, probe response, information request, and information response frames, for example, by including a modified relay capabilities element. an AP or relay capable PCP may indicate in DMG beacon frames, for example, by including a modified relay capabilities element, that it can support the range extension mode of relay operation as a RDS or as an REDS.

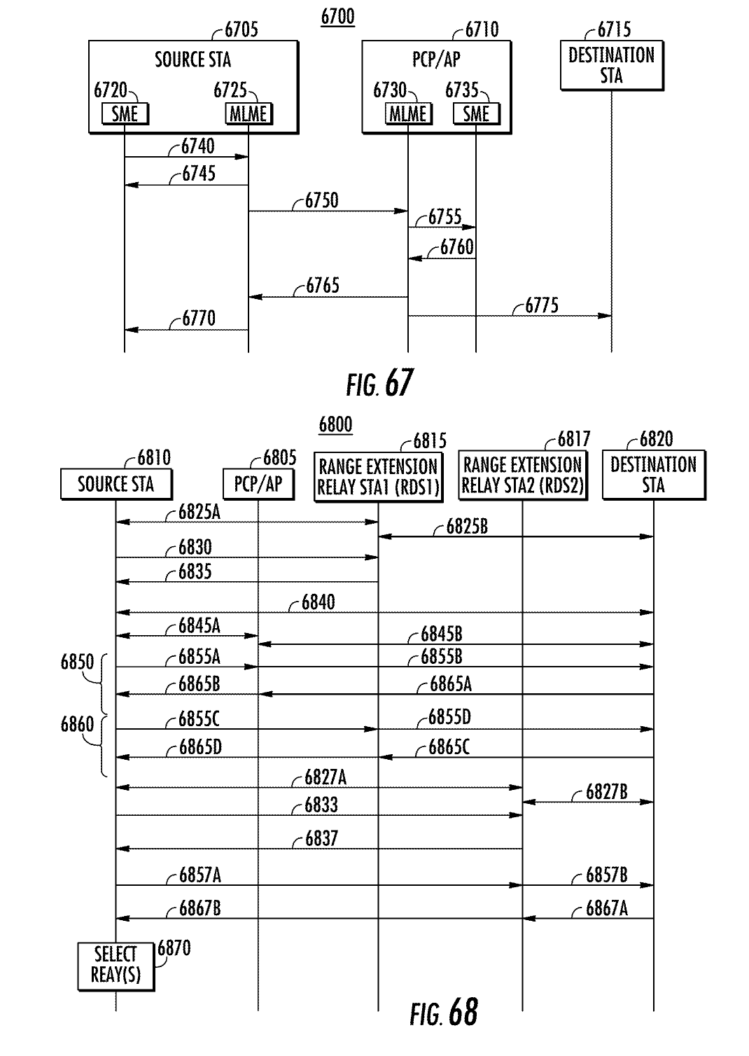

FIG. 65 is a diagram of an example design of the modified relay capabilities information field 6500. The modified relay capabilities information field 6500 may include a range extension bit 6510, a range extension supportability bit 6520, and a range extension (REX) RLS supportablility bit 6530.

The range extension bit 6510 in the modified relay capability information field 6500 may indicate whether the transmitting STA is capable of using frame-relaying through a range extension relay STA. It may be set to 1 if the transmitting STA is capable of using frame-relay through a range extension relay STA and is capable of setting up a range extension relay link as an end STA such as source and destination REDS. It may be set to 0 otherwise.

The range extension supportability bit 6520 in the modified relay capability information field 6500 may indicate whether the transmitting STA is capable of range extension relaying, or relaying by transmitting and receiving frames between a pair of other STAs that are not within range of each other, such as source and destination REDS. It may be set to 1 if the transmitting STA is capable of range extension relaying and functions as a range extension relay. It may be set to 0 otherwise.

The range extension (REX) RLS supportability bit 6530 in the modified relay capability information field 6500 may indicate whether the transmitting STA, for example, PCP or AP, is capable of supporting REX RLS relaying, for example, between a source and destination REDS that support REX relaying and a RDS that supports REX relaying. It may be set to 1 if the transmitting PCP/AP is capable of supporting range extension RLS. It may be set to 0 otherwise. Alternatively or additionally, the PCP/AP may indicate in its DMG or capabilities element that it is capable of providing tunneling of packets or similar capabilities so that the source and destination REDS and the range extension RDS may establish range extension relay link setup.

FIG. 66 is a diagram of an example range extension relay discovery procedure 6600. A STA, for example, a S-REDS, may obtain the capabilities of other STAs 6610 in the BSS following association with the BSS or with the transmission of an information request frame. A source STA may discover a destination STA 6620 with which it desires to connect. The source STA may then determine 6630 whether or not it is capable of establishing a direct connection with the destination STA. If the source STA discovers that it cannot establish a direct connection 6640 to the destination STA, for example, after beamforming training fails between the two STAs, the source STA may decide to initiate range extension relay link setup 6650 with the destination STA. The source STA may establish a direct connection 6655 with the destination STA if it determines that it is capable of doing so.

The source STA that intends to set up range extension relay operation with a destination STA may obtain the capabilities of the destination DMG STA 6660 prior to initiating the range extension relay setup procedure with the destination STA. A source STA may only attempt to initiate range extension relay link setup procedure with a destination STA if the destination STA indicates that it support range extension relay operations, in one embodiment, in its relay capabilities information field. In addition, the PCP/AP with which the source and destination STAs are associated with may have indicated that it supports range extension relay link setup or tunneled packet forwarding capabilities, in one embodiment, by setting the appropriate bits in the relay capabilities information field.

The source STA may attempt to set up range extension relay operation with the destination STA only if both the source STA and destination STA are REDS that both support range extension relay operations, and there exists at least one RDS in the BSS that supports range extension relay operations.

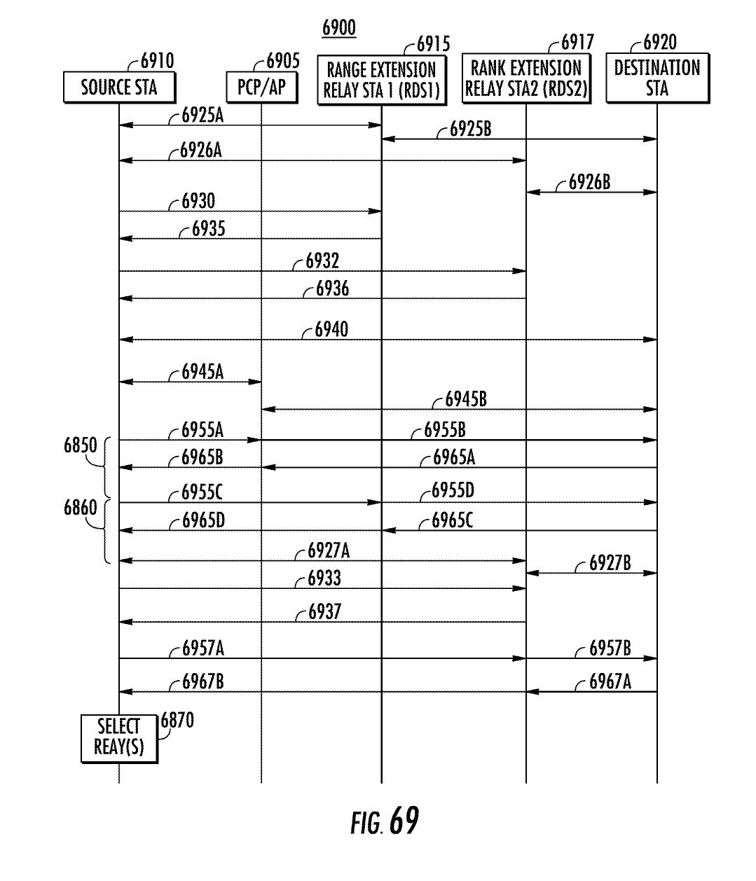

FIG. 67 is a diagram of another example range extension relay discovery procedure 6700. This example may involve a source STA 6705, a PCP/AP 6710, and a destination STA 6715. The source STA 6705 may comprise an SME 6720 and an MLME 6725. The PCP/AP 6710 may include an MLME 6730 and an SME 6735.

In this example, the SME 6720 of the source STA 6705 may issue a MLME-RELAYSearch.request primitive 6740, which may be modified as disclosed herein. The function of the MLME-RELAYSearch.request primitive 6740 may include being issued by the SME 6720 to the MLME 6725 to initiate the relay search process. The semantics of the primitive, including exemplary primitive parameters, are as disclosed herein.

MLME-RELAYSearch.request (

DestinationMACAddress,
RelayType,
ExtendedRange

)

The parameter RelayType may indicate the type(s) of relays being searched, which may include one or more of range extension, cooperation, link switch, etc. The parameter ExtendedRange may be an indicator whether range extension relay is being searched for.

The MLME-RELAYSearch.request primitive 6740 may be generated by the SME at a non-PCP/non-AP STA to request the PCP/AP 6710 for a list of RDSs in the BSS. The effect of the receipt of the MLME-RELAYSearch.request primitive 6740 is disclosed herein. This primitive may cause initiation of a relay search procedure and the accompanying search criteria. The MLME 6725 may subsequently issue an MLMERELAYSearch.confirm primitive 6745 that reflects the results. Upon receiving the MLME-RELAYSearch.request primitive 6740, the source STA 6705 may discover a list of RDSs in the BSS by transmitting a relay search request frame 6750 to the PCP/AP 6710 with the D-REDS AID field set to the AID of the destination STA 6715, and if MLME-RELAYSearch.request 6740 includes specific relay types, such as range extension, the source STA 6705 may include relay type indication or range extension indication in the relay search request frame 6750 to the PCP/AP 6710.

The MLME 6730 of the PCP/AP 6710 receiving a relay search request frame 6750 may generate an MLME-RELAYSearch.indication primitive 6755, which may also be modified by adding parameters such as RelayType or ExtendedRange indicator, which may be contained in the relay search request frame 6750 specifying the relay type or indicates the search for range extension relays.

Upon receiving an MLME-RELAYSearch.response primitive 6760, the PCP/AP 6710 may transmit a relay search response frame 6765 addressed to the requesting STA and shall include in the transmitted frame a list of RDSs in the BSS, or may include in the transmitted frame a list of RDSs in the BSS that satisfied the RelayType or can supported range extension relay operations if the criteria has been included in the associated relay search request frame.

The MLME 6725 of the source STA 6705 receiving a relay search response frame 6765 may generate an MLMERELAYSearch.confirm primitive 6770. After the transmission of the relay search response frame 6765 to the source STA 6705, the PCP/AP 6710 may transmit an unsolicited relay search response frame 6775 to the destination STA 6715 with the relay capable STA info field of the source DMG STA and the list of RDSs that the PCP/AP included in the last relay search response frame transmitted to the source DMG STA. The PCP/AP may also specifically indicate to the destination STA that the searched RDS are of certain categories, such as range extension.

Range extension relay selection may be performed in several manners. In one example, a source STA and a destination STA may pair trainings with a relay STA, and then exchange information regarding the channel measurement of the relay STA for selection. This process may then be repeated for each relay STA in the network. In another example, a source STA and a destination STA may pair trainings with multiple relay STAs, exchange information regarding the channel measurement of all the relay STAs, and then select one or more range extension relay STAs. It is noted that the sequence of these signal transmissions may be performed in any order and not limited to the signaling shown in FIGS. 68 and 69.

FIG. 68 is a diagram of an example range extension relay selection procedure 6800. This example range extension relay selection procedure may be performed with several range extension relay STAs, however only two range extension relay STAs are shown in FIG. 68 for simplicity.

The PCP/AP 6805 may schedule two SPs for beamforming training for each of the range extension relays contained in the transmitted relay search response frame. In the first SP, the transmitter may be the source STA 6810 and the destination may be the range extension relay STA1 6815. In the second SP, the transmitter may be the range extension relay STA1 6815 and the destination may be the destination STA 6820, such as the D-REDS.

After the range extension relay STA1 6815 completes BF with both the source STA and destination STA 6825A, 6825B, the source STA may transmit a multi-relay channel measurement request frame 6830 to the range extension relay STA1 6815, which shall respond with the transmission of a multi-relay channel measurement report frame 6835 back to the source STA 6810. The source STA 6810 may conduct BF 6840 with the destination STA. If the source STA 6810 and the destination STA 6820 are out of range of each other, or if it is already known that the source and destination STAs are out of range beforehand, the source STA 6810 and destination STA 6820 must exchange information 6845A, 6845B through a third STA, such as PCP/AP 6805.

For range extension relay selection, the source STA may transmit a multi-relay channel measurement request frame to the destination STA. Since the source STA and the destination STA are out of range of each other, the source STA needs to transmit the multi-relay channel measurement request frame in one or more of the following ways.

In a first example 6850, the source STA 6810 may transmit the multi-relay channel measurement request frame 6855A to the PCP/AP 6805, the PCP/AP 6805 may forward the multi-relay channel measurement request frame 6855B to the destination STA 6820. In a second example, 6860, the source STA 6810 may transmit the multi-relay channel measurement request frame 6855C to a third STA, such as a previously established range extension relay STA1 6815, the third STA then forwards the multi-relay channel measurement request frame 6855D to the destination STA 6820.

The multi-relay channel measurement request frame 6855A, 6855C transmitted by the source STA 6810 may contain the transmitting STA address, such as the MAC address/AID of the source STA, and/or the BSS/PBSS to which the source STA belongs, both the receiving address and the destination address, with the receiving address being the MAC/AID address of the PCP/AP or range extension relay, and the destination address being the MAC/AID address of the destination STA.

The multi-relay channel measurement request frame 6855B, 6855D transmitted by the forwarding STA, such as the PCP/AP 6805 or the range extension relay STA1 6815, may contain the transmitting STA address, such as the MAC address/AID of the forwarding STA, and/or the BSS/PBSS to which the source STA belongs, both the requesting address and the destination address, with the requesting address being the MAC/AID address of the source STA, and the destination address being the MAC/AID address of the destination STA.

In the first example 6850, when the destination STA 6820 receives the multi-relay channel measurement request frame 6855B, it may respond with a multi-relay channel measurement report frame in one or more of the ways disclosed herein. The destination STA 6820 may transmit the multi-relay channel measurement report frame 6865A to the PCP/AP 6805, and the PCP/AP 6805 may forward the multi-relay channel measurement report frame 6865B to the source STA 6810. In the second example 6860, the destination STA 6820 may transmit the multi-relay channel measurement report frame 6865C to a third STA, such as a previously established range extension relay STA1 6815, the third STA then forwards the multi-relay channel measurement report frame 6865D to the source STA 6805.

The multi-relay channel measurement report frame 6865A, 6865C transmitted by the destination STA 6820 may contain the transmitting STA address, such as the MAC address/AID of the destination STA, and/or the BSS/PBSS to which the destination STA belongs, both the receiving address and the destination address, with the receiving address being the MAC/AID address of the PCP/AP or range extension relay, and the destination address being the MAC/AID address of the source STA.

The multi-relay channel measurement report frame 6865B, 6865D transmitted by the forwarding STA, such as the PCP/AP 6805 or the range extension relay STA1 6815, may contain the transmitting STA address, such as the MAC address/AID of the forwarding STA, and/or the BSS/PBSS to which the destination STA belongs, both the requesting address and the destination address, with the requesting address being the MAC/AID address of the destination STA, and the destination address being the MAC/AID address of the source STA.

The PCP/AP 6805 may schedule two SPs for beamforming training for range extension relay STA2 6817 contained in the transmitted relay search response frame. In the first SP, the transmitter may be the source STA 6810 and the destination may be the range extension relay STA2 6817. In the second SP, the transmitter may be the range extension relay STA2 6817 and the destination may be the destination STA 6820, such as the D-REDS.

After the range extension relay STA2 6817 completes BF with both the source STA and destination STA 6827A, 6827B, the source STA 6810 may transmit a multi-relay channel measurement request frame 6833 to the relay STA2 6817, which shall respond with the transmission of a multi-relay channel measurement report frame 6837 back to the source STA 6810. The source STA 6810 may conduct BF with the destination STA 6820. If the source STA 6810 and the destination STA 6820 are out of range of each other, or if it is already known that the source and destination STAs are out of range beforehand, the source STA 6810 and destination STA 6820 must exchange information 6845A, 6845B through a third STA, such as PCP/AP 6805.

The source STA 6810 may transmit the multi-relay channel measurement request frame 6857A to a third STA, such as a previously established range extension relay STA2 6817, the third STA then forwards the multi-relay channel measurement request frame 6857B to the destination STA 6820.

The multi-relay channel measurement request frame 6857A transmitted by the source STA 6810 may contain the transmitting STA address, such as the MAC address/AID of the source STA, and/or the BSS/PBSS to which the source STA belongs, both the receiving address and the destination address, with the receiving address being the MAC/AID address of the PCP/AP or range extension relay, and the destination address being the MAC/AID address of the destination STA.

The multi-relay channel measurement request frame 6857B transmitted by the forwarding STA, such as the PCP/AP 6805 or the range extension relay STA1 6815, may contain the transmitting STA address, such as the MAC address/AID of the forwarding STA, and/or the BSS/PBSS to which the source STA belongs, both the requesting address and the destination address, with the requesting address being the MAC/AID address of the source STA, and the destination address being the MAC/AID address of the destination STA.

When the destination STA 6820 receives the multi-relay channel measurement request frame 6857B, it may respond with a multi-relay channel measurement report frame in one or more of the ways disclosed herein. The destination STA 6820 may transmit the multi-relay channel measurement report frame 6867A to the PCP/AP 6805, and the PCP/AP 6805 may forward the multi-relay channel measurement report frame 6867B to the source STA 6810. In the second example 6860, the destination STA 6820 may transmit the multi-relay channel measurement report frame 6867A to a third STA, such as a previously established range extension relay STA2 6817, the third STA then forwards the multi-relay channel measurement report frame 6867B to the source STA 6805.

The multi-relay channel measurement report frame 6867A transmitted by the destination STA 6820 may contain the transmitting STA address, such as the MAC address/AID of the destination STA, and/or the BSS/PBSS to which the destination STA belongs, both the receiving address and the destination address, with the receiving address being the MAC/AID address of the PCP/AP or range extension relay, and the destination address being the MAC/AID address of the source STA. The multi-relay channel measurement report frame 6867B transmitted by the forwarding STA, such as the PCP/AP 6805 or the range extension relay STA2 6817, may contain the transmitting STA address, such as the MAC address/AID of the forwarding STA, and/or the BSS/PBSS to which the destination STA belongs, both the requesting address and the destination address, with the requesting address being the MAC/AID address of the destination STA, and the destination address being the MAC/AID address of the source STA.

Once the source STA receives the multi-relay channel measurement report frame from the destination STA and range extension relay STAs, it may select one or more range extension relay STAs as the range extension relay(s) 6870 between the source and the destination STA. For example, a range extension relay link setup (RLS) procedure may be performed. Once the source STA has selected one or more range extension relay(s), the SME of the source STA may issue the MLME-RLS.request primitive to initiate the REX RLS procedure. The MLME-RLS.request may contain one or more relayMACaddresses if one or more relays are selected for the RLS procedure. The MLME-RLS.request may also contain the modified DestinationCapabilityInformation parameter which may, e.g., include a modified Relay Capability field, to indicate that the destination STA is capable of being a D-REDS of a range extension relay link. The MLME-RLS.request may also contain the modified RelayCapabilityInformation parameter which may, e.g., include a modified Relay Capability field, to indicate that the relay STA is capable of being a range extension relay. The MLME-RLS.request may also contain the modified RelayTransferParameterSet parameter to indicate that the relay link setup is to establish an range extension relay link.

FIG. 69 is a diagram of an example range extension relay selection procedure 6900. This example range extension relay selection procedure may be performed with several range extension relay STAs, however only two range extension relay STAs are shown in FIG. 69 for simplicity.

The PCP/AP 6905 may schedule two SPs for beamforming training for each of the range extension relays contained in the transmitted relay search response frame. In the first SP, the transmitter may be the source STA 1 6910 and the destination may be the range extension relay STA 1 6915. In the second SP, the transmitter may be the range extension relay STA 6915 and the destination may be the destination STA 6920, such as the D-REDS.

The range extension relay STA1 6915 may complete BF with both the source STA and destination STA 6925A, 6925B, and range extension relay STA2 6917 may complete BF with both the source STA and destination STA 6926A, 6926B. The source STA 6910 may transmit a multi-relay channel measurement request frame 6930 to the range extension relay STA1 6915, which shall respond with the transmission of a multi-relay channel measurement report frame 6935 back to the source STA 6910. The source STA 6910 may transmit a multi-relay channel measurement request frame 6932 to the range extension relay STA2 6917, which shall respond with the transmission of a multi-relay channel measurement report frame 6936 back to the source STA 6910. The source STA 6910 may conduct BF 6940 with the destination STA. If the source STA 6910 and the destination STA 6920 are out of range of each other, or if it is already known that the source and destination STAs are out of range beforehand, the source STA 6910 and destination STA 6920 must exchange information 6945A, 6945B through a third STA, such as PCP/AP 6905.

For range extension relay selection, the source STA may transmit a multi-relay channel measurement request frame to the destination STA. Since the source STA and the destination STA are out of range of each other, the source STA needs to transmit the multi-relay channel measurement request frame in one or more of the following ways.

In a first example 6950, the source STA 6910 may transmit the multi-relay channel measurement request frame 6955A to the PCP/AP 6905, the PCP/AP 6905 may forward the multi-relay channel measurement request frame 6955B to the destination STA 6920. In a second example, 6960, the source STA 6910 may transmit the multi-relay channel measurement request frame 6955C to a third STA, such as a previously established range extension relay STA1 6915, the third STA then forwards the multi-relay channel measurement request frame 6955D to the destination STA 6920.

The multi-relay channel measurement request frame 6955A, 6955C transmitted by the source STA 6910 may contain the transmitting STA address, such as the MAC address/AID of the source STA, and/or the BSS/PBSS to which the source STA belongs, both the receiving address and the destination address, with the receiving address being the MAC/AID address of the PCP/AP or range extension relay, and the destination address being the MAC/AID address of the destination STA.

The multi-relay channel measurement request frame 6955B, 6955D transmitted by the forwarding STA, such as the PCP/AP 6905 or the range extension relay STA1 6915, may contain the transmitting STA address, such as the MAC address/AID of the forwarding STA, and/or the BSS/PBSS to which the source STA belongs, both the requesting address and the destination address, with the requesting address being the MAC/AID address of the source STA, and the destination address being the MAC/AID address of the destination STA.

In the first example 6950, when the destination STA 6920 receives the multi-relay channel measurement request frame 6955B, it may respond with a multi-relay channel measurement report frame in one or more of the ways disclosed herein. The destination STA 6920 may transmit the multi-relay channel measurement report frame 6965A to the PCP/AP 6905, and the PCP/AP 6905 may forward the multi-relay channel measurement report frame 6965B to the source STA 6910. In the second example 6960, the destination STA 6920 may transmit the multi-relay channel measurement report frame 6965C to a third STA, such as a previously established range extension relay STA1 6915, the third STA then forwards the multi-relay channel measurement report frame 6965D to the source STA 6905.

The multi-relay channel measurement report frame 6965A, 6965C transmitted by the destination STA 6920 may contain the transmitting STA address, such as the MAC address/AID of the destination STA, and/or the BSS/PBSS to which the destination STA belongs, both the receiving address and the destination address, with the receiving address being the MAC/AID address of the PCP/AP or range extension relay, and the destination address being the MAC/AID address of the source STA.

The multi-relay channel measurement report frame 6965B, 6965D transmitted by the forwarding STA, such as the PCP/AP 6905 or the range extension relay STA1 6915, may contain the transmitting STA address, such as the MAC address/AID of the forwarding STA, and/or the BSS/PBSS to which the destination STA belongs, both the requesting address and the destination address, with the requesting address being the MAC/AID address of the destination STA, and the destination address being the MAC/AID address of the source STA.

The PCP/AP 6905 may schedule two SPs for beamforming training for range extension relay STA2 6917 contained in the transmitted relay search response frame. In the first SP, the transmitter may be the source STA 1 6910 and the destination may be the range extension relay STA2 6917. In the second SP, the transmitter may be the range extension relay STA2 6917 and the destination may be the destination STA 6920, such as the D-REDS.

After the range extension relay STA2 6917 completes BF with both the source STA and destination STA 6927A, 6927B, the source STA 6910 may transmit a multi-relay channel measurement request frame 6933 to the range extension relay STA2 6917, which shall respond with the transmission of a multi-relay channel measurement report frame 6937 back to the source STA 6910. The source STA 6910 may conduct BF with the destination STA 6920. If the source STA 1 6910 and the destination STA 6920 are out of range of each other, or if it is already known that the source and destination STAs are out of range beforehand, the source STA 6910 and destination STA 6920 must exchange information 6945A, 6945B through a third STA, such as PCP/AP 6905.

The source STA 6910 may transmit the multi-relay channel measurement request frame 6957A to a third STA, such as a previously established range extension relay STA2 6917, the third STA then forwards the multi-relay channel measurement request frame 6957B to the destination STA 6920.

The multi-relay channel measurement request frame 6957A transmitted by the source STA 6910 may contain the transmitting STA address, such as the MAC address/AID of the source STA, and/or the BSS/PBSS to which the source STA belongs, both the receiving address and the destination address, with the receiving address being the MAC/AID address of the PCP/AP or range extension relay, and the destination address being the MAC/AID address of the destination STA.

The multi-relay channel measurement request frame 6957B transmitted by the forwarding STA, such as the PCP/AP 6905 or the range extension relay STA2 6917, may contain the transmitting STA address, such as the MAC address/AID of the forwarding STA, and/or the BSS/PBSS to which the source STA belongs, both the requesting address and the destination address, with the requesting address being the MAC/AID address of the source STA, and the destination address being the MAC/AID address of the destination STA.

When the destination STA 6920 receives the multi-relay channel measurement request frame 6957B, it may respond with a multi-relay channel measurement report frame in one or more of the ways disclosed herein. The destination STA 6920 may transmit the multi-relay channel measurement report frame 6967A to the PCP/AP 6905, and the PCP/AP 6905 may forward the multi-relay channel measurement report frame 6967B to the source STA 1 6910. In the second example 6960, the destination STA 6920 may transmit the multi-relay channel measurement report frame 6967A to a third STA, such as a previously established range extension relay STA2 6917, the third STA then forwards the multi-relay channel measurement report frame 6967B to the source STA 6905.

The multi-relay channel measurement report frame 6967A transmitted by the destination STA 6920 may contain the transmitting STA address, such as the MAC address/AID of the destination STA, and/or the BSS/PBSS to which the destination STA belongs, both the receiving address and the destination address, with the receiving address being the MAC/AID address of the PCP/AP or range extension relay, and the destination address being the MAC/AID address of the source STA.

The multi-relay channel measurement report frame 6967B transmitted by the forwarding STA, such as the PCP/AP 6905 or the range extension relay STA2 6917, may contain the transmitting STA address, such as the MAC address/AID of the forwarding STA, and/or the BSS/PBSS to which the destination STA belongs, both the requesting address and the destination address, with the requesting address being the MAC/AID address of the destination STA, and the destination address being the MAC/AID address of the source STA.

Once the source STA receives the multi-relay channel measurement report frames from the destination STA and range extension relay STAs, it may select one or more range extension relay STAs as the range extension relay(s) 6970 between the source and the destination STA. For example, a range extension relay link setup (RLS) procedure may be performed. Once the source STA has selected one or more range extension relay(s), the SME of the source STA may issue the MLME-RLS.request primitive to initiate the REX RLS procedure. The MLME-RLS.request may contain one or more relayMACaddresses if one or more relays are selected for the RLS procedure. The MLME-RLS.request may also contain the modified DestinationCapabilityInformation parameter which may, e.g., include a modified Relay Capability field, to indicate that the destination STA is capable of being a D-REDS of a range extension relay link. The MLME-RLS.request may also contain the modified RelayCapabilityInformation parameter which may, e.g., include a modified Relay Capability field, to indicate that the relay STA is capable of being a range extension relay. The MLME-RLS.request may also contain the modified RelayTransferParameterSet parameter to indicate that the relay link setup is to establish an range extension relay link.

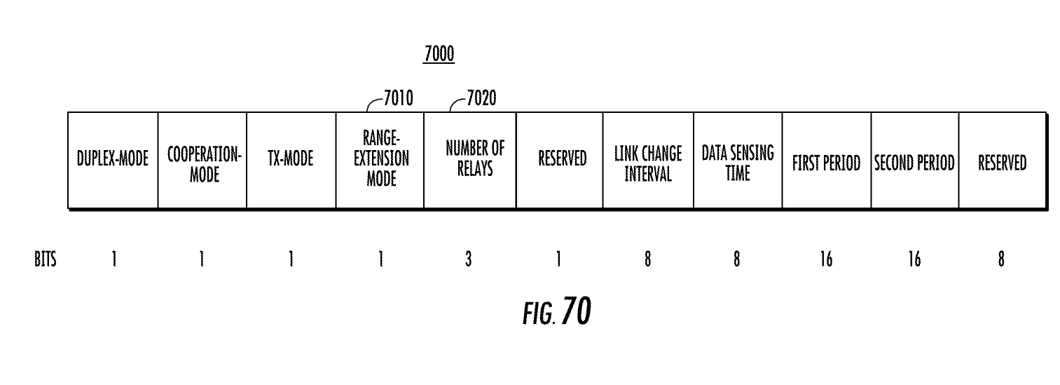

FIG. 70 is a diagram of an example design of the relay transfer parameter field 7000 contained in the RelayTransferParameterSet. The modified relay transfer parameter 7000 may contain a range extension mode indicator 7010 indicating that the RLS is for Range extension relay links. The modified relay transfer parameter field 7000 may also contain a number of relays 7020 to indicate the total number of relays that are being used for the current RLS procedure.

Upon receiving the MLME-RLS.request, the source STA then may transmit an RLS request frame to the selected range extension relay STAs. The RLS request frame may contain the AIDs for the source, destination, and range extension relay STAs, as well as relay capability information contained in the MLME-RLS.request, and the relay transfer parameters set included in the MLME-RLS.request.

Upon receiving the RLS request frame from the source STA, and if the range extension relay is willing to participate in the range extension RLS, the range extension STA may forward the information contained in the RLS request frame to the destination STA. Otherwise, the range extension relay STA shall respond with a RLS response frame with the status code “failed”. The destination STA, if it is willing to participate in the range extension RLS, after receiving the RLS request frame from the range extension relay, shall respond with a RLS response frame with success status code and transmit it to the range extension relay.

After receiving the RLS Response frame with status code “success” from the destination STA, the range extension relay STA may transmit a RLS response frame to the source STA with the status code “success”, if it is willing to participate in range extension RLS.

In one example range extension relay link transmission procedure, if there is only one range extension relay STA set up between the source and the destination STA, then the source and the destination STA may transmit their packets to the relay in a first period, then in a second period, the relay may forward the received packets to respectively to the destination STA or source STA.

If there are more than one range extension relay STAs set up between the source and the destination STA, then one of the range extension relay may be identified as the primary range extension relay STA. The relay link through the primary range extension relay STA may function similarly as the direct link between the source and destination STA in a non-range extension relay case. Link switching or cooperation type of relay operations may take place over the primary and secondary range extension relay links.

Although the solutions, features and elements described herein consider IEEE 802.11 specific protocols, one of ordinary skill in the art will appreciate that the solutions described herein are not restricted to this scenario and are applicable to other wireless systems as well. Many of the embodiments relate to procedures for support of a relay, however a relay may also be considered as a STA which performs the procedures described herein to support the functions or requirements of a relay.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in wireless communications, the method comprising:
transmitting, by a Source-Relay End-point directional multi-gigabit (DMG) Station (S-REDS), a first multi-relay channel measurement request to a plurality of Relay DMG Stations (RDS)s;
receiving, at the S-REDS, a first multi-relay channel measurement report from a first RDS of the plurality of RDSs, wherein the first multi-relay channel measurement report contains first channel measurement information associated with a channel between the first RDS and the S-REDS;
transmitting, by the S-REDS, a second multi-relay channel measurement request to the plurality of RDSs;
receiving, at the S-REDS, a second multi-relay channel measurement report from the first RDS of the plurality of RDSs, wherein the second multi-relay channel measurement report contains second channel measurement information associated with a channel between the first RDS and a Destination-Relay End-point DMG Station (D-REDS); and
selecting an RDS from the plurality of RDSs based on the first channel measurement information and the second channel measurement information.

2. The method of claim 1, wherein the second channel measurement information includes channel information associated with a channel between the first RDS and the D-REDS and channel information associated with a channel between the D-REDS and the first RDS.

3. The method of claim 1 further comprising:
transmitting, by the S-REDS, a third multi-relay channel measurement request to the plurality of RDSs;
receiving, at the S-REDS, a third multi-relay channel measurement report from a second RDS, wherein the third multi-relay channel measurement report from the second RDS contains third channel measurement information associated with a channel between the second RDS and the S-REDS;
transmitting, by the S-REDS a fourth multi-relay channel measurement request to the plurality of RDSs; and
receiving, at the S-REDS, a fourth multi-relay channel measurement report from the second RDS, wherein the fourth multi-relay channel measurement report contains a fourth channel measurement information for a channel between the second RDS and the D-REDS.

4. The method of claim 3, wherein the fourth channel measurement information includes channel information associated with a channel between the second RDS and the D-REDS and channel information associated with a channel between the D-REDS and the second RDS.

5. A method for use in wireless communications, the method comprising:
transmitting, from a multiple data stream (MDS) Relay station (STA), a message that includes an indicator that indicates that the MDS Relay STA supports MDS relay operation;
receiving, at the MDS Relay STA, a first Relay Link Setup (RLS) request frame from a source STA;
transmitting, from the MDS Relay STA, a second RLS request frame to a destination STA in response to receiving the first RLS request frame;
receiving, at the MDS Relay STA, a first RLS response frame from the destination STA, wherein the first RLS response frame includes a first data stream number; and
transmitting, from the MDS Relay STA, a second RLS response frame to the source STA in response to receiving the first RLS response frame, wherein the second RLS response frame includes a second data stream number.

6. The method of claim 5, wherein at least one of the first RLS response frame or the second RLS response frame includes a status code that indicates success.

7. The method of claim 5, wherein at least one of the first RLS response frame or the second RLS response frame includes a Relay identification (ID) associated with the MDS Relay STA.

8. The method of claim 5, wherein at least one of the first RLS response frame or the second RLS response frame includes a data stream number.

9. The method of claim 5, wherein at least one of the first RLS response frame or the second RLS response frame includes a Relay Order or a Relay Type.

10. A Source-Relay End-point directional multi-gigabit (DMG) Station (S-REDS) comprising:
a transmitter configured to transmit a first multi-relay channel measurement request to a plurality of Relay DMG Stations (RDS)s;
a receiver configured to receive a first multi-relay channel measurement report from a first RDS of the plurality of RDSs, wherein the first multi-relay channel measurement report contains first channel measurement information associated with a channel between the first RDS and the S-REDS;
wherein the transmitter is further configured to transmit a second multi-relay channel measurement request to the plurality of RDSs;
wherein the receiver is further configured to receive a second multi-relay channel measurement report from the first RDS of the plurality of RDSs, wherein the second multi-relay channel measurement report contains second channel measurement information associated with a channel between the first RDS and a Destination-Relay End-point DMG Station (D-REDS); and
a processor configured to select an RDS from the plurality of RDSs based on the first channel measurement information and the second channel measurement information.

11. The S-REDS of claim 10, wherein the second channel measurement information includes channel information associated with a channel between the first RDS and the D-REDS and channel information associated with a channel between the D-REDS and the first RDS.

12. The S-REDS of claim 10, wherein the transmitter is further configured to transmit a third multi-relay channel measurement request to the plurality of RDSs, wherein the receiver is further configured to receive a third multi-relay channel measurement report from the second RDS, wherein the third multi-relay channel measurement report from the second RDS contains third channel measurement information associated with a channel between the second RDS and the S-REDS, wherein the transmitter is further configured to transmit a fourth multi-relay channel measurement request to the plurality of RDSs, and wherein the receiver is further configured to receive a fourth multi-relay channel measurement report from the second RDS, wherein the fourth multi-relay channel measurement report contains fourth channel measurement information for a channel between the second RDS and the D-REDS.

13. The S-REDS of claim 12 wherein the fourth channel measurement information includes channel information associated with a channel between the second RDS and the D-REDS and channel information associated with a channel between the D-REDS and the second RDS.

14.-17. (canceled)
